(19) United States
(12) Patent Application Publication
(10) Pub. No.: US 2011/0190157 A1
(43) Pub. Date: Aug. 4, 2011

(54) Biomarkers for Diagnosis and Treatment of Chronic Lymphocytic Leukemia

(75) Inventors: Thomas J. Kipps, San Diego, CA (US); Zhouxin Shen, San Diego, CA (US); Steven P. Briggs, Del Mar, CA (US); Trey Ideker, La Jolla, CA (US); Laura Rassenti, San Diego, CA (US); Han-Yu Chuang, La Jolla, CA (US)

(73) Assignee: THE REGENTS OF THE UNIVERSITY OF CALIFORNIA

(21) Appl. No.: 13/058,530

(22) PCT Filed: Aug. 14, 2009
(86) PCT No.: PCT/US09/53948

§ 371 Date: Mar. 22, 2011

Related U.S. Application Data
(60) Provisional application No. 61/089,462, filed on Aug. 15, 2008.
(60) Provisional application No. 61/120,347, filed on Dec. 5, 2008.

(51) Int. Cl. C40B 30/04; C40B 40/08

(52) U.S. Cl. 506/9; 506/17

(57) ABSTRACT

A molecular classification procedure based on activity levels of modules in protein networks, wherein the proteins are biomarkers for chronic lymphocytic leukemia (CLL), and method for use of the subnetworks to distinguish between patients at low or high risk of progression of their disease.

### BACKGROUND OF THE INVENTION

1. Field of the Invention

The invention relates to the use of protein biomarkers for the differential diagnosis, determination of prognosis, and monitoring of the progression of treatment of chronic lymphocytic leukemia.

2. Background Information

Cancers are the second most prevalent cause of death in the United States, causing 450,000 deaths per year. One in three Americans will develop cancer, and one in five will die of cancer. While substantial progress has been made in identifying some of the likely environmental and hereditary causes of cancer, there is a need for substantial improvement in the diagnosis and therapy for cancer and related diseases and disorders.

The course of chronic lymphocytic leukemia (CLL) is variable. Some patients have aggressive disease and require therapy within a relatively short time after diagnosis, whereas others have indolent, asymptomatic disease, and need no therapy for many years. CLL treatment depends upon both the stage and symptoms of the individual patient.

A large group of CLL patients have low-grade, or indolent, disease, which does not benefit from treatment. Individuals with CLL-related complications or more advanced disease often benefit from treatment. To this end, several molecules have been investigated in the pursuit of a biomarker to use for diagnosis of CLL. However, as yet, there is no definitive biomarker that can universally detect and distinguish the aggressive and indolent forms of CLL (see, e.g., J. Binet et al, Perspectives on the use of new diagnostic tools in the treatment of chronic lymphocytic leukemia, Blood 2006 107: 859-861; and, L. Rassenti et al, ZAP-70 compared with immunoglobulin heavy-chain gene mutation status as a predictor of disease progression in chronic lymphocytic leukemia, N Engl J Med. 2004 Aug. 26; 351(9):856-7). A need, therefore, exists for a method of using biomarkers for in connection with the differential diagnosis and treatment of CLL.

### SUMMARY OF THE INVENTION

The present invention is based on the seminal discovery that a panel of biomarkers is differentially expressed in patients with CLL at distinct stages of the disease. More specifically, the invention relates to a molecular classification procedure based on activity levels of modules in protein networks.

Accordingly, the present invention provides a molecular differential diagnosis (prognosis) tool that assigns patients to “aggressive” (high-risk) or “indolent” (low-risk) groups based on their gene expression correlated to the treatment-free survival from the date of sample collection.

Accordingly, the invention provides a method for predicting the prognostic risk posed by chronic lymphocytic leukemia (CLL) to a patient diagnosed with the disease. The method includes obtaining a sample from the patient; and comparing expression of a first plurality of genes from said sample to expression of a second plurality of genes comprising a biomarker subnetwork, wherein the genes of the subnetwork encode proteins known to exhibit protein-protein interactions, and wherein further said proteins are associated with relatively high or low risk for progression of the disease, whereby similarity between expression of said pluralities of genes indicates the relative level of such risk for the patient. In various aspects, the subnetwork of genes encode proteins that comprise one or more protein biomarkers listed in Tables 1 through 4. In related aspects, the subnetwork includes one or more subnetworks listed in Table 5. Additionally, the subnetwork may include one or more of the subnetworks of FIGS. 8 through 37.

In another embodiment, the invention provides a method of diagnosing CLL in a subject. The method includes diagnosing a subject as having or being at risk of having chronic lymphocytic leukemia (CLL), by obtaining a sample from the subject; and comparing the expression or activation of one or more biomarkers listed in Tables 1 through 5 or FIGS. 8 through 37, in a first sample from the subject suspected of having CLL with a control sample of normal B cells, wherein differential expression of one or more of said biomarkers in the subject's sample as compared to the control sample is diagnostic of CLL in the subject. In one aspect the biomarker includes one or more biomarkers listed in Tables 1 or 3 and expression of the one or more biomarkers is increased as compared to expression of the biomarker in the control sample. In a related aspect, the biomarker includes one or more biomarkers listed in Tables 2 or 4 and expression of the one or more biomarkers is decreased as compared to expression of the biomarker in the control sample.

In another embodiment, the invention provides a method for distinguish aggressive CLL from indolent CLL in a subject. For example a method is provided for differentially diagnosing aggressive chronic lymphocytic leukemia (CLL) versus indolent CLL in a subject. The method includes obtaining a sample from a subject; and comparing the level of expression of one or more biomarkers listed in Table 1 and/or Table 2 in a sample from the subject suspected of having aggressive CLL with a control indolent CLL sample, wherein greater expression of one or more of said biomarkers listed in Table 1 in the subject sample versus the control indolent CLL sample is diagnostic of aggressive CLL in the subject, or wherein lesser expression of one or more of said biomarkers listed in Table 2 in the subject sample versus the control indolent CLL sample is diagnostic of indolent CLL in the subject.

According to another embodiment, a method is provided for monitoring a therapeutic regime or progression of CLL in a subject. The method includes identifying when a pattern of biomarker expression indicative of CLL in the indolent state changes to a pattern indicative of CLL in the aggressive state. Detection of such a shift can provide a basis upon which to alter therapy at the early stages of aggressive CLL, thereby potentially improving the clinical outcome for the patient. Additionally, a method is provided in entailing monitoring a therapeutic regimen for treating a subject having or at risk of having CLL, including determining a change in activity or expression of one or more biomarkers listed in any of Tables 1 through 4, subnetwork listed in Table 5 or FIGS. 8 through 37, thereby monitoring the therapeutic regimen in the subject.

In yet another aspect, the invention provides a method for diagnosing CLL in a subject, comprising the steps of a) providing a gene expression profile of a sample from the subject suspected of having CLL, wherein the sample simultaneously expresses a plurality of genes at the protein level that are markers (biomarkers) for CLL; and b) comparing the subject's gene expression profile to a reference gene expression profile obtained from a corresponding control sample of B cells, wherein the reference gene expression profile comprises an expression value of one or more target genes for biomarkers indicative of CLL; and/or c) comparing the gene expression profile to a database of CLL protein biomarker subnetworks, to provide a differential diagnosis between indolent and aggressive CLL and/or provide a prognosis for the patient.

In another embodiment, the invention provides a computer microchip programmed with one or more datasets concerning CLL subnetwork markers that can be used in clinical routines for predicting whether a particular patient's expression profile is likely to be in a short need of treatment. A microarray-like approach can be implemented. Accordingly, the invention provides a diagnostic chip comprising nucleotides with at least 80%, 85%, 90%, 95%, or greater percent homology to the sequences of two or more genes listed in Tables 1 through 4, and the subnetworks listed in Table 5 and those of FIGS. 8 through 37.

In another embodiment, the invention provides a software program with algorithms for comparing one or more datasets concerning CLL subnetwork markers that can be used in clinical routines for predicting whether a particular patient's expression profile is likely to be in a short need of treatment. Accordingly, a computer-readable media including algorithms for execution of comparisons included in the methods described herein is provided.

### BRIEF DESCRIPTION OF THE DRAWINGS

FIG. 1. Potential biomarkers for distinguish aggressive and indolent CLL. ZAP70 is over-expressed in aggressive CLL.

FIG. 2. Schematic overview of subnetwork identification. Protein-protein interaction networks are used to assign sets of genes to discrete subnetworks. Gene expression profiles of tissue samples drawn from each type of cancer (i.e., metastatic or nonmetastatic) are transformed into a “subnetwork activity matrix”. For a given subnetwork Mk in the interaction network, the activity is a combined z-score derived from the expression of its individual genes. After overlaying the expression vector of each gene on its corresponding protein in the interaction network, subnetworks with discriminative activities are found via a greedy search. Significant subnetworks are selected based on null distributions estimated from permuted subnetworks. Subnetworks are then used to identify disease genes, and the subnetwork activity matrix is also used to train a classifier.

FIG. 3. Prognostic subnetworks shown as identifying new putative cancer markers and provide an array of “small-scale” models charting the molecular mechanisms correlated with CLL progression, e.g. subnetworks detailing interactions between proteins participating in Wnt signaling, Smoothend signaling, or cell death.

FIG. 4. Prognostic indicators evaluated in untreated CLL patients using the invention, with respect to subnetwork signature (FIG. 4a) versus gene expression profiles (FIG. 4b), IgVH mutational status (FIG. 4c) or ZAP-70 protein expression (FIG. 4d).

FIG. 5. Comparison of subnetwork signature determined using the 131 CLL patient cohort (left panel) to gene expression profile of independent testing set of 17 CLL patients (right panel). The subnetwork signature was predictive of the prognosis of the subsequent independent testing set.

FIG. 6. An illustration grouping the CLL subnetworks of FIGS. 6 through 52 to indicate the spectrum of CLL biomarker expression for disease progression from low to high risk (indolent to aggressive).

FIG. 7. A schematic for application of the method of the invention to CLL risk classification.

FIGS. 8 through 37. Subnetwork matrices of protein markers for CLL.

### DETAILED DESCRIPTION OF THE INVENTION

Methods are provided for the diagnosis and monitoring of treatment of CLL based on detection of certain biomarkers in samples from patients who have, or are suspected of having, CLL. Further, expression of one or more such biomarkers can be used to distinguish aggressive CLL from indolent CLL. In addition, certain cellular pathways have been identified as biomarkers of CLL whose activation or inactivation is diagnostic for CLL.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

In various aspects, the invention provides biomarkers relating to CLL diagnosis, prognosis, treatment, and pathology. A biomarker is a characteristic that is objectively measured and evaluated as an indicator of normal biological processes, pathogenic processes, or pharmacological responses to a therapeutic intervention. Biomarkers vary widely in nature, ease of measurement, and correlation with physiological states of interest. As in the present invention, biomarkers may include up- or down-regulation of gene expression or subnetworks of a plurality of genes. For example, increased or decreased expression of a gene encoding a protein during pathogenesis of a disease, such as CLL, implicates the protein as a protein biomarker. Similarly, increased or decreased expression of a plurality of genes, or subnetwork, during pathogenesis of a disease, such as CLL, implicates the subnetwork as a biomarker subnetwork. For example, the subnetwork, may include a plurality of genes whose expression products (proteins) are known to interact in cellular processes to define biological pathways and processes.

Biomarker subnetworks and/or protein biomarkers whose up-regulation or downregulation is indicative of an increase or decrease in the relative “activeness” of the disease. In particular, marker gene expression define a repertoire of transcriptional activity contributing to or resulting from the dynamic evolution of CLL cells. Network-based gene expression analysis reveals subnetworks of proteins that are coordinately irregulated under the disease progression. With knowledge of such subnetworks, CLL progression can be monitored by analyzing subnetwork activities inferred from gene expression profiles.

As used herein, the terms “patient” or “individual” are used interchangeably herein, and is meant a mammalian subject to be treated, with human patients being preferred. In some cases, the methods of the invention find use in experimental animals, in veterinary application, and in the development of animal models for disease, including, but not limited to, rodents including mice, rats, and hamsters, and primates.

Gene expression profiling has been used to define a repertoire of transcriptional activity contributing to or resulting from the dynamic evolution of CLL cells. To evaluate for this, samples obtained from CLL patients may be profiled for expression, using for example, microarray technology, such as mRNA expression microarrays. However, one of skill in the art would understand that expression profiling may be performed by any method known in the art, including methods, such as serial analysis of gene expression (SAGE) or SuperSAGE technology.

As discussed herein, the methods of the present invention may be used, for example, to evaluate CLL patients and those at risk for CLL. In any of the methods of diagnosis, prognosis, disease progression and therapeutic efficacy described herein, either the presence or the absence of one or more biomarkers of CLL, may be used to generate such clinical measures.

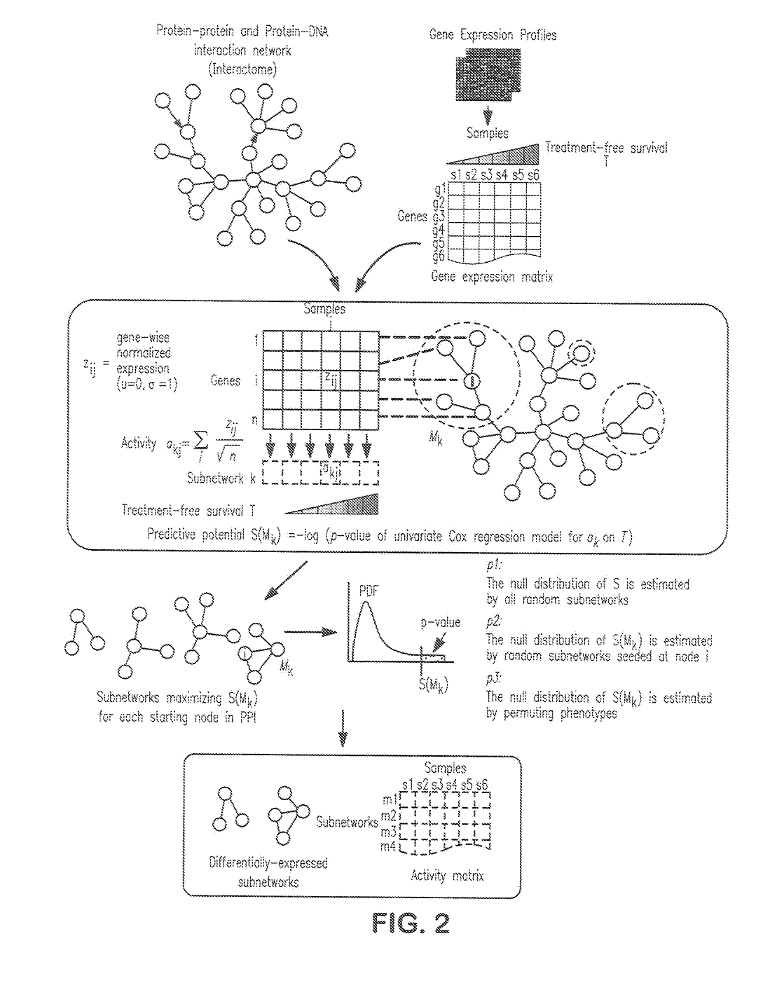

In one embodiment, the invention provides a molecular prognosis tool that assigns patients to “aggressive” (high-risk) or “indolent” (low-risk) groups based on their gene expression correlated to the treatment-free survival from the date of sample collection. To achieve better prediction performance based upon biological-defensive models, the network-based classification scheme developed for predicting metastasis potential of breast cancers (Chuang et al., Mol Syst Biol., 2008) was adapted to CLL analysis. The network-based approach identifies prognostic markers not as individual genes but as subnetworks extracted from molecular interaction databases (FIG. 2).

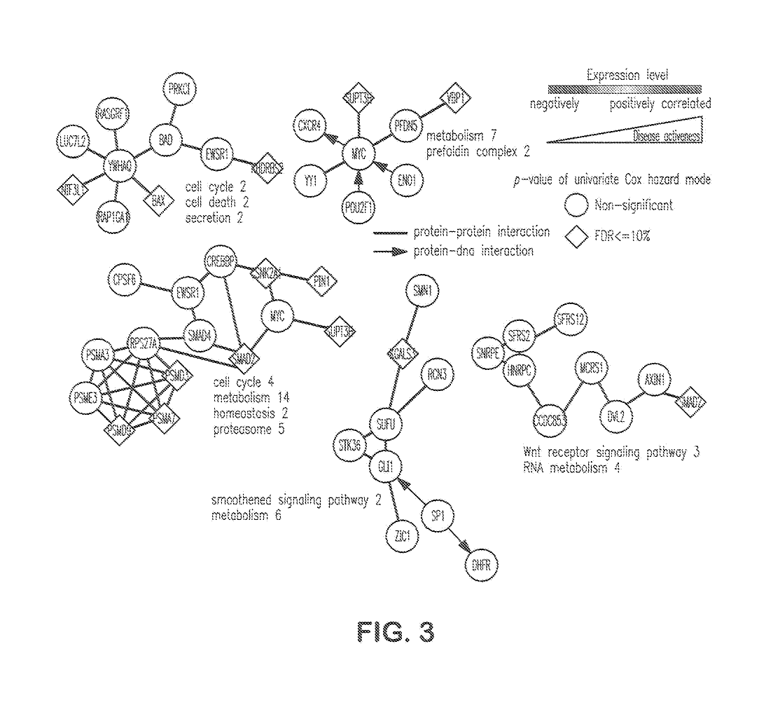

Approximately 30 prognostic subnetworks have been identified which provide new putative cancer markers and an array of “small-scale” models charting the molecular mechanisms correlated with CLL progression, e.g. subnetworks detailing interactions between proteins participating in Wnt signaling, Smoothend signaling, or cell death (FIG. 3).

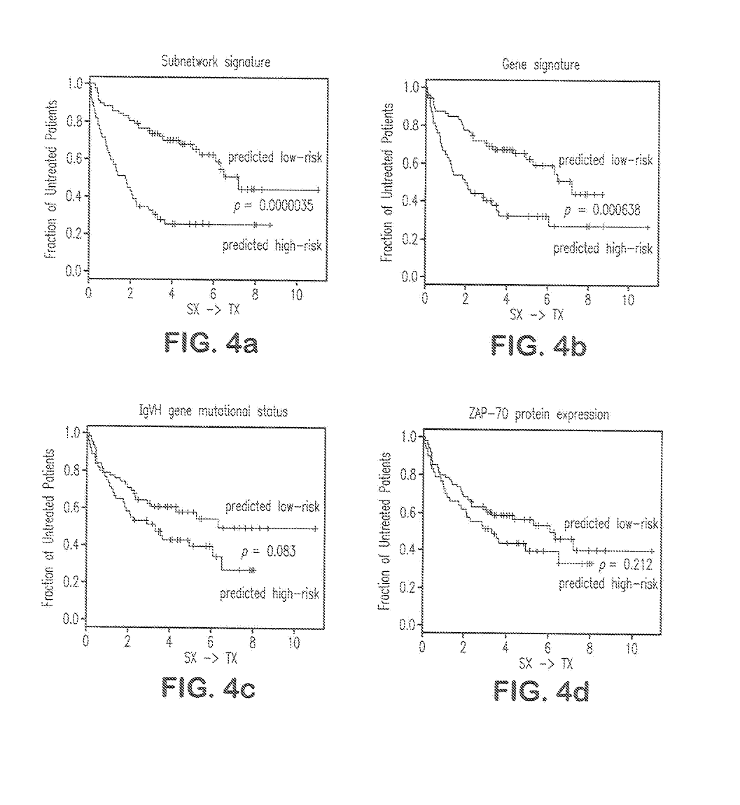

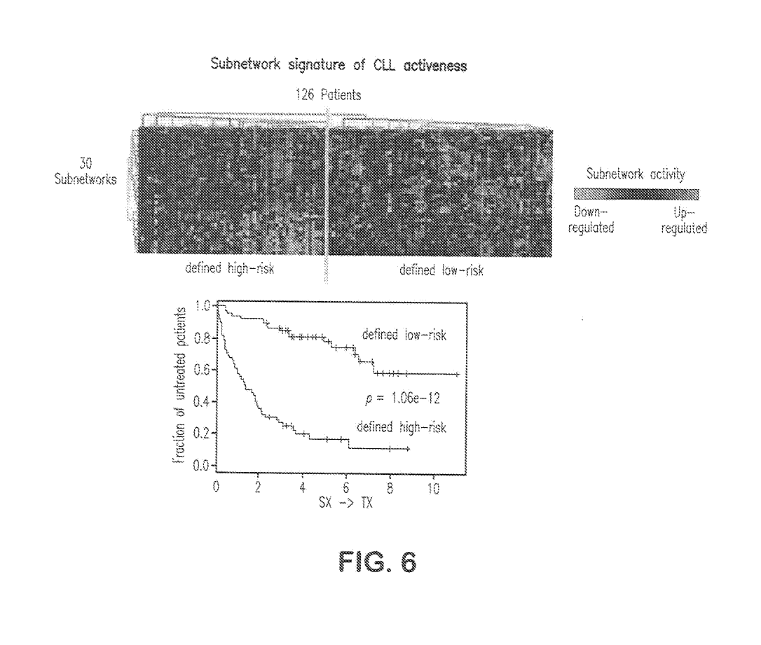

The network-based classification of the invention achieves higher accuracy in predicting duration of treatment-free survival in newly diagnosed patients than commonly-used prognostic factors or conventional gene-expression array analyses (compare FIG. 4a to FIGS. 4b through 4d). Thus, the network-based approach integrating protein interactions with CLL expression profiles leads to increased classification accuracy along a scale of disease “activeness” (FIG. 6) and, simultaneously, provides a view of the biological processes underlying CLL progression.

To perform the methods of the invention, the sample of cells examined according to the present method can be obtained from the subject to be treated; e.g., from a blood sample. As used herein, the term “sample” refers to any sample suitable for the methods provided by the present invention. The sample may be any sample that includes cells or cellular components suitable for detection. In one aspect, the sample is a blood sample, including, for example, whole blood or any fraction or component thereof. A blood sample, suitable for use with the present invention may be extracted from any source known that includes blood cells or components thereof, such as veinous, arterial, peripheral, tissue, cord, and the like. For example, a sample may be obtained and processed using well known and routine clinical methods (e.g., procedures for drawing and processing whole blood). In one aspect, an exemplary sample may be peripheral blood drawn from a subject with cancer.

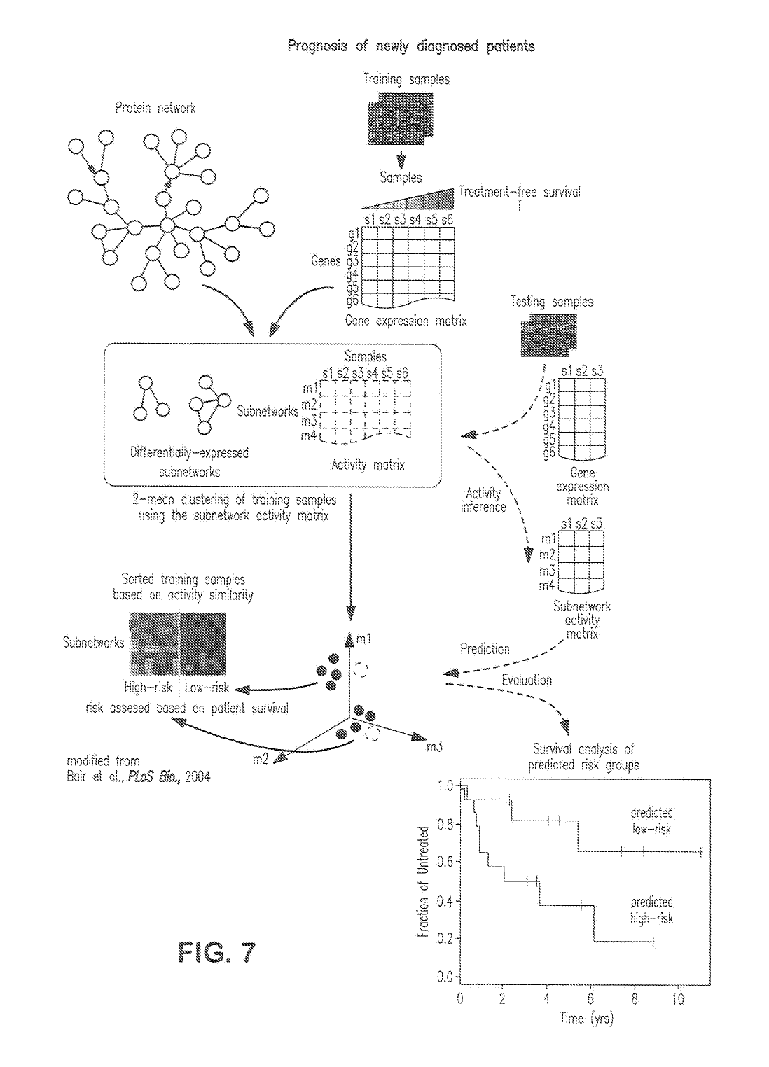

Once disease is established and a treatment protocol is initiated, the methods of the invention may be repeated on a regular basis to monitor the expression level of genes associated with CLL in the subject and correlate them to the subnetwork data. The gene expression level data allows one to distinguish between aggressive and indolent CLL, while comparison of the expression data to subnetwork matrices for CLL aids in classification of each patient into high or low risk categories (FIG. 7). The results obtained from successive assays may be used to show the efficacy of treatment over a period ranging from several days to months.

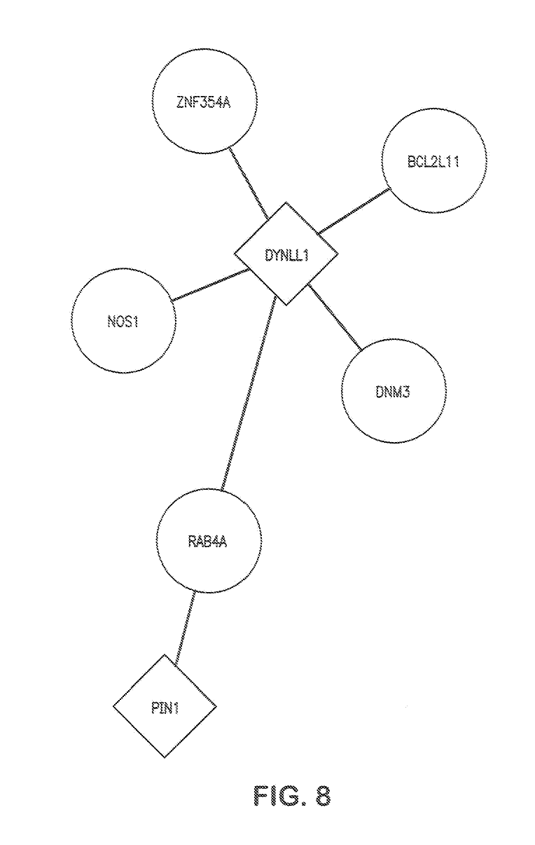

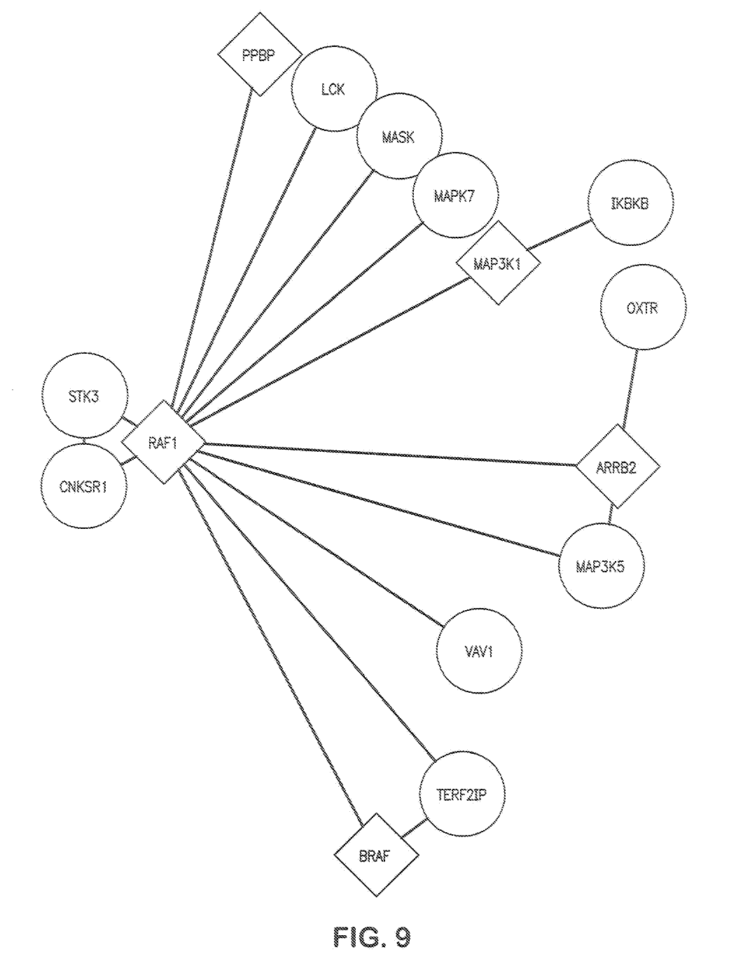

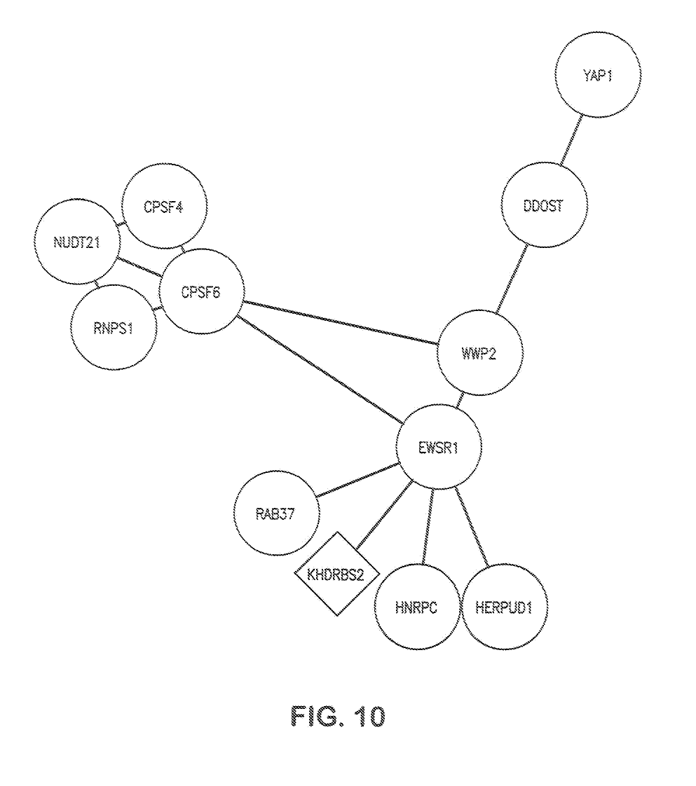

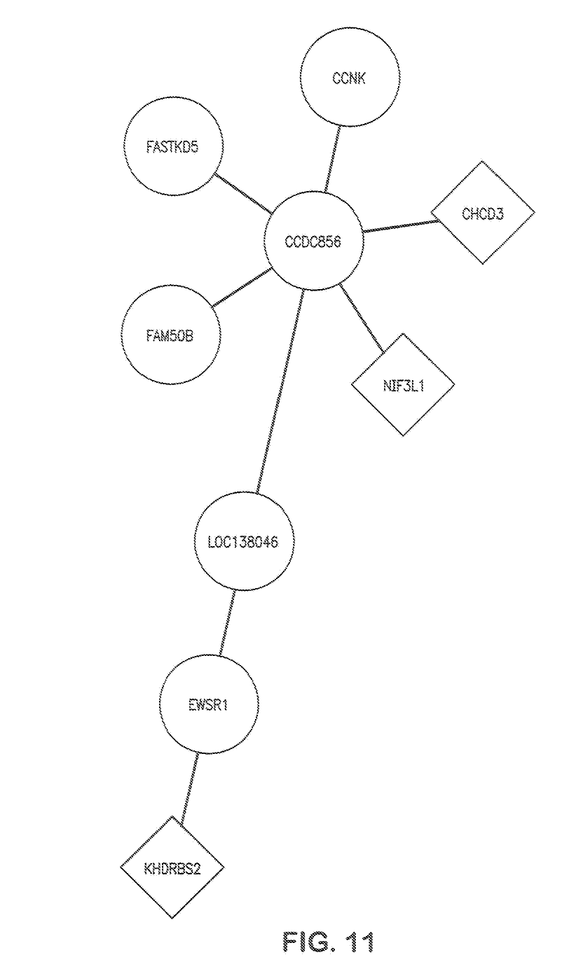

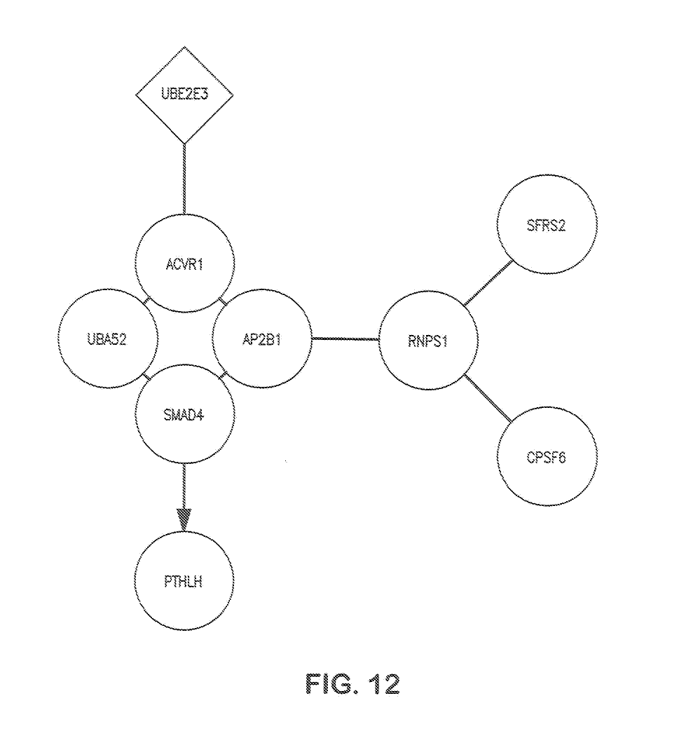

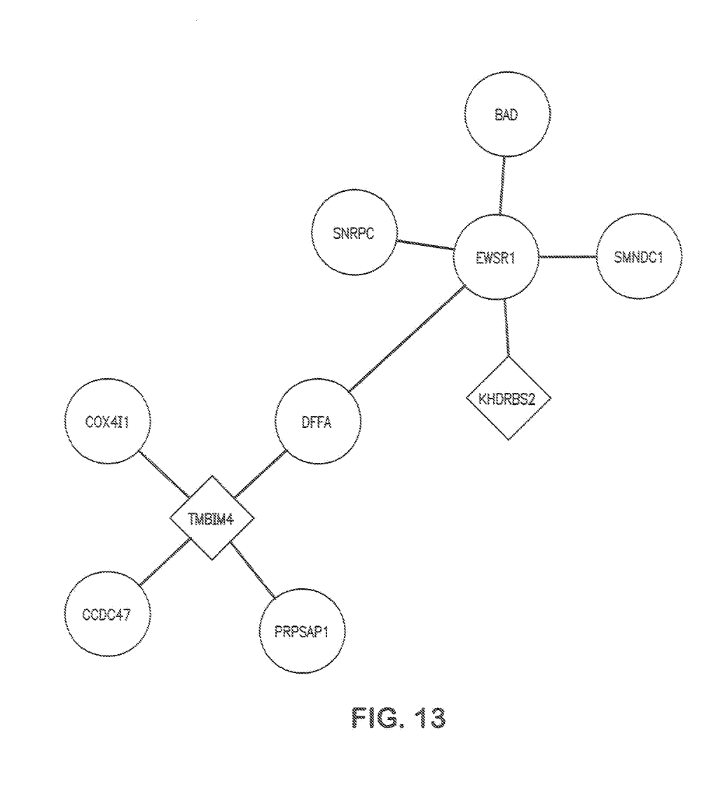

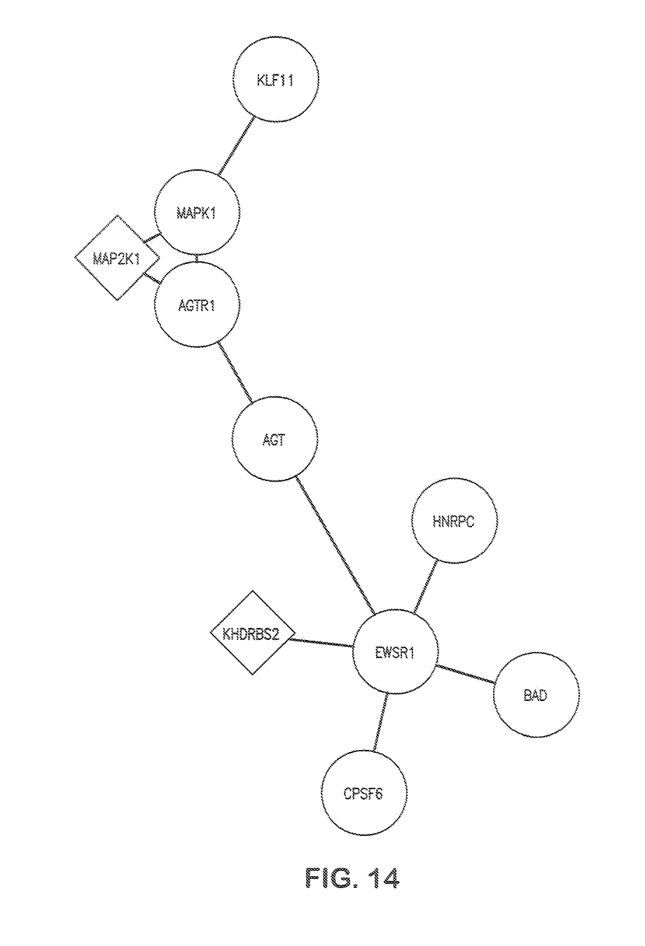

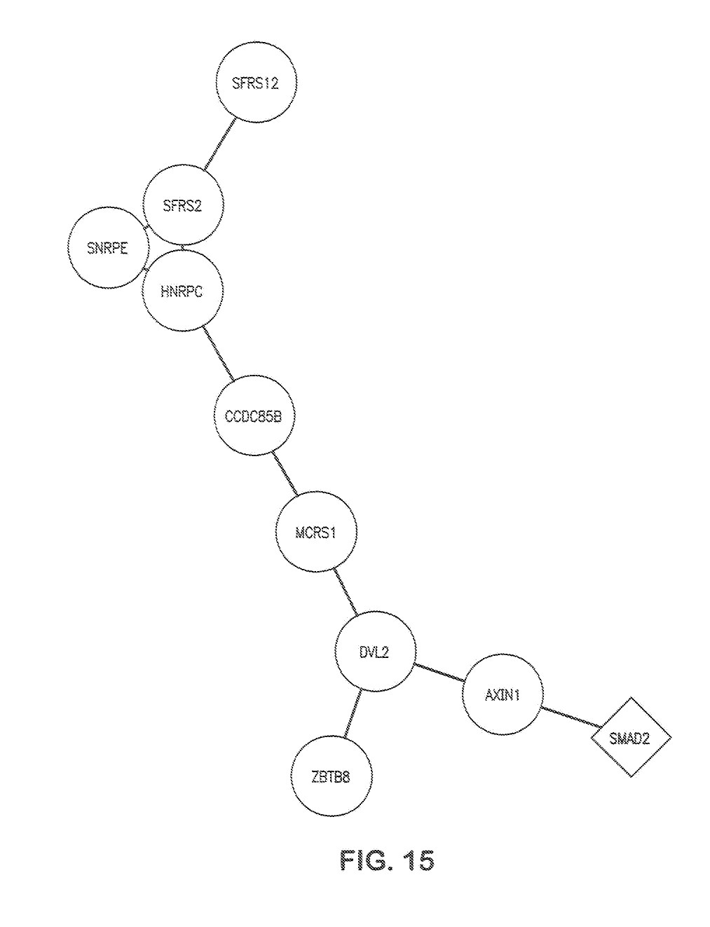

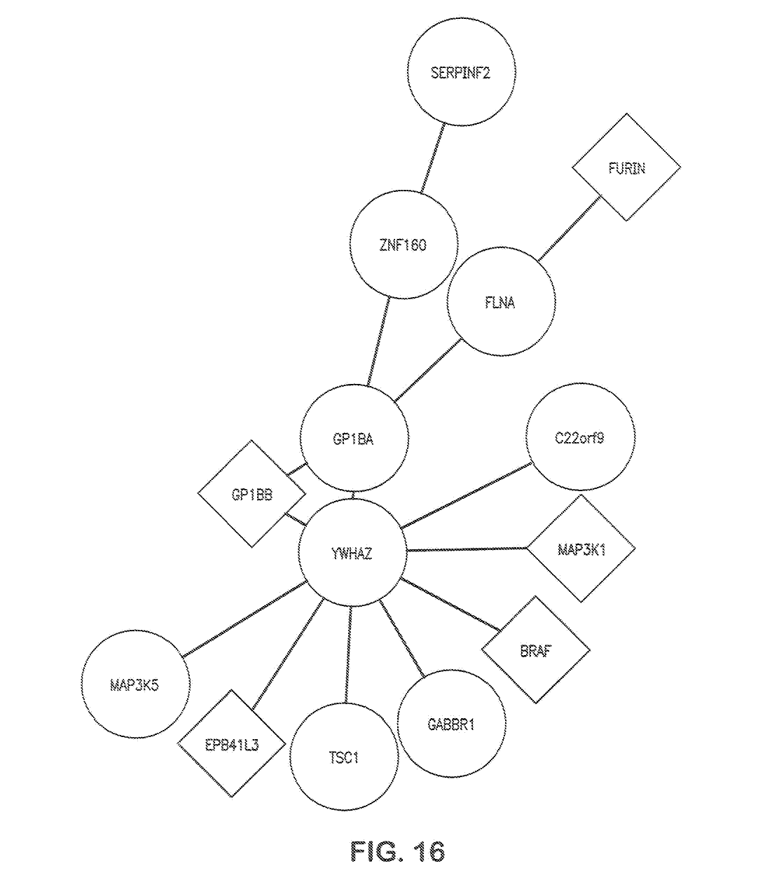

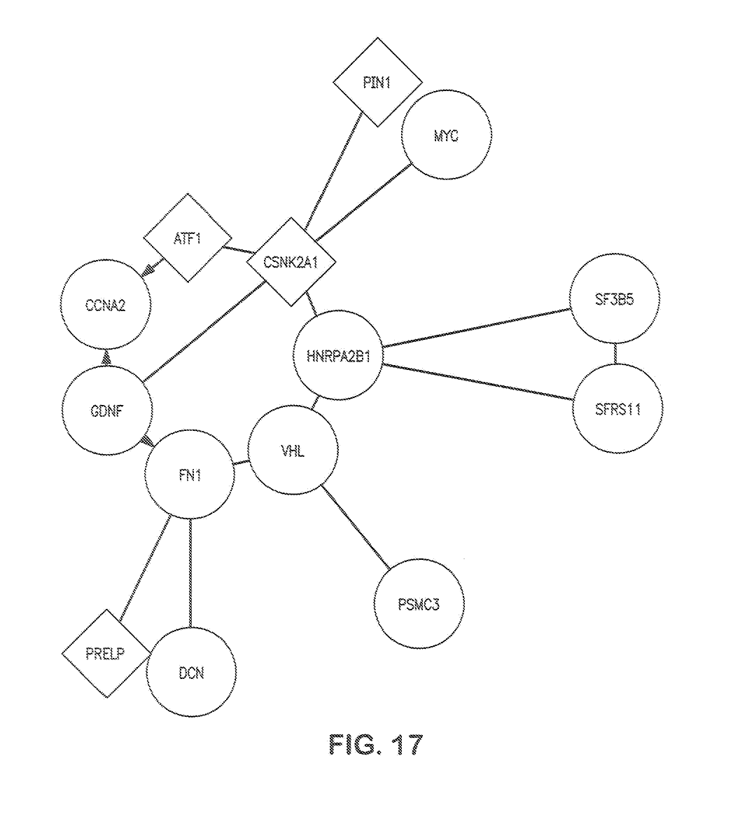

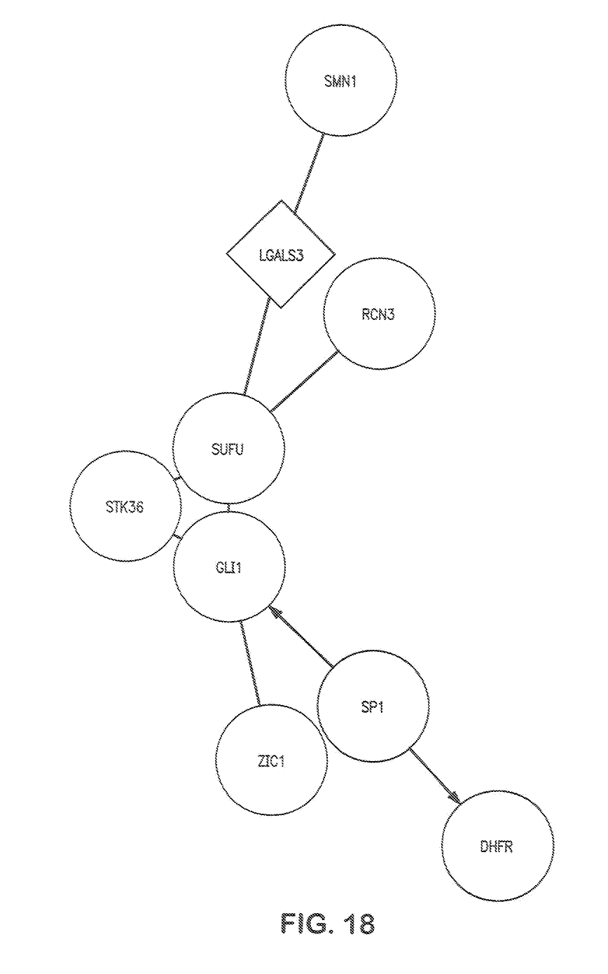

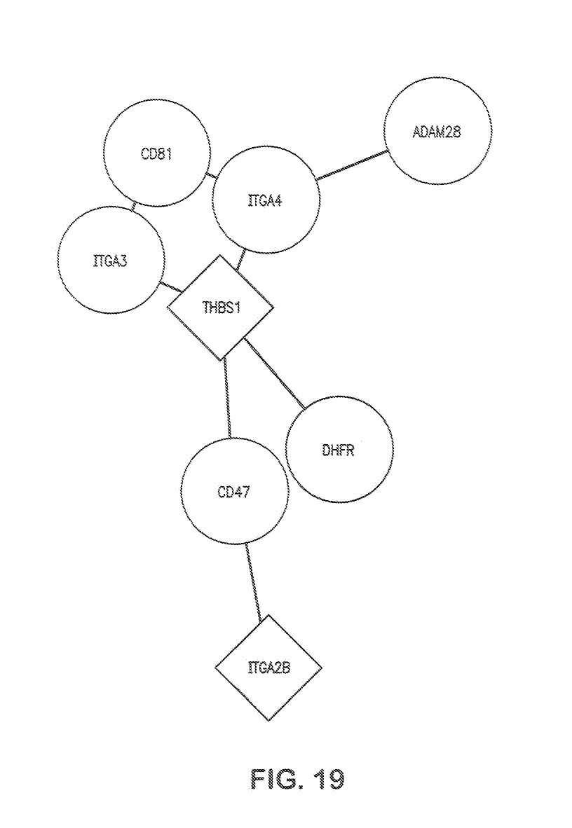

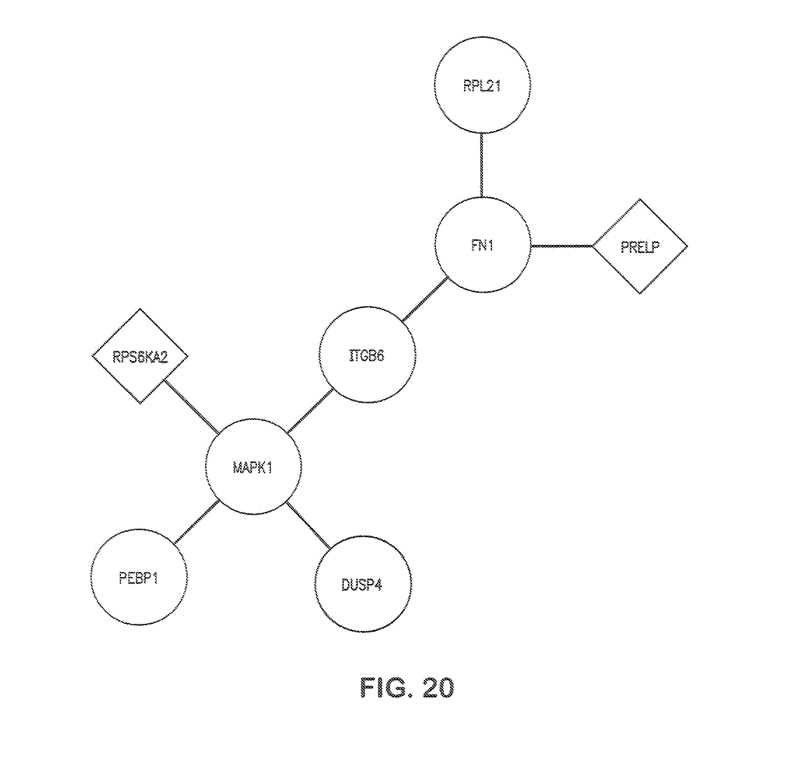

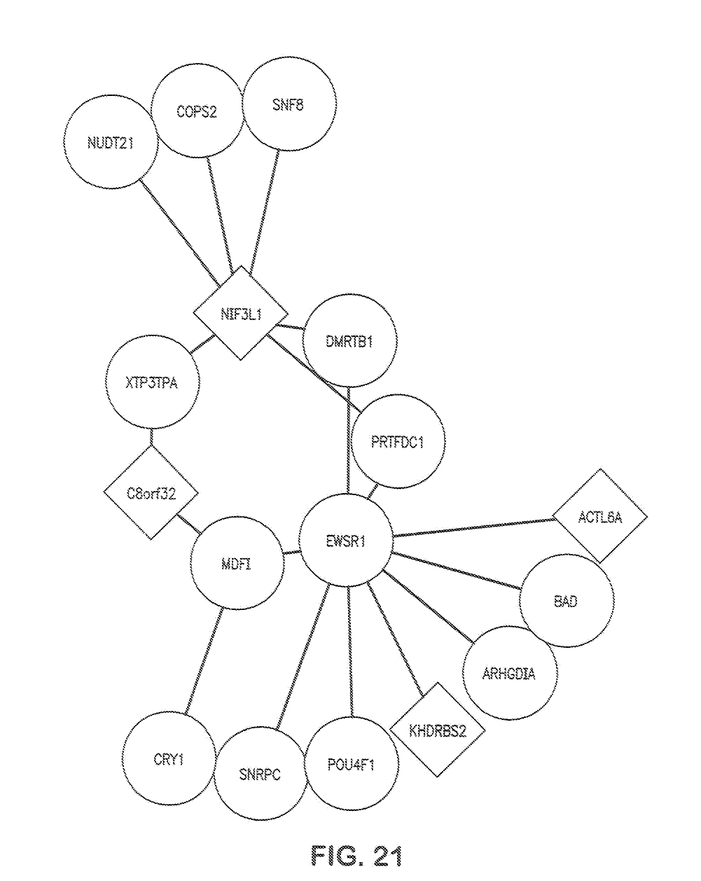

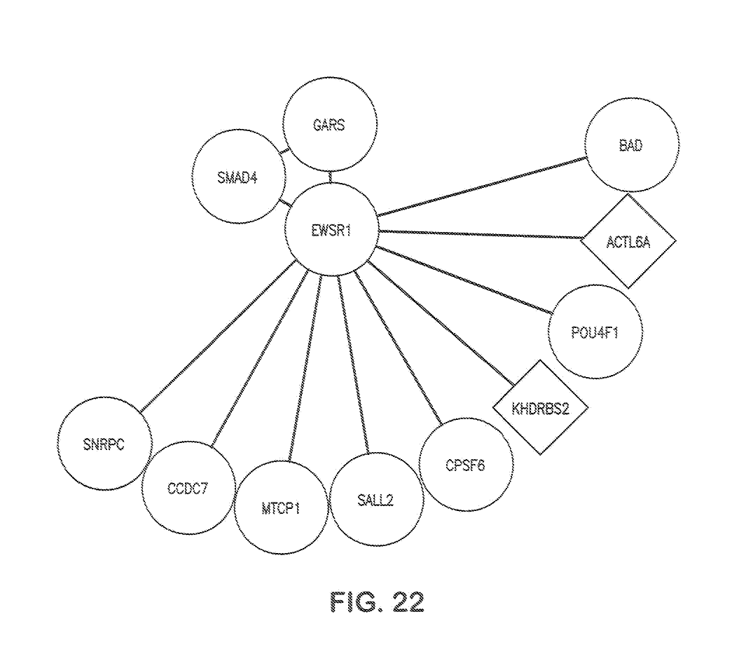

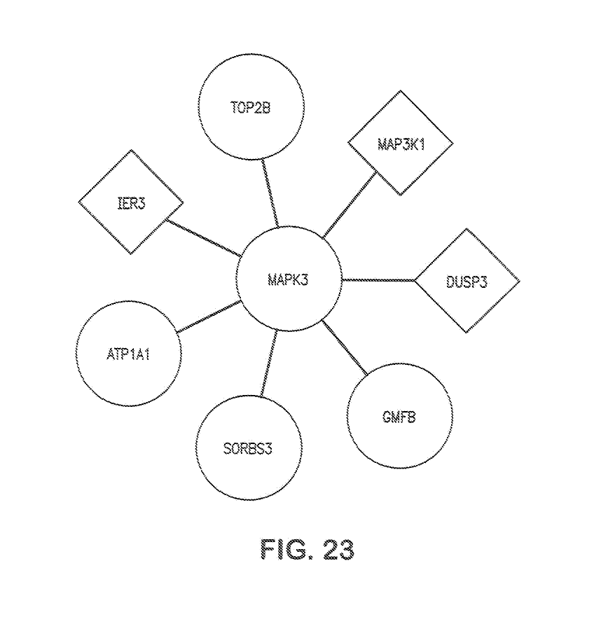

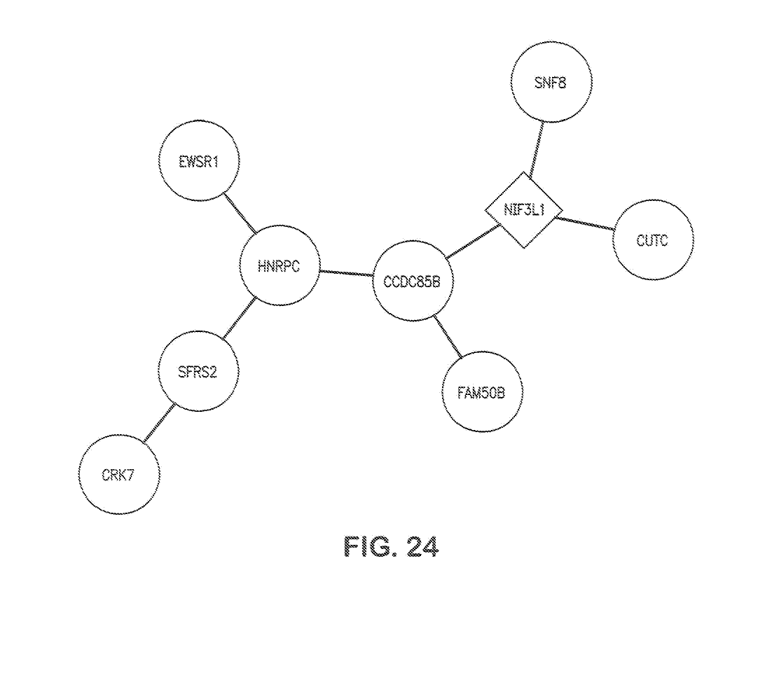

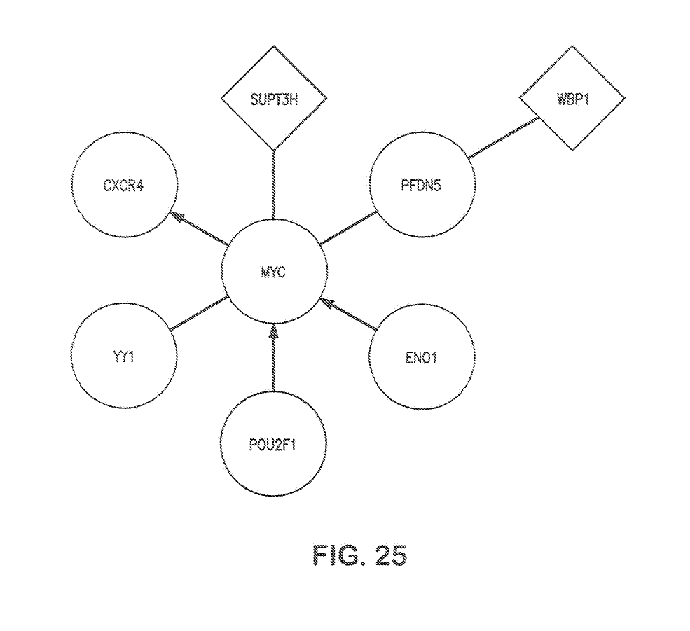

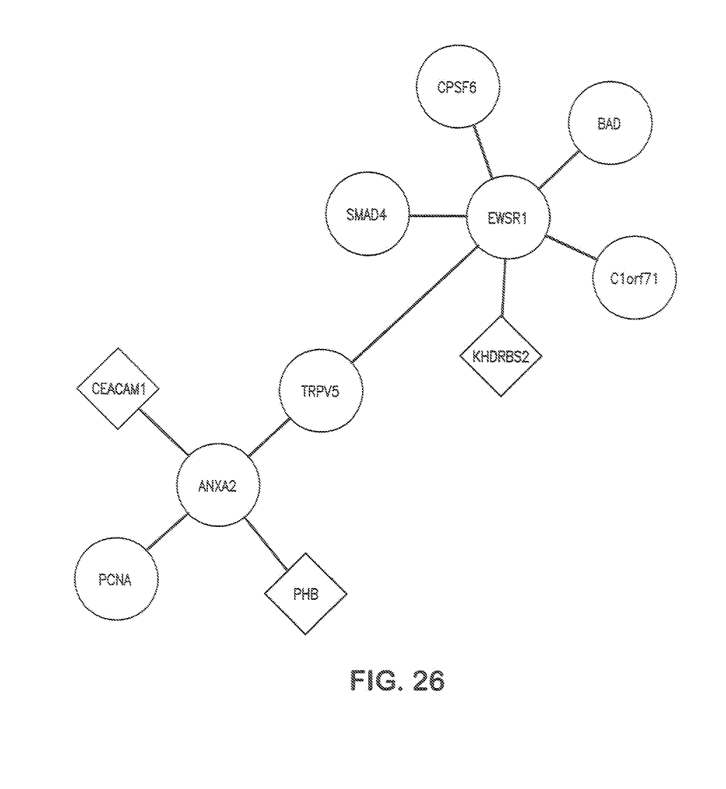

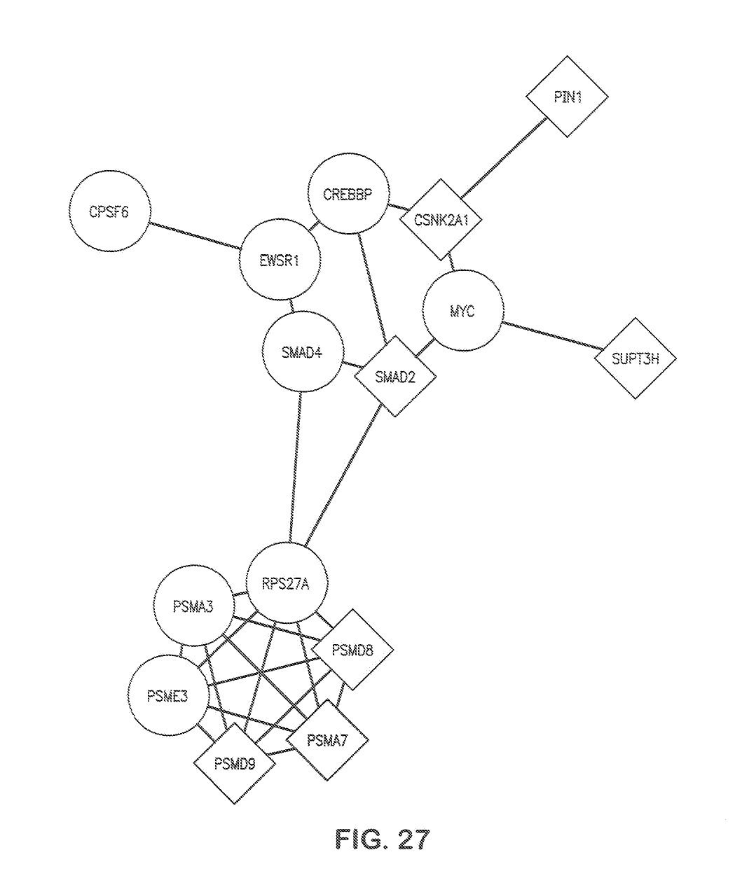

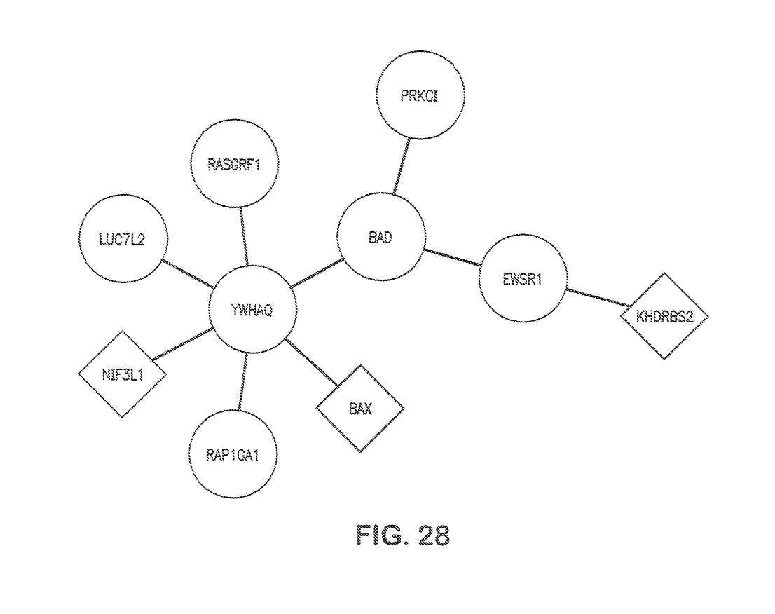

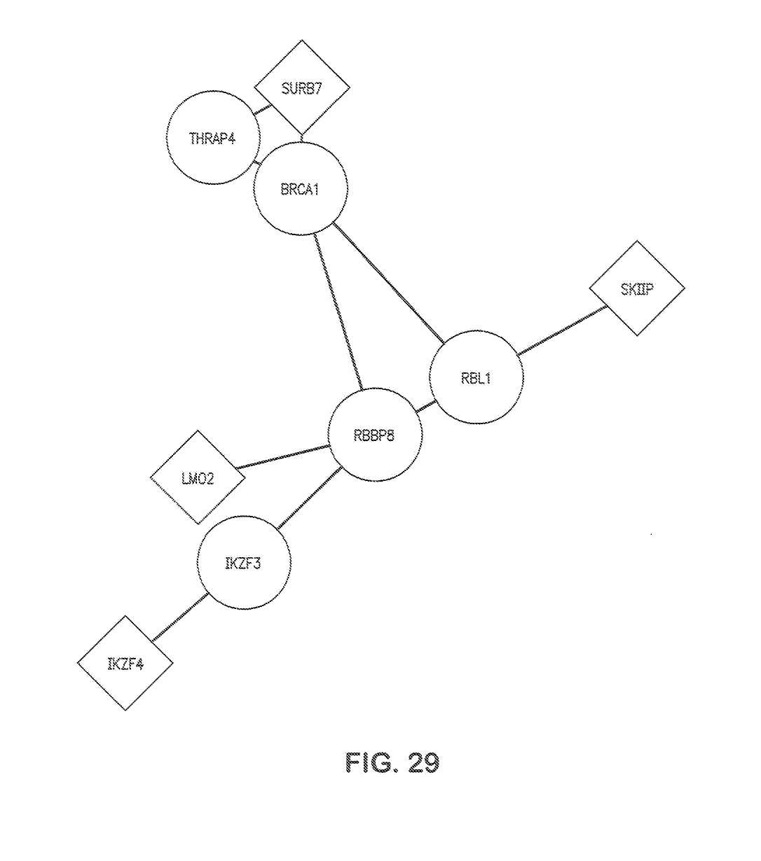

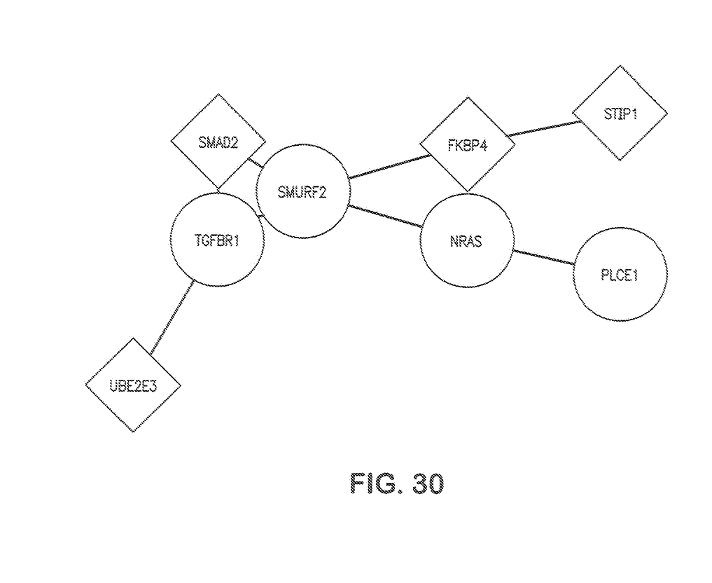

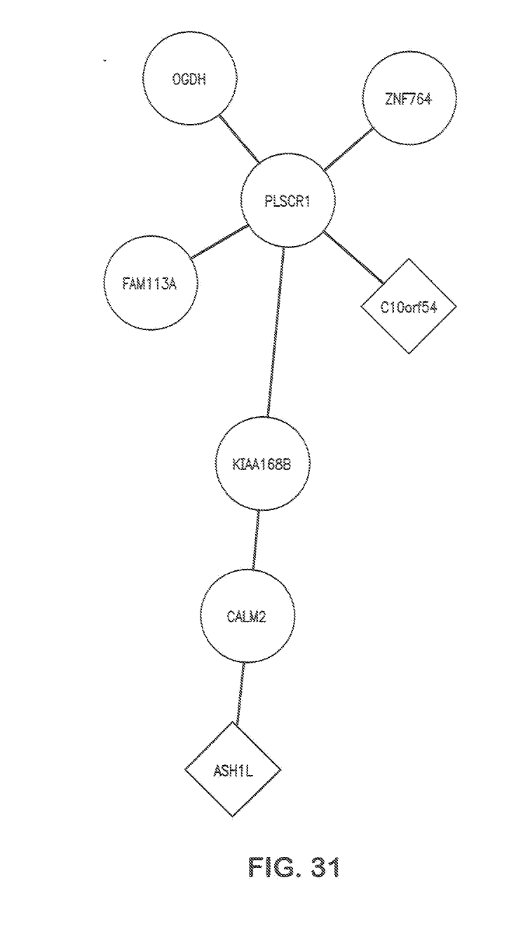

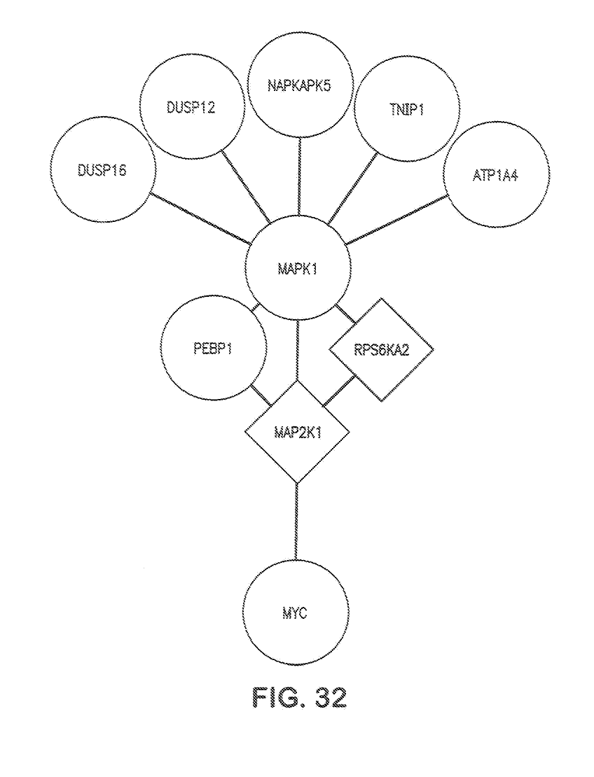

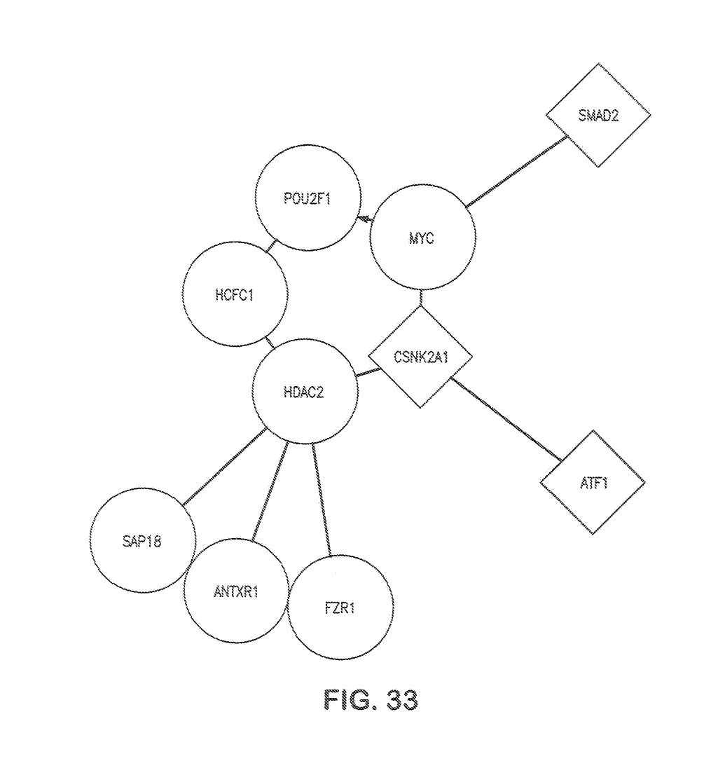

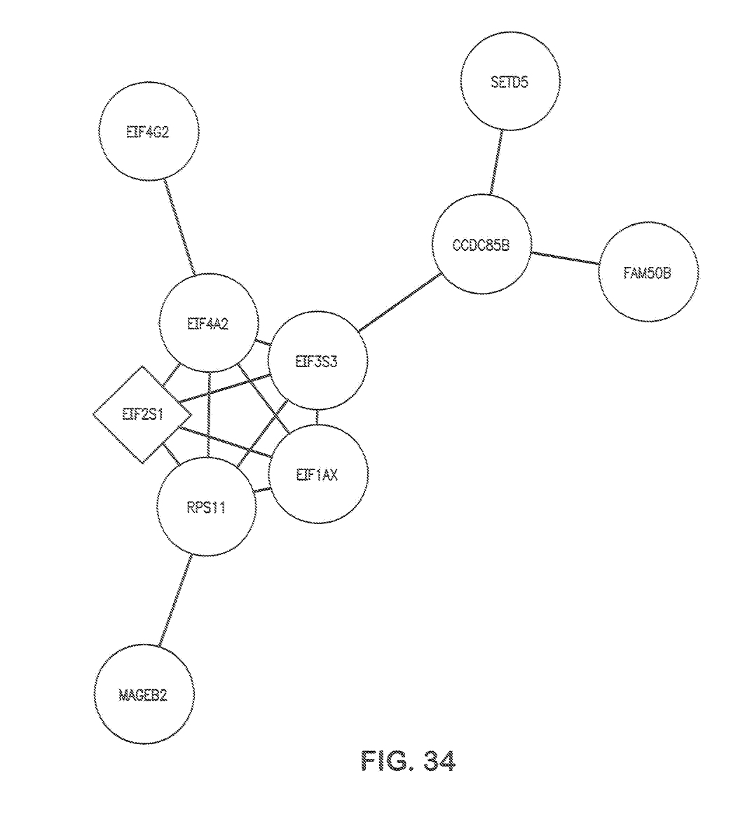

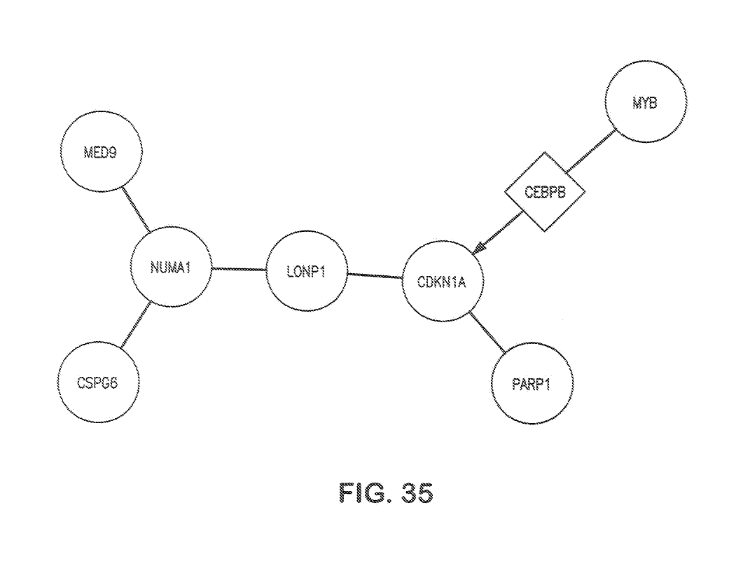

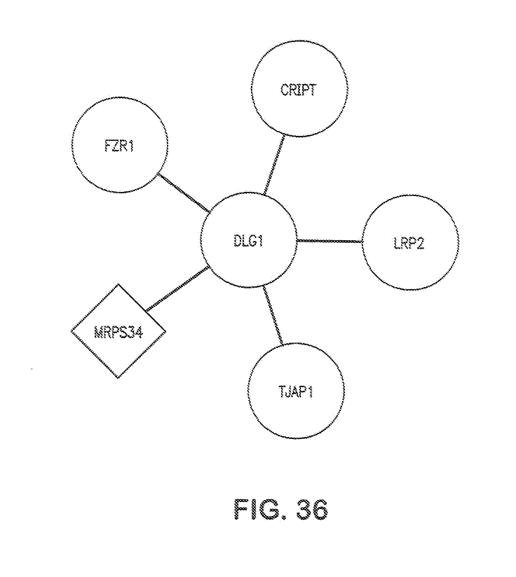

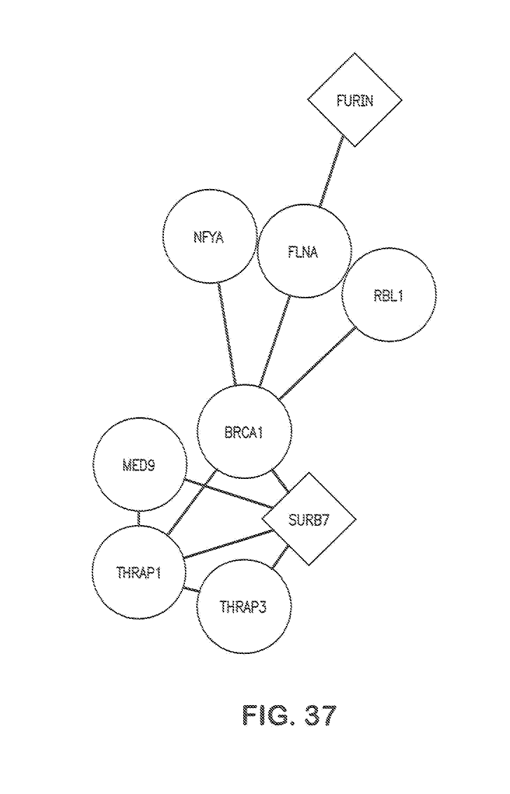

A panel of protein biomarkers that can be used collectively or individually to diagnose CLL are described in Tables 1 through 4 herein below. Analysis of the panel has also revealed that up- or downregulation of certain cellular pathways can be used as indicators of CLL, as described in Table 5 below. Likewise FIGS. 8 through 37 include biomarker clusters of genes implicated in CLL diagnosis and progression.

Most of the individual members of the panel, and the identified cellular pathways, have not previously been recognized as CLL biomarkers or drug targets. The panel of biomarkers can be quantitated using mass spectrometry, antibodies, or other assays well known in the art that identify and measure relative or absolute quantities of gene expression or the resulting proteins, such as expression profiling using microarray or SAGE technology.

Furthermore, the biomarkers can be used to discover drugs by developing assays that report agonist or antagonist interactions of drug candidates with the panel of biomarkers, both individually and collectively, and that report both direct and indirect effects on the biomarkers.

In all of the embodiments of the invention described herein, analysis, such as comparison of the data generated relating to gene expression, is generally performed using software algorithms generally known in the art. Thus generation, comparison and analysis of data is performed on computer-readable media including such software. The results are typically outputted to a user via a visual display.

The invention further provides a microarray device, such as a microarray including nucleotide sequences of the biomarkers disclosed herein. The microarrays are provided for obtaining clinically relevant data regarding CLL diagnosis and the like as described.

Microarrays or arrays of the present invention may include any one, two or three dimensional arrangement of addressable regions bearing a particular chemical moiety or moieties (for example, polynucleotide sequences) associated with that region. Preferably the chemical moieties include oligonucleotides (i.e., probes) An array is addressable in that it has multiple regions of different moieties (i.e., different oligonucleotide sequences) such that a region (i.e., a feature or spot of the array) is at a particular predetermined location (i.e., an address) on the array. An array layout refers to one or more characteristics of the array, such as feature positioning, feature size, and some indication of a moiety at a given location. An array includes a support substrate that may be of any suitable type known in the art, such as glass, to which one or more chemical moiety or moieties are linked or bound using methods well known in the art.

As used herein, the terms “polynucleotide” and “oligonucleotide” refer to nucleic acid molecules. A polynucleotide or oligonucleotide includes single or multiple stranded configurations, where one or more of the strands may or may not be completely aligned with another. The terms “polynucleotide” and “oligonucleotide” are intended to be generic to polydeoxyribonucleotides (containing 2-deoxy-D-ribose), polyribonucleotides (containing D-ribose), or any other type of polynucleotide which is an N-glycoside of a purine or pyrimidine base. Additionally, the terms are intended to include polymers in which the conventional backbone has been replaced with a non-naturally occurring or synthetic backbone or in which one or more of the conventional bases has been replaced with a non-naturally occurring or synthetic base. As such a polynucleotide or oligonucleotide may include naturally occurring nucleotides and phosphodiester bonds that are chemically synthesized.

While the terms “oligonucleotide” and “polynucleotide” are intended to be synonymous, an “oligonucleotide” may generally refer to a nucleotide multimer of about 2 to 100 nucleotides in length, such as a probe, while a “polynucleotide” includes a nucleotide multimer having any number of nucleotides, such as the entire genome of an organism or a portion thereof.

The probes for use with the microarray may be oligodeoxyribonucleotides or oligoribonucleotides, or any modified forms of these polymers that are capable of hybridizing with a target nucleic sequence by complementary base-pairing. Complementary base pairing means sequence-specific base pairing which includes, for example, Watson-Crick base pairing as well as other forms of base pairing such as Hoogsteen base pairing. Modified forms include 2′-O-methyl oligoribonucleotides and so-called PNAs, in which oligodeoxyribonucleotides are linked via peptide bonds rather than phosphodiester bonds. The probes can be attached by any linkage to a support substrate (i.e., 3′, 5′ or via the base).

A variety of methods are well known in the art for manufacturing microarrays, including methods for binding or affixing probes in a variety of configurations to a solid support, such as glass, plastic or silicon wafer. Such methods include fabrication using a variety of technologies, such as printing with fine-pointed pins onto glass slides, photolithography using pre-made masks, photolithography using dynamic micromirror devices, ink-jet printing, or electrochemistry on microelectrode arrays.

In various aspects, the number of probes affixed to the array support can be quite large. For example, the array may include up to about 6 million probes. Further, the probe sequences may be about 80, 85, 90, 95% or more, homologous to one or more nucleotide sequences of the biomarkers identified herein. For example, the probe sequences may be about 95% homologous or greater to the biomarkers indentified in FIGS. 8-37.

The following examples are provided to further illustrate the embodiments of the present invention, but are not intended to limit the scope of the invention. While they are typical of those that might be used, other procedures, methodologies, or techniques known to those skilled in the art may alternatively be used.

### EXAMPLE I

### Differential Expression of Biomarkers in Aggressive and Indolent CLL

Purified B cell samples from aggressive and indolent CLL patients were lysed and proteins were digested by trypsin. O16/O18 labeling was used for relative quantitation by spectra count, while iTRAQ labeling was used to obtain more accurate quantitation. An automated 2D nanoflow LC system was coupled to an LTQ mass spectrometer to identify and quantify the peptides. Mass spectra were searched against the IPI™ database using Agilent Spectrum Mill™ software. Search results for individual spectra were automatically validated using filtering criteria from an in-situ False Discovery Rate (FDR) calculation. IDs for identified proteins were converted to gene symbols and Unigene IDs using the IPI gene cross reference table. Protein function analysis was done using the NCI DAVID™ website.

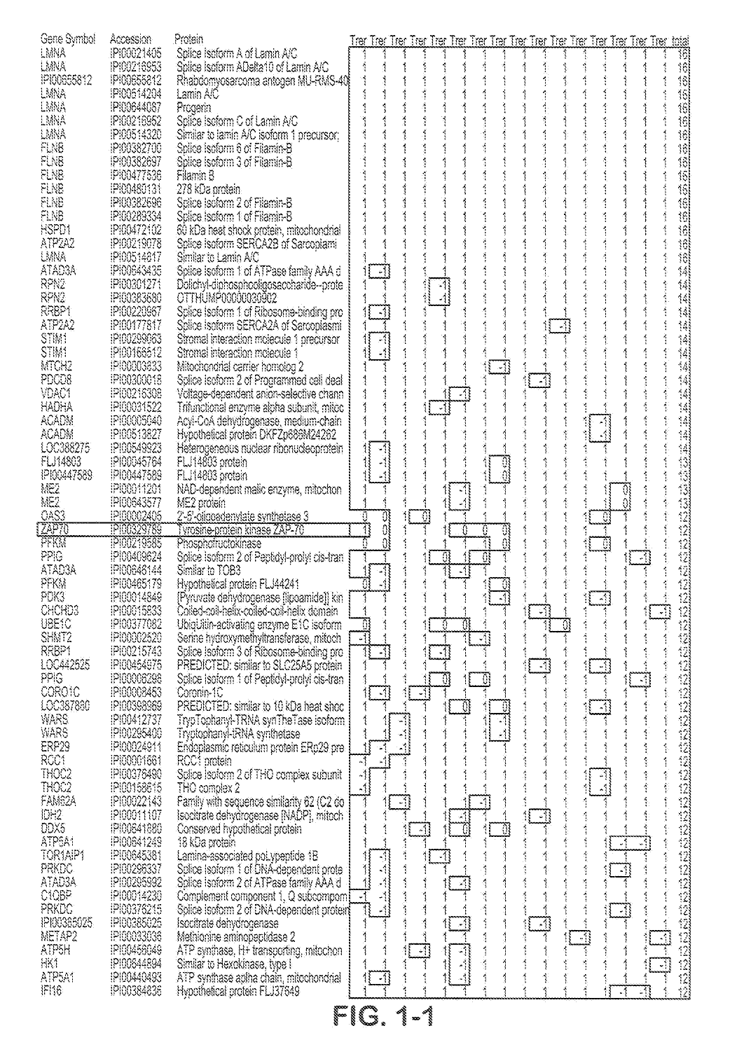

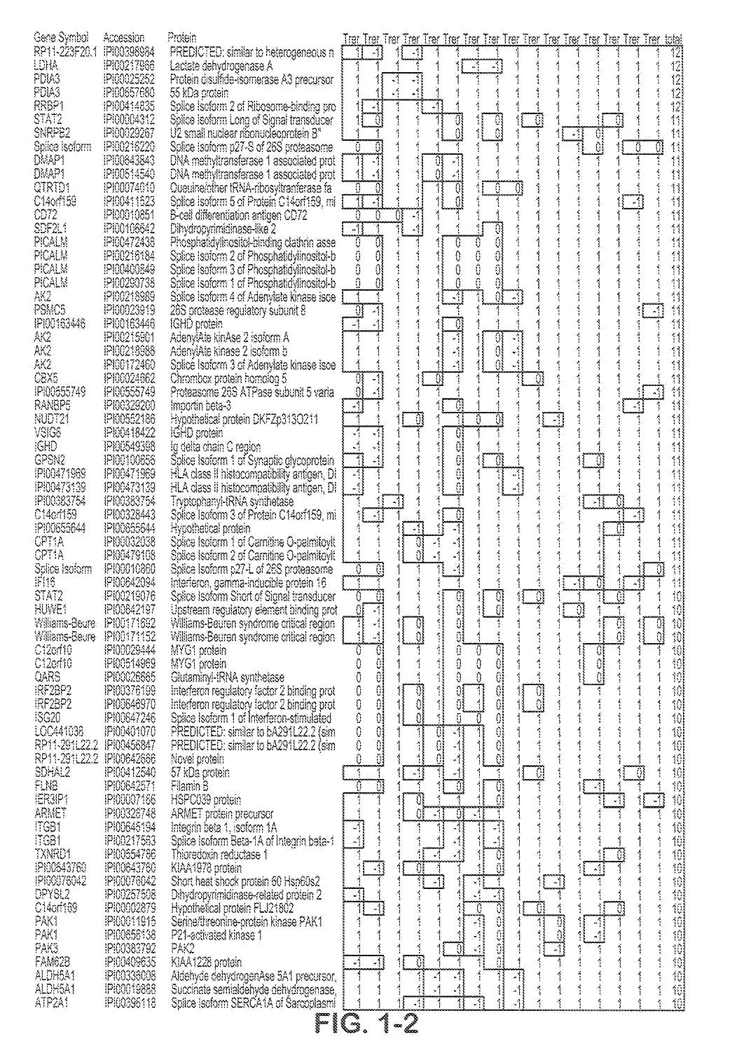

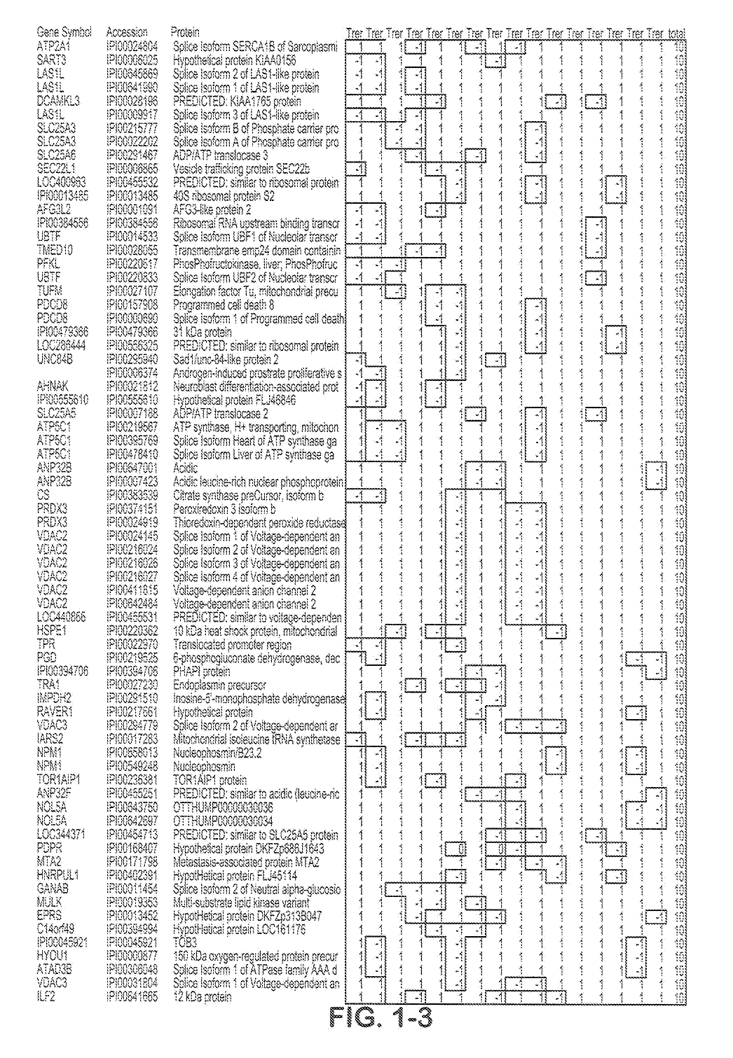

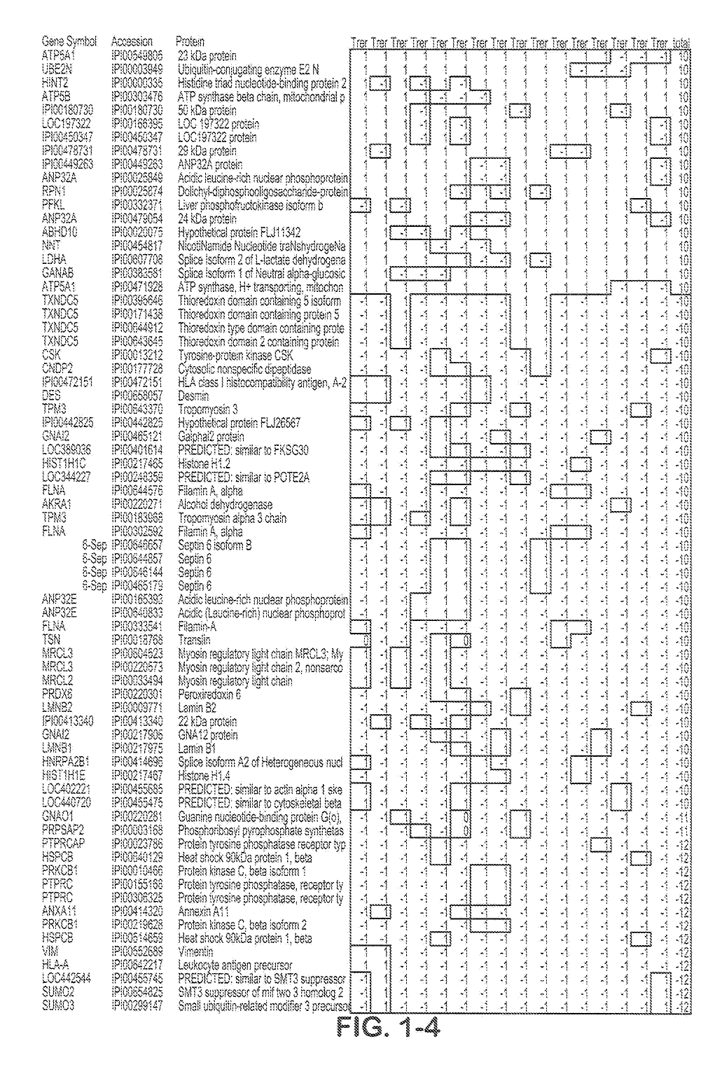

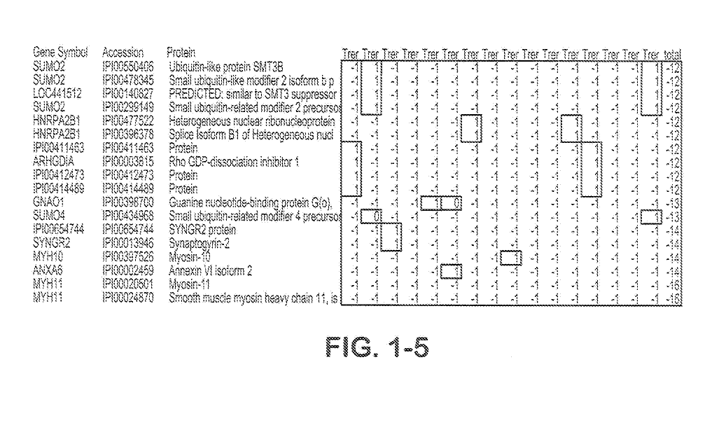

5 pairs of aggressive and indolent CLL samples were analyzed using O16/O18 labeling. A total of 15,442 IPI protein sequences were identified at a protein FDR of 3.5%, which corresponds to 6,348 unigenes. Relative protein spectra count ratio was used for quantitation. Spectra count ratio was digitized into either up (+1), down (−1), or undetected (0) categories. 16 replicate runs were performed to obtain good quantitative statistics. A protein relative abundance heat map was generated using this method (FIG. 1). The difference (N) of the “up” (Nᵤₚ)and “down” (N_{down}) frequencies was used to calculate the quantitation FDR (N=|Nᵤₚ−N_{down}|):

$$FDR = \frac{1}{{2}^{N - 1}}$$

Proteins that consistently shown up or down trends were selected as potential biomarkers (FIG. 1). Using a cutoff of N=10, 230 up-regulated and 71 down-regulated proteins in aggressive CLL were found. Among them, ZAP70 is a known marker for distinguishing aggressive CLL from indolent CLL.

Table 1 lists the panel of protein biomarkers that are up-regulated in aggressive CLL compared to indolent CLL B-cells.

TABLE 1
Proteins that are up-regulated in aggressive CLL compared to indolent CLL B-cells.

| Gene Symbol | Unigene | Accession | Protein |
|---|---|---|---|
| SERPINB6 | Hs.519523; | IPI00413451 | SERPINB6 Hypothetical protein DKFZp686I04222 |
| FKBP5 | Hs.407190; | IPI00218775 | FKBP5 FK506-binding protein 5 |
| PSMD13 | Hs.134688; | IPI00552191 | PSMD13 Hypothetical protein DKFZp686H16220 |
| FHOD1 | Hs.95231; | IPI00001730 | FHOD1 FH1/FH2 domain-containing protein 1 |
| ZAP70 | Hs.234569; | IPI00783674 | ZAP70 Tyrosine-protein kinase ZAP-70 |
| IPI00784519 | IPI00784519 | IPI00784519 | Hypothetical protein |
| LOC642956 | IPI00737213 | IPI00737213 | LOC642956 similar to Fatty acid-binding protein, epidermal |
| MX1 | Hs.517307; | IPI00167949 | MX1 Interferon-induced GTP-binding protein Mx1 |
| ITGAX | Hs.248472; | IPI00302270 | ITGAX Integrin alpha-X precursor |
| BLVRB | Hs.515785; | IPI00219910 | BLVRB 23 kDa protein |
| RNASE3 | Hs.73839; | IPI00025427 | RNASE3 Eosinophil cationic protein precursor |
| RAB32 | Hs.287714; | IPI00014377 | RAB32 Ras-related protein Rab-32 |
| ARFGAP1 | Hs.25584; | IPI00217354 | ARFGAP1 Isoform 2 of ADP-ribosylation factor GTPase-activating protein 1 |
| NAIP1B | IPI00398857 | IPI00398857 | NAIP1B similar to Baculoviral IAP repeat-containing protein 1 |
| LOC654029 | IPI00787407 | IPI00787407 | LOC654029 similar to 40S ribosomal protein S10 |
| CRIP2 | Hs.534309; | IPI00006034 | CRIP2 Cysteine-rich protein 2 |
| ARIH2 | Hs.649132; | IPI00792023 | ARIH2 Ariadne homolog 2 variant |
| USP28 | Hs.503891; | IPI00103951 | USP28 Isoform 2 of Ubiquitin carboxyl-terminal hydrolase 28 |
| HIP1R | Hs.654842; | IPI00792558 | HIP1R 69 kDa protein |
| | Hs.524815; | | |
| RCN1 | Hs.97887; | IPI00015842 | RCN1 Reticulocalbin-1 precursor |
| IPI00021711 | IPI00021711 | IPI00021711 | HLA-DPA1 HLA class II histocompatibility antigen, DP alpha chain |
| | | | precursor |
| MRPL19 | Hs.44024; | IPI00027096 | MRPL19 39S ribosomal protein L19, mitochondrial precursor |
| PFKM | Hs.75160; | IPI00743142 | PFKM Isoform 1 of 6-phosphofructokinase, muscle type |
| KIAA0196 | Hs.270043; | IPI00748472 | KIAA0196 Protein KIAA0196 variant |
| MARCKSL1 | Hs.75061; | IPI00641181 | MARCKSL1 MARCKS-related protein |
| NDUFA11 | Hs.406062; | IPI00329301 | NDUFA11 NADH dehydrogenase [ubiquinone] 1 alpha subcomplex |
| | | | subunit 11 |
| DHTKD1 | Hs.612022; | IPI00063408 | DHTKD1 dehydrogenase E1 and transketolase domain containing protein 1 |
| | Hs.104980; | | |
| PEX11B | Hs.504284; | IPI00021978 | PEX11B Peroxisomal membrane protein 11B |
| MRPL1 | Hs.532019; | IPI00549381 | MRPL1 mitochondrial ribosomal protein L1 precursor |
| UBE3A | Hs.654383; | IPI00219197 | UBE3A Isoform I of Ubiquitin-protein ligase E3A |
| MYCBP2 | Hs.591221; | IPI00607852 | MYCBP2 Isoform 2 of Probable E3 ubiquitin-protein ligase MYCBP2 |
| HTRA2 | Hs.469045; | IPI00001663 | HTRA2 Isoform 1 of Serine protease HTRA2, mitochondrial precursor |
| GTF2B | Hs.481852; | IPI00643469 | GTF2B General transcription factor IIB |
| APOL2 | Hs.474740; | IPI00220007 | APOL2 Apolipoprotein-L2 |
| PBXIP1 | Hs.505806; | IPI00645060 | PBXIP1 Pre-B-cell leukemia transcription factor interacting protein 1 |
| PTPN11 | Hs.506852; | IPI00298347 | PTPN11 Isoform 2 of Tyrosine-protein phosphatase non-receptor type 11 |
| | Hs.646231; | | |
| ARL2 | Hs.502836; | IPI00003326 | ARL2, SNX15 ADP-ribosylation factor-like protein 2 |
| DTX3L | Hs.518201; | IPI00152503 | DTX3L Protein deltex 3-like protein |
| EIF4B | Hs.648394; | IPI00439415 | EIF4B eukaryotic translation initiation factor 4B |
| | Hs.655133; | | |
| PITPNA | Hs.429819; | IPI00216048 | PITPNA Phosphatidylinositol transfer protein alpha isoform |
| CSNK2A1 | Hs.644056; | IPI00744507 | CSNK2A1 Casein kinase II subunit alpha |
| HK2 | Hs.591588; | IPI00102864 | HK2 Hexokinase-2 |
| | Hs.406266; | | |
| NDRG1 | Hs.372914; | IPI00183085 | NDRG1 CDNA FLJ38330 fis, clone FCBBF3025280, highly similar to NDRG1 |
| | | | PROTEIN |
| TSTA3 | Hs.404119; | IPI00014361 | TSTA3 GDP-L-fucose synthetase |
| BCL7C | Hs.658547; | IPI00449172 | BCL7C Hypothetical protein |
| CREB1 | Hs.584750; | IPI00218334 | CREB1 Isoform CREB-B of cAMP response element-binding protein |
| TBXAS1 | Hs.520757; | IPI00788599 | TBXAS1 thromboxane A synthase 1 (platelet, cytochrome P450, family 5, |
| | | | subfamily A) isoform TXS-I |
| MMRN1 | Hs.268107; | IPI00012269 | MMRN1 Multimerin-1 precursor |
| PAICS | Hs.518774; | IPI00815732 | PAICS phosphoribosylaminoimidazole carboxylase, |
| | Hs.655926; | | phosphoribosylaminoimidazole succinocarboxamide synthetase isoform 1 |
| LDHB | Hs.446149; | IPI00219217 | LDHB L-lactate dehydrogenase B chain |
| TMEM70 | Hs.106650; | IPI00106966 | TMEM70 Isoform 1 of Transmembrane protein 70 |
| IPI00171438 | IPI00171438 | IPI00171438 | MUTED, TXNDC5 Thioredoxin domain-containing protein 5 precursor |
| NP | Hs.75514; | IPI00017672 | NP CDNA FLJ25678 fis, clone TST04067, highly similar to PURINE |
| | | | NUCLEOSIDE PHOSPHORYLASE |
| FKBP3 | Hs.509226; | IPI00024157 | FKBP3 FK506-binding protein 3 |

Table 2 lists the panel of protein biomarkers that are down-regulated in aggressive CLL compared to indolent CLL B-cells.

TABLE 2
Proteins that are down-regulated in aggressive CLL compared to indolent CLL B-cells.

| Gene Symbol | Unigene | Accession | Protein |
|---|---|---|---|
| SWAP70 | Hs.153026; | IPI00307200 | SWAP70 Switch-associated protein 70 |
| GPD2 | Hs.512382; | IPI00017895 | GPD2 Isoform 1 of Glycerol-3-phosphate dehydrogenase, |
| | | | mitochondrial precursor |
| HIST1H1C | Hs.7644; | IPI00217465 | HIST1H1C Histone H1.2 |
| CAPG | Hs.516155; | IPI00027341 | CAPG Macrophage-capping protein |
| NSL1 | Hs.497692; | IPI00306330 | NSL1 Kinetochore-associated protein NSL1 homolo |
| FAM82C | Hs.511067; | IPI00410079 | FAM82C Isoform 1 of Protein FAM82C |
| CCBL1 | Hs.495250; | IPI00002523 | CCBL1 Isoform 1 of Kynurenine-oxoglutarate transaminase 1 |
| DDEF1 | Hs.655552; | IPI00410303 | DDEF1 Isoform 2 of 130 kDa phosphatidylinositol 4,5-biphosphate- |
| | | | dependent ARF1 GTPase-activating protein |
| OSGEP | Hs.525196; | IPI00015809 | OSGEP Probable O-sialoglycoprotein endopeptidase |
| AKAP8 | Hs.631640; | IPI00014474 | AKAP8 A-kinase anchor protein 8 |
| BACH2 | Hs.269764; | IPI00029178 | BACH2 Transcription regulator protein BACH2 |
| SIRT2 | Hs.466693; | IPI00382551 | SIRT2 Isoform 2 of NAD-dependent deacetylase sirtuin-2 |
| RFC5 | Hs.506989; | IPI00373883 | RFC5 RFC5 protein |
| KIAA1598 | Hs.501140; | IPI00448751 | KIAA1598 Protein KIAA1598 |
| IPI00827623 | IPI00827623 | IPI00827623 | CDNA FLJ44136 fis, clone THYMU2009157, moderately similar to Mus |
| | | | musculus MRPS18b mitochondrial ribosomal protein S18b |
| RAB3GAP2 | IPI00554590 | IPI00554590 | RAB3GAP2 Isoform 1 of Rab3 GTPase-activating protein non-catalytic |
| | | | subunit |
| NDUFB6 | Hs.493668; | IPI00219385 | NDUFB6 NADH dehydrogenase [ubiquinone] 1 beta subcomplex |
| | | | subunit 6 |
| AP1B1 | Hs.368794; | IPI00413947 | AP1B1 Isoform B of AP-1 complex subunit beta-1 |
| DYSF | Hs.252180; | IPI00020210 | DYSF Dysferlin_v1 |
| NDNL2 | Hs.656412; | IPI00217104 | NDNL2 Melanoma-associated antigen G1 |
| AYTL2 | Hs.368853; | IPI00171626 | AYTL2 1-acylglycerophosphocholine O-acyltransferase 1 |
| F11R | Hs.517293; | IPI00001754 | F11R Junctional adhesion molecule A precursor |
| EIF2A | Hs.655782; | IPI00012462 | EIF2A Eukaryotic translation initiation factor 2A |
| TAF6 | Hs.489309; | IPI00028579 | TAF6 Transcription initiation factor TFIID subunit 6 |
| REXO2 | Hs.7527; | IPI00032830 | REXO2 Isoform 1 of Oligoribonuclease, mitochondrial precursor |
| | Hs.677190; | | (Fragment) |
| RP6-213H19.1 | Hs.444247; | IPI00182383 | RP6-213H19.1 serine/threonine protein kinase MST4 isoform 3 |
| LOC652614 | IPI00739274 | IPI00739274 | LOC652614 similar to HLA class I histocompatibility antigen, A-11 |
| | | | alpha chain precursor |
| ANXA6 | Hs.412117; | IPI00002459 | ANXA6 annexin VI isoform 2 |
| LOC730410 | IPI00797359 | IPI00797359 | MICA, HLA-A, HLA-A29.1, LOC730410, HLA-B, HLA-C Major |
| | | | histocompatibility complex, class I, C |
| H2AFX | Hs.477879; | IPI00219037 | H2AFX Histone H2A.x |
| FAM63A | Hs.3346; | IPI00413164 | FAM63A hypothetical protein LOC55793 isoform 1 |
| AK1 | Hs.175473; | IPI00018342 | AK1 Adenylate kinase isoenzyme 1 |
| SMC5 | Hs.534189; | IPI00843768 | SMC5 Structural maintenance of chromosomes protein 5 |
| PRKAR2B | Hs.433068; | IPI00554752 | PRKAR2B cAMP-dependent protein kinase type II-beta regulatory |
| | | | subunit |
| GNAO1 | Hs.654647; | IPI00398700 | GNAO1 Guanine nucleotide-binding protein G(o) subunit alpha 2 |
| HLA-DQB1 | Hs.534322; | IPI00472502 | HLA-DQB1 HLA class II histocompatibility antigen, DQ(W3) beta chain |
| | Hs.653339; | | precursor |
| | Hs.409934; | | |
| NCK2 | Hs.657909; | IPI00306531 | NCK2 Cytoplasmic protein NCK2 |
| IGHG1 | IPI00448925 | IPI00448925 | IGHG1 IGHG1 protein |
| IPI00641330 | IPI00641330 | IPI00641330 | RING1 Isoform 1 of E3 ubiquitin-protein ligase RING1 |
| WHSC1L1 | Hs.608111; | IPI00743157 | WHSC1L1 Isoform 1 of Histone-lysine N-methyltransferase NSD3 |
| DYNLL2 | Hs.591176; | IPI00062037 | DYNLL2 Dynein light chain 2, cytoplasmic |
| RAB6B | IPI00016891 | IPI00016891 | RAB6B Ras-related protein Rab-6B |
| PTDSS1 | Hs.292579; | IPI00010746 | PTDSS1 Phosphatidylserine synthase 1 |
| NUP160 | Hs.643526; | IPI00748807 | NUP160 Isoform 1 of Nuclear pore complex protein Nup160 |
| HIST1H1A | Hs.150206; | IPI00217469 | HIST1H1A Histone H1.1 |
| FLJ12949 | Hs.693832; | IPI00186139 | FLJ12949 CDNA FLJ36560 fis, clone TRACH2009340 |

Table 3 lists the panel of protein biomarkers that are up-regulated in CLL compared to normal B-cells.

TABLE 3
Proteins that are up-regulated in CLL compared to normal B-cells.

| Gene Symbol | Unigene | Accession | Protein |
|---|---|---|---|
| HIST2H2AB | Hs.664173; | IPI00216730 | HIST2H2AB Histone H2A type 2-B |
| HIST1H1C | Hs.7644; | IPI00217465 | HIST1H1C Histone H1.2 |
| RAB15 | Hs.512492; | IPI00383449 | RAB15 Isoform 2 of Ras-related protein Rab-15 |
| RAB33B | Hs.591679; | IPI00021475 | RAB33B Ras-related protein Rab-33B |
| TMPRSS13 | Hs.266308; | IPI00012505 | TMPRSS13 Isoform 3 of Transmembrane protease, serine 13 |
| SNRPE | Hs.334612; | IPI00029266 | SNRPE Small nuclear ribonucleoprotein E |
| | Hs.654418; | | |
| IPI00455457 | IPI00455457 | IPI00455457 | Histone 2, H3, pseudogene 2 |
| RPSA | IPI00553164 | IPI00553164 | RPSA 40S ribosomal protein SA |
| IPI00787692 | IPI00787692 | IPI00787692 | 8 kDa protein |
| HNRPD | Hs.480073; | IPI00220684 | HNRPD Isoform 3 of Heterogeneous nuclear ribonucleoprotein D0 |
| HNRPA3 | Hs.516539; | IPI00419373 | HNRPA3 Isoform 1 of Heterogeneous nuclear ribonucleoprotein A3 |
| FAU | Hs.387208; | IPI00397098 | FAU 40S ribosomal protein S30 |
| METTL7A | Hs.675538; | IPI00022300 | METTL7A Methyltransferase-like protein 7A precursor |
| | Hs.655369; | | |
| PARP1 | Hs.177766; | IPI00449049 | PARP1 Poly [ADP-ribose] polymerase 1 |
| FUS | Hs.513522; | IPI00785172 | FUS Fusion (Involved in t(12,16) in malignant liposarcoma) isoform a |
| | | | variant (Fragment) |
| DEK | Hs.484813; | IPI00020021 | DEK Protein DEK |
| HP1BP3 | Hs.142442; | IPI00642238 | HP1BP3 Hypothetical protein DKFZp434I0612 |
| ALDH5A1 | Hs.371723; | IPI00336008 | ALDH5A1 aldehyde dehydrogenase 5A1 precursor, isoform 1 |
| THOC4 | Hs.534385; | IPI00328840 | THOC4 THO complex subunit 4 |
| FBL | Hs.299002; | IPI00025039 | FBL rRNA 2′-O-methyltransferase fibrillarin |
| SRP14 | Hs.533732; | IPI00293434 | SRP14 Signal recognition particle 14 kDa protein |
| LOC653884 | IPI00736887 | IPI00736887 | LOC653884 similar to FUS interacting protein (serine-arginine rich) 1 |
| NOL5A | Hs.376064; | IPI00411937 | NOL5A Nucleolar protein 5A |
| NOLA2 | Hs.27222; | IPI00041325 | NOLA2 H/ACA ribonucleoprotein complex subunit 2 |
| HIST1H1E | Hs.248133; | IPI00217467 | HIST1H1E Histone H1.4 |
| NOP5/NOP58 | Hs.471104; | IPI00006379 | NOP5/NOP58 Nucleolar protein 5 |
| HNRPH3 | Hs.643472; | IPI00216492 | HNRPH3 Isoform 2 of Heterogeneous nuclear ribonucleoprotein H3 |
| CUGBP2 | Hs.309288; | IPI00845479 | CUGBP2 CUG triplet repeat, RNA binding protein 2 isoform 2 |
| IPI00011654 | IPI00011654 | IPI00011654 | TUBB Tubulin beta chain |
| MCCC1 | Hs.47649; | IPI00024580 | MCCC1 Methylcrotonoyl-CoA carboxylase subunit alpha, mitochondrial |
| | | | precursor |
| NHP2L1 | Hs.182255; | IPI00026167 | NHP2L1 NHP2-like protein 1 |
| BUB3 | Hs.418533; | IPI00013468 | BUB3 Mitotic checkpoint protein BUB3 |
| HNRPU | Hs.166463; | IPI00644079 | HNRPU heterogeneous nuclear ribonucleoprotein U isoform a |
| IPI00013174 | IPI00013174 | IPI00013174 | TMEM137, RBM14 Isoform 1 of RNA-binding protein 14 |
| VDAC2 | Hs.355927; | IPI00216027 | VDAC2 Isoform 4 of Voltage-dependent anion-selective channel protein 2 |
| NPM1 | Hs.557550; | IPI00549248 | NPM1 Isoform 1 of Nucleophosmin |
| APEX1 | Hs.73722; | IPI00215911 | APEX1 DNA-(apurinic or apyrimidinic site) lyase |
| HNRPA2B1 | Hs.487774; | IPI00396378 | HNRPA2B1 Isoform B1 of Heterogeneous nuclear ribonucleoproteins |
| | | | A2/B1 |
| NCL | Hs.79110; | IPI00827674 | NCL Isoform 2 of Nucleolin |
| COX5A | Hs.401903; | IPI00025086 | COX5A Cytochrome c oxidase subunit 5A, mitochondrial precursor |
| DPM1 | Hs.654951; | IPI00790317 | DPM1 Dolichyl-phosphate mannosyltransferase polypeptide 1, catalytic |
| | | | subunit |
| ZNF22 | Hs.655124; | IPI00215890 | ZNF22 Zinc finger protein 22 |
| | Hs.462693; | | |
| RPA1 | Hs.461925; | IPI00020127 | RPA1 Replication protein A 70 kDa DNA-binding subunit |
| | Hs.595562; | | |
| HNRPUL2 | IPI00456887 | IPI00456887 | HNRPUL2 Heterogeneous nuclear ribonucleoprotein U-like protein 2 |
| GOT2 | Hs.599470; | IPI00018206 | GOT2 Aspartate aminotransferase, mitochondrial precursor |
| SHMT2 | Hs.75069; | IPI00002520 | SHMT2 Serine hydroxymethyltransferase, mitochondrial precursor |
| SMCHD1 | Hs.8118; | IPI00847644 | SMCHD1 structural maintenance of chromosomes flexible hinge domain |
| | | | containing 1 |
| PCK2 | Hs.75812; | IPI00797038 | PCK2 mitochondrial phosphoenolpyruvate carboxykinase 2 isoform 1 |
| | | | precursor |
| ILF2 | Hs.75117; | IPI00005198 | ILF2 Interleukin enhancer-binding factor 2 |
| U2AF1 | Hs.365116; | IPI00005613 | U2AF1 Splicing factor U2AF 35 kDa subunit |
| ELAVLI | Hs.660070; | IPI00301936 | ELAVL1 ELAV-like protein 1 |
| | Hs.184492; | | |
| VDAC1 | Hs.519320; | IPI00216308 | VDAC1 Voltage-dependent anion-selective channel protein 1 |
| HSPE1 | Hs.1197; | IPI00220362 | HSPE1 10 kDa heat shock protein, mitochondrial |
| FIP1L1 | Hs.518760; | IPI00395337 | FIP1L1 Isoform 1 of Pre-mRNA 3′-end-processing factor FIP1 |
| SFRS1 | Hs.68714; | IPI00215884 | SFRS1 Isoform ASF-1 of Splicing factor, arginine/serine-rich 1 |
| SFRS3 | Hs.405144; | IPI00010204 | SFRS3 Splicing factor, arginine/serine-rich 3 |
| NDUFV2 | Hs.464572; | IPI00646556 | NDUFV2 28 kDa protein |
| DCI | Hs.403436; | IPI00300567 | DCI Isoform 1 of 3,2-trans-enoyl-CoA isomerase, mitochondrial precursor |
| HLA-DRA | Hs.520048; | IPI00005171 | HLA-DRA HLA class II histocompatibility antigen, DR alpha chain |
| | | | precursor |
| MTCH2 | Hs.269944; | IPI00003833 | MTCH2 Mitochondrial carrier homolog 2 |
| MATR3 | Hs.268939; | IPI00789551 | MATR3 100 kDa protein |
| DHX9 | Hs.191518; | IPI00844578 | DHX9 ATP-dependent RNA helicase A |
| LOC138046 | Hs.121663; | IPI00790685 | LOC138046 34 kDa protein |
| CD72 | Hs.116481; | IPI00010851 | CD72 B-cell differentiation antigen CD72 |
| ECH1 | Hs.196176; | IPI00011416 | ECH1 Delta(3,5)-Delta(2,4)-dienoyl-CoA isomerase, mitochondrial |
| | | | precursor |
| STRBP | Hs.287659; | IPI00169430 | STRBP Isoform 1 of Spermatid perinuclear RNA-binding protein |
| HNRPA0 | Hs.96996; | IPI00011913 | HNRPA0 Heterogeneous nuclear ribonucleoprotein A0 |
| FLJ12949 | Hs.693832; | IPI00186139 | FLJ12949 CDNA FLJ36560 fis, clone TRACH2009340 |
| NIPSNAP1 | Hs.173878; | IPI00304435 | NIPSNAP1 Protein NipSnap1 |
| MT-CO1 | IPI00464968 | IPI00464968 | MT-CO1 Cytochrome c oxidase polypeptide 1 |
| SET | Hs.436687; | IPI00072377 | SET Isoform 1 of Protein SET |
| SFRS7 | Hs.309090; | IPI00332419 | SFRS7 Isoform 3 of Splicing factor, arginine/serine-rich 7 |
| IPI00023972 | IPI00023972 | IPI00023972 | APOLD1, DDX47 Probable ATP-dependent RNA helicase DDX47 |
| UFM1 | Hs.694848; | IPI00010207 | UFM1 Ubiquitin-fold modifier 1 precursor |
| | Hs.643655; | | |
| HMGA1 | Hs.679425; | IPI00179700 | HMGA1 Isoform HMG-I of High mobility group protein HMG-I/HMG-Y |
| | Hs.518805; | | |
| RPS24 | Hs.356794; | IPI00219486 | RPS24 40S ribosomal protein S24, Isoform 2 |
| NUP43 | Hs.510375; | IPI00742943 | NUP43 Nucleoporin Nup43 |
| ARS2 | Hs.111801; | IPI00220038 | ARS2 Isoform B of Arsenite-resistance protein 2 |
| CUTC | Hs.16606; | IPI00300408 | CUTC Copper homeostasis protein cutC homolog |
| PSIP1 | Hs.658434; | IPI00028122 | PSIP1 Isoform 1 of PC4 and SFRS1-interacting protein |
| IPI00219038 | IPI00219038 | IPI00219038 | H3F3B, H3F3A Histone H3.3 |
| LOC345630 | IPI00736552 | IPI00736552 | LOC345630 similar to fibrillarin |
| NDUFS8 | Hs.90443; | IPI00010845 | NDUFS8 NADH dehydrogenase [ubiquinone] iron-sulfur protein 8, |
| | | | mitochondrial precursor |
| CD79B | Hs.89575; | IPI00027668 | CD79B Isoform Long of B-cell antigen receptor complex-associated |
| | | | protein beta-chain precursor |
| PTBP2 | Hs.591430; | IPI00514064 | PTBP2 Isoform 1 of Polypyrimidine tract-binding protein 2 |
| MRPL4 | Hs.279652; | IPI00023334 | MRPL4 Isoform 1 of Mitochondrial 39S ribosomal protein L4 |
| PECI | Hs.15250; | IPI00419263 | PECI Peroxisomal 3,2-trans-enoyl-CoA isomerase |
| DDX27 | Hs.65234; | IPI00293078 | DDX27 Probable ATP-dependent RNA helicase DDX27 |
| PTDSS1 | Hs.292579; | IPI00010746 | PTDSS1 Phosphatidylserine synthase 1 |
| RPL28 | Hs.652114; | IPI00182533 | RPL28 60S ribosomal protein L28 |
| CD74 | Hs.694723; | IPI00217775 | CD74 Isoform Short of HLA class II histocompatibility antigen gamma |
| | | | chain |
| DDX19A | Hs.656037; | IPI00019918 | DDX19A ATP-dependent RNA helicase DDX19A |
| WASF2 | IPI00472164 | IPI00472164 | WASF2 Wiskott-Aldrich syndrome protein family member 2 |
| NOLA3 | Hs.14317; | IPI00032853 | NOLA3 H/ACA ribonucleoprotein complex subunit 3 |
| MBD2 | Hs.25674; | IPI00434623 | MBD2 Isoform 1 of Methyl-CpG-binding domain protein 2 |
| HSPC152 | Hs.333579; | IPI00009010 | HSPC152 TRM112-like protein |
| SMU1 | Hs.679417; | IPI00305833 | SMU1 Smu-1 suppressor of mec-8 and unc-52 protein homolog |
| | Hs.655351; | | |
| hCG_2040224 | IPI00412855 | IPI00412855 | hCG_2040224 similar to ribosomal protein L18a |
| SNRPA | Hs.466775; | IPI00012382 | SNRPA U1 small nuclear ribonucleoprotein A |
| TETRAN | Hs.632581; | IPI00103940 | TETRAN Tetracycline transporter-like protein |
| USMG5 | Hs.500921; | IPI00063903 | USMG5 Up-regulated during skeletal muscle growth protein 5 |
| IPI00555878 | IPI00555878 | IPI00555878 | APOBEC3C, APOBEC3D Probable DNA dC->dU-editing enzyme APOBEC- |
| | | | 3C |
| MRPL9 | Hs.694788; | IPI00307409 | MRPL9 39S ribosomal protein L9, mitochondrial precursor |
| HSP90AB2P | Hs.590925; | IPI00455599 | HSP90AB2P Heat shock protein 90Bb |
| VISA | Hs.646283; | IPI00020719 | VISA Isoform 1 of Mitochondrial antiviral-signaling protein |
| PPM2C | Hs.22265; | IPI00794806 | PPM2C 67 kDa protein |
| IPI00216457 | IPI00216457 | IPI00216457 | HIST2H2AA3, HIST2H2AA4 Histone H2A type 2-A |
| GLS | Hs.116448; | IPI00215687 | GLS Isoform GAC of Glutaminase kidney isoform, mitochondrial precursor |
| H2AFX | Hs.477879; | IPI00219037 | H2AFX Histone H2A.x |
| MRPS17 | Hs.44298; | IPI00744772 | MRPS17 28S ribosomal protein S17, mitochondrial precursor |
| IPI00465070 | IPI00465070 | IPI00465070 | HIST1H3I, HIST1H3A, HIST1H3F, HIST1H3C, |
| | | | HIST1H3D, HIST1H3J, HIST1H3H, HIST1H3G, HIST1H3B, |
| | | | HIST1H3E Histone H3.1 |
| IPI00171611 | IPI00171611 | IPI00171611 | HIST2H3A, HIST2H3C Histone H3.2 |
| NDUFB6 | Hs.493668; | IPI00219385 | NDUFB6 NADH dehydrogenase [ubiquinone] 1 beta subcomplex subunit 6 |
| COPS2 | Hs.369614; | IPI00743825 | COPS2 Isoform 1 of COP9 signalosome complex subunit 2 |
| ISG20 | Hs.459265; | IPI00647246 | ISG20 Isoform 1 of Interferon-stimulated gene 20 kDa protein |
| PIGR | Hs.497589; | IPI00004573 | PIGR Polymeric-immunoglobulin receptor precursor |
| MRPL19 | Hs.44024; | IPI00027096 | MRPL19 39S ribosomal protein L19, mitochondrial precursor |
| RANBP3 | Hs.531752; | IPI00026337 | RANBP3 Isoform 1 of Ran-binding protein 3 |
| SPCS1 | Hs.297304; | IPI00794229 | SPCS1 9 kDa protein |
| | Hs.11125; | | |
| KMO | IPI00642771 | IPI00642771 | KMO Isoform 1 of Kynurenine 3-monooxygenase |
| DNTTIP2 | Hs.85769; | IPI00290410 | DNTTIP2 Deoxynucleotidyltransferase terminal-interacting protein 2 |
| CDIPT | Hs.121549; | IPI00647250 | CDIPT 20 kDa protein |
| FCER2 | Hs.465778; | IPI00217263 | FCER2 Isoform B of Low affinity immunoglobulin epsilon Fc receptor |
| LEMD3 | Hs.505905; | IPI00032491 | LEMD3 Inner nuclear membrane protein Man1 |
| YY1 | Hs.388927; | IPI00014513 | YY1 Transcriptional repressor protein YY1 |
| PML | Hs.526464; | IPI00220453 | PML Isoform PML-X of Probable transcription factor PML |
| LSM8 | IPI00219871 | IPI00219871 | LSM8 U6 snRNA-associated Sm-like protein LSm8 |
| UBE2J1 | Hs.163776; | IPI00006937 | UBE2J1 Ubiquitin-conjugating enzyme E2 J1 |
| WDR12 | Hs.73291; | IPI00304232 | WDR12 WD repeat protein 12 |
| SDCCAG10 | Hs.371372; | IPI00744546 | SDCCAG10 Hypothetical protein |
| CDC42SE2 | Hs.508829; | IPI00024973 | CDC42SE2 CDC42 small effector 2 |
| C5orf24 | Hs.406549; | IPI00396126 | C5orf24 Uncharacterized protein C5orf24 |
| SSR3 | Hs.518346; | IPI00009235 | SSR3 Translocon-associated protein subunit gamma |
| LBH | Hs.567598; | IPI00333338 | LBH Hypothetical protein LBH |
| | Hs.593113; | | |
| NGDN | Hs.9043; | IPI00000162 | NGDN Isoform 1 of Neuroguidin |
| YTHDC1 | Hs.175955; | IPI00412832 | YTHDC1 77 kDa protein |
| C14orf2 | Hs.109052; | IPI00749237 | C14orf2 6.8 kDa mitochondrial proteolipid |
| NCOA5 | Hs.654991; | IPI00288941 | NCOA5 Nuclear receptor coactivator 5 |
| ZNF384 | Hs.103315; | IPI00736968 | ZNF384 nuclear matrix transcription factor 4 isoform b |
| GTPBP1 | Hs.276925; | IPI00010463 | GTPBP1 GTP-binding protein 1 |
| CD19 | Hs.652262; | IPI00442499 | CD19 CDNA FLJ27147 fis, clone SPL09574, highly similar to B-lymphocyte |
| | | | antigen CD19 |
| KIAA1704 | Hs.507922; | IPI00477669 | KIAA1704 Isoform 2 of Uncharacterized protein KIAA1704 |
| SAP30L | Hs.483906; | IPI00002831 | SAP30L SAP30-like protein |
| RPS4Y1 | Hs.282376; | IPI00302740 | RPS4Y1 40S ribosomal protein S4, Y isoform 1 |
| RPS4Y2 | Hs.367761; | IPI00219894 | RPS4Y2 40S ribosomal protein S4, Y isoform 2 |
| MBD1 | Hs.405610; | IPI00438701 | MBD1 Isoform 1 of Methyl-CpG-binding domain protein 1 |
| MRPS31 | Hs.154655; | IPI00294242 | MRPS31 28S ribosomal protein S31, mitochondrial precursor |
| PYCRL | Hs.165186; | IPI00646105 | PYCRL Pyrroline-5-carboxylate reductase |
| DGUOK | Hs.469022; | IPI00221319 | DGUOK Isoform 4 of Deoxyguanosine kinase, mitochondrial precursor |
| SETD1A | Hs.297483; | IPI00783972 | SETD1A Histone-lysine N-methyltransferase, H3 lysine-4 specific SET1 |
| CREB1 | Hs.584750; | IPI00218334 | CREB1 Isoform CREB-B of cAMP response element-binding protein |
| POLR1E | Hs.591087; | IPI00550638 | POLR1E Isoform 2 of DNA-directed RNA polymerase I subunit RPA49 |
| ZNF800 | Hs.159006; | IPI00396098 | ZNF800 zinc finger protein 800 |
| CETN2 | Hs.82794; | IPI00215928 | CETN2 Centrin-2 |
| TOMM34 | Hs.517066; | IPI00009946 | TOMM34 Mitochondrial import receptor subunit TOM34 |
| hCG_1640785 | IPI00740757 | IPI00740757 | hCG_1640785 similar to 40S ribosomal protein S25 |
| IPI00478694 | IPI00478694 | IPI00478694 | 14 kDa protein |
| LIMD2 | Hs.591166; | IPI00549972 | LIMD2 LIM domain-containing protein 2 |
| MPI | Hs.75694; | IPI00332187 | MPI Isoform 2 of Mannose-6-phosphate isomerase |
| GTF2A1 | Hs.593630; | IPI00004350 | GTF2A1 Isoform 42 kDa of Transcription initiation factor IIA subunit 1 |
| | Hs.592334; | | |
| COL4A3BP | Hs.270437; | IPI00182914 | COL4A3BP Isoform 2 of Goodpasture antigen-binding protein |
| CXXC5 | Hs.189119; | IPI00152156 | CXXC5 Putative MAPK activating protein |
| MRPL37 | Hs.584908; | IPI00335130 | MRPL37 Mitochondrial ribosomal protein L37 |
| LOC642019 | IPI00738039 | IPI00738039 | LOC651388, LOC642019 similar to nucleolar protein 5A |
| PIAS2 | Hs.658013; | IPI00477352 | PIAS2 Isoform 3 of E3 SUMO-protein ligase PIAS2 |
| CAPG | Hs.516155; | IPI00848090 | CAPG gelsolin-like capping protein |
| CD22 | Hs.652118; | IPI00295133 | CD22 Isoform CD22-beta of B-cell receptor CD22 precursor |
| FLJ11184 | Hs.267446; | IPI00019962 | FLJ11184 Hypothetical protein FLJ11184 |
| UTP15 | Hs.406703; | IPI00152708 | UTP15 U3 small nucleolar RNA-associated protein 15 homolog |
| TNFRSF13C | Hs.344088; | IPI00218927 | TNFRSF13C Isoform 2 of Tumor necrosis factor receptor superfamily |
| | | | member 13C |
| DBT | Hs.633217; | IPI00003944 | DBT Lipoamide acyltransferase component of branched-chain alpha- |
| | | | keto acid dehydrogenase complex, mitochondrial precursor |
| ISCA2 | Hs.291079; | IPI00783970 | ISCA2 16 kDa protein |
| RBM42 | Hs.5086; | IPI00550442 | RBM42 MGC10433 protein |
| RASSF2 | Hs.631504; | IPI00217958 | RASSF2 Ras association (RalGDS/AF-6) domain family 2 protein isoform 2B |
| RALGPS2 | Hs.644008; | IPI00334126 | RALGPS2 Ral GEF with PH domain and SH3-binding motif 2 |
| EXOSC3 | Hs.591076; | IPI00434985 | EXOSC3 exosome component 3 isoform 2 |
| C19orf29 | Hs.128425; | IPI00736681 | C19orf29 chromosome 19 open reading frame 29 |
| | Hs.665775; | | |
| TMEM106B | Hs.396358; | IPI00395903 | TMEM106B Transmembrane protein 106B |
| DDB2 | Hs.655280; | IPI00021518 | DDB2 Isoform 1 of DNA damage-binding protein 2 |
| hCG_1644323 | IPI00376817 | IPI00376817 | hCG_1644323 similar to 60S ribosomal protein L32 |
| MEN1 | Hs.423348; | IPI00182106 | MEN1 Isoform 2 of Menin |
| FCGR2B | Hs.654395; | IPI00013969 | FCGR2B Isoform IIB1 of Low affinity immunoglobulin gamma Fc region |
| | | | receptor II-b precursor |
| IPI00828062 | IPI00828062 | IPI00828062 | Anti-(ED-B) scFV (Fragment) |
| RPUSD2 | Hs.173311; | IPI00150963 | RPUSD2 RNA pseudouridylate synthase domain containing 2 |
| YAF2 | Hs.649195; | IPI00795130 | YAF2 YY1-associated factor 2 |
| MRPL55 | Hs.63236; | IPI00472663 | MRPL55 mitochondrial ribosomal protein L55 isoform b |
| ATF7 | Hs.12286; | IPI00218344 | ATF7 Isoform 2 of Cyclic AMP-dependent transcription factor ATF-7 |
| MT-CO3 | IPI00017533 | IPI00017533 | MT-CO3 Cytochrome c oxidase subunit 3 |
| STIM2 | Hs.135763; | IPI00658128 | STIM2 Similar to Stromal interaction molecule 2 |
| RUNX2 | Hs.535845; | IPI00604427 | RUNX2 Isoform 2 of Runt-related transcription factor 2 |
| CDK9 | Hs.557646; | IPI00301923 | CDK9 Isoform 1 of Cell division protein kinase 9 |
| RBPJ | Hs.479396; | IPI00218578 | RBPJ Isoform APCR-3 of Recombining binding protein suppressor of |
| | | | hairless |
| PDE4DIP | Hs.657490; | IPI00642902 | PDE4DIP Phosphodiesterase 4D-interacting protein |
| | Hs.584841; | | |
| | Hs.654651; | | |
| | Hs.613082; | | |
| CLINT1 | Hs.644000; | IPI00397519 | CLINT1 Isoform 2 of Clathrin interactor 1 |
| PAPD1 | Hs.173946; | IPI00641482 | PAPD1 Novel protein |
| IPI00385252 | IPI00385252 | IPI00385252 | Ig kappa chain V-III region GOL |
| INPP5F | Hs.369755; | IPI00007250 | INPP5F Inositol polyphosphate-5-phosphatase F |
| RNASEH2B | Hs.306291; | IPI00245135 | RNASEH2B RNASEH2B protein |
| HLA-DQB1 | Hs.534322; | IPI00788813 | HLA-DQB1 HLA DR-beta-I (Fragment) |
| | Hs.653339; | | |
| | Hs.409934; | | |
| THEM2 | Hs.9676; | IPI00020530 | THEM2 Thioesterase superfamily member 2 |
| RFC2 | Hs.647062; | IPI00017412 | RFC2 Isoform 1 of Replication factor C subunit 2 |
| SIRT5 | Hs.567431; | IPI00010331 | SIRT5 Isoform 2 of NAD-dependent deacetylase sirtuin-5 |
| ZHX2 | Hs.377090; | IPI00007256 | ZHX2 Zinc fingers and homeoboxes protein 2 |
| | Hs.658443; | | |
| HEATR5B | Hs.591564; | IPI00479069 | HEATR5B HEAT repeat containing 5B |
| KRT14 | Hs.654380; | IPI00384444 | KRT14 Keratin, type I cytoskeletal 14 |
| ZMYM2 | Hs.644041; | IPI00294603 | ZMYM2 MYM-type zinc finger protein 2 |
| UTP14A | Hs.458598; | IPI00107113 | UTP14A Isoform 1 of U3 small nucleolar RNA-associated protein 14 |
| | | | homolog A |
| COQ6 | Hs.632335; | IPI00032633 | COQ6 Ubiquinone biosynthesis monooxygenase COQ6 |
| C1orf80 | Hs.156625; | IPI00303602 | C1orf80 hypothetical protein LOC64853 |
| | Hs.676507; | | |
| | Hs.534965; | | |
| GSTZ1 | Hs.655292; | IPI00013809 | GSTZ1 Maleylacetoacetate isomerase |
| PPP5C | Hs.654604; | IPI00019812 | PPP5C Serine/threonine-protein phosphatase 5 |
| SFRS12 | Hs.519347; | IPI00375462 | SFRS12 Isoform 2 of Splicing factor, arginine/serine-rich 12 |
| CSNK2A2 | Hs.82201; | IPI00020602 | CSNK2A2 Casein kinase II subunit alpha' |
| MOBKL2A | IPI00163727 | IPI00163727 | MOBKL2A Mps one binder kinase activator-like 2A |
| ENDOGL1 | Hs.517897; | IPI00021106 | ENDOGL1 Endonuclease G-like 1 |
| GIT2 | Hs.434996; | IPI00749446 | GIT2 81 kDa protein |
| C2orf49 | Hs.549577; | IPI00031698 | C2orf49 Ashwin |
| PHF14 | Hs.655688; | IPI00454969 | PHF14 PHD finger protein 14 |
| SP140 | Hs.632549; | IPI00012793 | SP140 Isoform LYSp100-B of Nuclear body protein SP140 |
| BLOC1S3 | Hs.695194; | IPI00397721 | BLOC1S3 Biogenesis of lysosome-related organelles complex-1 subunit 3 |
| | Hs.690005; | | |
| ZBTB4 | Hs.694779; | IPI00001835 | ZBTB4 Zinc finger and BTB domain-containing protein 4 |
| SENP7 | Hs.529551; | IPI00218776 | SENP7 Isoform 2 of Sentrin-specific protease 7 |
| IPI00643418 | IPI00643418 | IPI00643418 | 68 kDa protein |
| ZNF346 | Hs.484259; | IPI00442165 | ZNF346 Isoform 2 of Zinc finger protein 346 |
| NOSIP | Hs.7236; | IPI00006408 | NOSIP Nitric oxide synthase-interacting protein |
| NIF3L1 | Hs.145284; | IPI00604624 | NIF3L1 Hypothetical protein NIF3L1 |
| YEATS4 | Hs.4029; | IPI00008536 | YEATS4 YEATS domain-containing protein 4 |
| TP53I11 | Hs.554791; | IPI00478302 | TP53I11 p53-induced protein |
| CIRBP | Hs.634522; | IPI00641579 | CIRBP 32 kDa protein |
| POLR2G | Hs.14839; | IPI00218895 | POLR2G DNA-directed RNA polymerase II subunit RPB7 |
| CD81 | Hs.54457; | IPI00000190 | CD81 CD81 antigen |
| ST14 | Hs.504315; | IPI00001922 | ST14 Suppressor of tumorigenicity protein 14 |
| TMPO | Hs.11355; | IPI00181409 | TMPO Isoform Gamma of Lamina-associated polypeptide 2, isoforms |
| | | | beta/gamma |
| RSBN1 | Hs.486285; | IPI00019999 | RSBN1 round spermatid basic protein 1 |
| CXorf26 | Hs.370100; | IPI00107104 | CXorf26 UPF0368 protein Cxorf26 |
| RNMT | Hs.592347; | IPI00747403 | RNMT Isoform 1 of mRNA cap guanine-N7 methyltransferase |
| ARID1B | Hs.603283; | IPI00015404 | ARID1B Isoform 1 of AT-rich interactive domain-containing protein 1B |
| | Hs.291587; | | |
| PAK1 | Hs.435714; | IPI00656138 | PAK1 Isoform 1 of Serine/threonine-protein kinase PAK 1 |
| RBM26 | Hs.693621; | IPI00827541 | RBM26 Isoform 2 of RNA-binding protein 26 |
| TCEB3 | Hs.621226; | IPI00018404 | TCEB3 Transcription elongation factor B polypeptide 3 |
| | Hs.584806; | | |
| BCDIN3 | Hs.178011; | IPI00021320 | BCDIN3 BIN3 domain-containing protein 1 |
| SEC24B | Hs.292472; | IPI00785208 | SEC24B SEC24 (S. cerevisiae) homolog B isoform b |
| LOC728944 | IPI00788055 | IPI00788055 | LOC728944 similar to THAP domain-containing protein 4 |
| ITPR2 | Hs.512235; | IPI00031545 | ITPR2 Isoform Long of Inositol 1,4,5-trisphosphate receptor type 2 |
| | Hs.659892; | | |
| C8orf38 | Hs.435500; | IPI00852766 | C8orf38 Terpenoid synthase domain containing protein |
| MRPL21 | Hs.503047; | IPI00375677 | MRPL21 39S ribosomal protein L21, mitochondrial precursor |
| PMVK | Hs.30954; | IPI00220648 | PMVK Phosphomevalonate kinase |
| ORC3L | Hs.410228; | IPI00374747 | ORC3L Isoform 2 of Origin recognition complex subunit 3 |
| MGC21874 | Hs.518614; | IPI00761105 | MGC21874 similar to Ada2b CG9638-PA, isoform A isoform 3 |
| APOC3 | Hs.534984; | IPI00657670 | APOC3 13 kDa protein |
| | Hs.73849; | | |
| SGPP1 | Hs.24678; | IPI00306840 | SGPP1 Sphingosine-1-phosphate phosphatase 1 |
| SLC25A46 | Hs.75639; | IPI00478497 | SLC25A46 Solute carrier family 25 member 46 |
| CXXC1 | Hs.180933; | IPI00292445 | CXXC1 CpG-binding protein |
| GNPAT | Hs.498028; | IPI00005677 | GNPAT Dihydroxyacetone phosphate acyltransferase |
| MTCP1 | Hs.6917; | IPI00446798 | MTCP1 P8 MTCP-1 protein |
| MLL5 | Hs.592262; | IPI00337726 | MLL5 myeloid/lymphoid or mixed-lineage leukemia 5 |
| STAMBPL1 | Hs.16229; | IPI00290975 | STAMBPL1 Isoform 1 of AMSH-like protease |
| SENP1 | Hs.371957; | IPI00005101 | SENP1 Sentrin-specific protease 1 |
| RNUXA | Hs.693680; | IPI00303402 | RNUXA RNA U small nuclear RNA export adapter protein |
| | Hs.555731; | | |
| BRE | Hs.11916; Hs.258314; | IPI00719447 | BRE Isoform 3 of Protein BRE |
| ANKRD13A | Hs.528703; | IPI00217831 | ANKRD13A Ankyrin repeat domain-containing protein 13A |
| RSRC2 | Hs.432996; | IPI00386342 | RSRC2 HSPC314 |
| QSOX2 | Hs.657864; | IPI00783371 | QSOX2 Sulfhydryl oxidase 2 precursor |
| UTP18 | IPI00000733 | IPI00000733 | UTP18 U3 small nucleolar RNA-associated protein 18 homolog |
| FAM36A | IPI00103057 | IPI00103057 | FAM36A Isoform 2 of Protein FAM36A |
| CXorf9 | Hs.61469; | IPI00844580 | CXorf9 42 kDa protein |
| LRCH3 | Hs.659335; | IPI00396561 | LRCH3 Isoform 3 of Leucine-rich repeat and calponin homology domain- |
| | Hs.518414; | | containing protein 3 precursor |
| HSF1 | Hs.530227; | IPI00218507 | HSF1 Isoform Short of Heat shock factor protein 1 |
| | Hs.571397; | | |
| DDX56 | Hs.654762; | IPI00302281 | DDX56 Probable ATP-dependent RNA helicase DDX56 |
| NFU1 | Hs.430439; | IPI00160021 | NFU1 HIRA interacting protein 5 isoform 1 |
| SMPD4 | IPI00743121 | IPI00743121 | SMPD4 neutral sphingomyelinase 3 isoform 1 |
| RAB2B | Hs.22399; | IPI00102896 | RAB2B Ras-related protein Rab-2B |
| RRP1 | Hs.110757; | IPI00550766 | RRP1 RRP1-like protein |
| FARS2 | Hs.484547; | IPI00645207 | FARS2 Phenylalanine-tRNA synthetase 2 |
| IKZF3 | Hs.444388; | IPI00796035 | IKZF3 aiolos isoform 1 |
| GLO1 | Hs.268849; | IPI00220766 | GLO1 Lactoylglutathione lyase |
| TRA2A | Hs.645489; | IPI00013891 | TRA2A Isoform Long of Transformer-2 protein homolog |
| ICAM3 | Hs.654563; | IPI00031620 | ICAM3 Intercellular adhesion molecule 3 precursor |
| RBMX | Hs.661054; | IPI00304692 | RBMX Heterogeneous nuclear ribonucleoprotein G |
| | Hs.380118; | | |
| TMEM70 | Hs.106650; | IPI00106966 | TMEM70 Isoform 1 of Transmembrane protein 70 |
| AGPAT5 | Hs.624002; | IPI00028491 | AGPAT5 1-acyl-sn-glycerol-3-phosphate acyltransferase epsilon |
| MECP2 | Hs.200716; | IPI00645192 | MECP2 Isoform B of Methyl-CpG-binding protein 2 |
| RPL18 | Hs.515517; | IPI00215719 | RPL18 60S ribosomal protein L18 |
| SOD1 | Hs.443914; | IPI00783680 | SOD1 Superoxide dismutase |
| DKC1 | Hs.4747; | IPI00221394 | DKC1 H/ACA ribonucleoprotein complex subunit 4 |
| CRYZ | Hs.83114; | IPI00000792 | CRYZ Quinone oxidoreductase |
| LBR | Hs.435166; | IPI00292135 | LBR Lamin-B receptor |
| KRT9 | Hs.654569; | IPI00019359 | KRT9 Keratin, type I cytoskeletal 9 |
| IPI00853068 | IPI00853068 | IPI00853068 | HBA2, HBA1 Alpha 2 globin variant (Fragment) |
| NFKB1 | Hs.654408; | IPI00788987 | NFKB1 Isoform 1 of Nuclear factor NF-kappa-B p105 subunit |
| PABPN1 | Hs.117176; | IPI00414963 | PABPN1 Isoform 2 of Polyadenylate-binding protein 2 |
| ATIC | Hs.90280; | IPI00289499 | ATIC Bifunctional purine biosynthesis protein PURH |
| RPL18A | Hs.337766; | IPI00026202 | RPL18A 60S ribosomal protein L18a |
| PTBP1 | Hs.172550; | IPI00179964 | PTBP1 Isoform 1 of Polypyrimidine tract-binding protein 1 |
| H1FX | Hs.75307; | IPI00021924 | H1FX Histone H1x |
| KRT1 | Hs.80828; | IPI00220327 | KRT1 Keratin, type II cytoskeletal 1 |
| TFAM | Hs.642966; | IPI00020928 | TFAM Transcription factor A, mitochondrial precursor |
| HIBADH | Hs.406758; | IPI00013860 | HIBADH 3-hydroxyisobutyrate dehydrogenase, mitochondrial precursor |
| ILF3 | Hs.465885; | IPI00418313 | ILF3 Isoform 4 of Interleukin enhancer-binding factor 3 |
| SF1 | Hs.502829; | IPI00386120 | SF1 Isoform 6 of Splicing factor 1 |
| SF3B3 | Hs.514435; | IPI00300371 | SF3B3 Isoform 1 of Splicing factor 3B subunit 3 |
| LSM4 | Hs.515255; | IPI00294955 | LSM4 U6 snRNA-associated Sm-like protein LSm4 |
| NAT10 | Hs.577281; | IPI00300127 | NAT10 N-acetyltransferase 10 |
| SAE1 | Hs.515500; | IPI00033130 | SAE1 SUMO-activating enzyme subunit 1 |
| DDX23 | Hs.130098; | IPI00006725 | DDX23 Probable ATP-dependent RNA helicase DDX23 |
| UBB | Hs.673132; | IPI00179330 | RPS27A, UBC, UBB ubiquitin and ribosomal protein S27a precursor |
| | Hs.356190; | | |
| PRKDC | Hs.491682; | IPI00296337 | PRKDC Isoform 1 of DNA-dependent protein kinase catalytic subunit |
| HSD17B10 | Hs.171280; | IPI00017726 | HSD17810 Isoform 1 of 3-hydroxyacyl-CoA dehydrogenase type-2 |
| Sep9 | Hs.440932; | IPI00784614 | SEPT9 Isoform 1 of Septin-9 |
| | Hs.672188; | | |
| RPS4X | Hs.446628; | IPI00217030 | RPS4X 40S ribosomal protein S4, X isoform |
| AFG3L2 | Hs.528996; | IPI00001091 | AFG3L2 AFG3-like protein 2 |
| RPL8 | Hs.178551; | IPI00012772 | RPL8 60S ribosomal protein L8 |
| HSPD1 | Hs.595053; | IPI00784154 | HSPD1 60 kDa heat shock protein, mitochondrial precursor |
| | Hs.632539; | | |
| CROCC | Hs.309403; | IPI00843774 | CROCC CROCC protein |
| NUMA1 | Hs.325978; | IPI00006196 | NUMA1 Isoform 2 of Nuclear mitotic apparatus protein 1 |
| TUFM | Hs.12084; | IPI00027107 | TUFM Tu translation elongation factor, mitochondrial |
| LOC197322 | Hs.461727; | IPI00166395 | LOC197322 LOC197322 protein |
| LSM2 | Hs.103106; | IPI00032460 | LSM2 U6 snRNA-associated Sm-like protein LSm2 |
| MGC29506 | Hs.409563; | IPI00102821 | MGC29506 hypothetical protein LOC51237 |
| C19orf53 | Hs.231616; | IPI00022317 | C19orf53 Leydig cell tumor 10 kDa protein homolog |
| NDUFA13 | Hs.534453; | IPI00219685 | NDUFA13 cell death-regulatory protein GRIM19 |
| BCAS2 | Hs.22960; | IPI00025178 | BCAS2 Breast carcinoma amplified sequence 2 |
| RPL31 | Hs.469473; | IPI00848331 | RPL31 ribosomal protein L31 isoform 2 |
| LOC643790 | Hs.447529; | IPI00456588 | LOC643790 similar to Nonhistone chromosomal protein HMG-14 |
| HNRPDL | Hs.527105; | IPI00011274 | HNRPDL Isoform 1 of Heterogeneous nuclear ribonucleoprotein D-like |
| EIF3S5 | Hs.516023; | IPI00654777 | EIF3S5 Eukaryotic translation initiation factor 3 subunit 5 |
| NOL1 | Hs.534334; | IPI00654555 | NOL1 Isoform 1 of Putative RNA methyltransferase NOL1 |
| CDKN1B | Hs.238990; | IPI00006991 | CDKN1B Cyclin-dependent kinase inhibitor 1B |
| SFRS9 | Hs.369624; | IPI00012340 | SFRS9 Splicing factor, arginine/serine-rich 9 |
| | Hs.652394; | | |
| LEF1 | Hs.555947; | IPI00007156 | LEF1 Isoform 1 of Lymphoid enhancer-binding factor 1 |
| MKI67IP | Hs.367842; | IPI00154590 | MKI67IP MKI67 FHA domain-interacting nucleolar phosphoprotein |
| IAH1 | Hs.656852; | IPI00432867 | IAH1 IAH1 protein (Fragment) |
| RBM8A | Hs.654719; | IPI00001757 | RBM8A Isoform 1 of RNA-binding protein 8A |
| NUCKS1 | Hs.643846; | IPI00022145 | NUCKS1 Isoform 1 of Nuclear ubiquitous casein and cyclin-dependent |
| | Hs.632458; | | kinases substrate |
| PIN4 | Hs.655623; | IPI00006658 | PIN4 protein (peptidyl-prolyl cis/trans isomerase) NIMA-interacting, 4 |
| HIST1H1A | Hs.150206; | IPI00217469 | HIST1HIA Histone H1.1 |
| RNASE3 | Hs.73839; | IPI00025427 | RNASE3 Eosinophil cationic protein precursor |
| C20orf116 | Hs.471975; | IPI00375407 | C20orf116 Isoform 2 of Uncharacterized protein C20orf116 precursor |
| IKZF1 | Hs.488251; | IPI00216389 | IKZF1 Isoform Ik4 of DNA-binding protein Ikaros |
| | Hs.435949; | | |
| TRNT1 | Hs.567495; | IPI00301719 | TRNT1 Isoform 2 of tRNA-nucleotidyltransferase 1, mitochondrial precursor |
| PTPRCAP | Hs.155975; | IPI00023786 | PTPRCAP Protein tyrosine phosphatase receptor type C-associated |
| | | | protein |
| HMGN4 | Hs.236774; | IPI00220484 | HMGN4 High mobility group nucleosome-binding domain-containing |
| | | | protein 4 |
| RBM3 | Hs.301404; | IPI00604407 | RBM3 RNA binding motif protein 3 isoform b |
| FLJ20920 | Hs.288959; | IPI00304071 | FLJ20920 Hypothetical protein FLJ20920 |
| C14orf43 | Hs.656506; | IPI00784739 | C14orf43 Uncharacterized protein C14orf43 |
| IGHM | IPI00829729 | IPI00829729 | IGHM IGHM protein |
| HNRPAB | Hs.248746; | IPI00334713 | HNRPAB Isoform 3 of Heterogeneous nuclear ribonucleoprotein A/B |
| | Hs.591731; | | |
| TERF2 | Hs.63335; | IPI00024214 | TERF2 Isoform 1 of Telomeric repeat-binding factor 2 |
| CROP | Hs.130293; | IPI00107745 | CROP Isoform 1 of Cisplatin resistance-associated overexpressed protein |
| SFXN1 | Hs.369440; | IPI00009368 | SFXN1 Sideroflexin-1 |
| C11orf31 | Hs.655373; | IPI00218054 | C11orf31 Selenoprotein H |
| HSDL2 | Hs.59486; | IPI00414384 | HSDL2 Hydroxysteroid dehydrogenase-like protein 2 |
| CAMK2D | Hs.144114; | IPI00172636 | CAMK2D Isoform Delta 6 of Calcium/calmodulin-dependent protein |
| | | | kinase type II delta chain |
| XRCC5 | Hs.388739; | IPI00220834 | XRCC5 ATP-dependent DNA helicase 2 subunit 2 |
| RAN | Hs.10842; | IPI00643041 | RAN GTP-binding nuclear protein Ran |
| NUDT21 | Hs.528834; | IPI00646917 | NUDT21 Cleavage and polyadenylation specificity factor 5 |
| DDX18 | Hs.363492; | IPI00301323 | DDX18 ATP-dependent RNA helicase DDX18 |
| SWAP70 | Hs.153026; | IPI00307200 | SWAP70 Switch-associated protein 70 |
| ALOX5 | Hs.89499; | IPI00218916 | ALOX5 Arachidonate 5-lipoxygenase |
| RPL23 | Hs.406300; | IPI00795408 | RPL23 15 kDa protein |
| C1QBP | Hs.555866; | IPI00014230 | C1QBP Complement component 1 Q subcomponent-binding protein, |
| | | | mitochondrial precursor |
| UBTF | Hs.89781; | IPI00384556 | UBTF Ribosomal RNA upstream binding transcription factor (Fragment) |
| DDX5 | Hs.279806; | IPI00017617 | DDX5 Probable ATP-dependent RNA helicase DDX5 |
| SPTAN1 | Hs.372331; | IPI00844215 | SPTAN1 Isoform 1 of Spectrin alpha chain, brain |
| IVD | Hs.513646; | IPI00789848 | IVD Isovaleryl-CoA dehydrogenase, mitochondrial precursor |
| | Hs.449599; | | |
| OGDH | Hs.488181; | IPI00098902 | OGDH oxoglutarate (alpha-ketoglutarate) dehydrogenase (lipoamide) |
| | | | isoform 1 precursor |
| CPSF6 | Hs.369606; | IPI00647126 | CPSF6 Isoform 3 of Cleavage and polyadenylation specificity factor 6 |
| PRPF4 | Hs.374973; | IPI00150269 | PRPF4 Isoform 1 of U4/U6 small nuclear ribonucleoprotein Prp4 |
| PDCD4 | Hs.232543; | IPI00240675 | PDCD4 programmed cell death 4 isoform 2 |
| TRIM28 | Hs.467408; | IPI00438229 | TRIM28 Isoform 1 of Transcription intermediary factor 1-beta |
| SNRPD1 | Hs.464734; | IPI00302850 | SNRPD1 Small nuclear ribonucleoprotein Sm D1 |
| SUCLG2 | Hs.655250; | IPI00096066 | SUCLG2 Succinyl-CoA ligase [GDP-forming] beta-chain, mitochondrial |
| | | | precursor |
| PSPC1 | Hs.213198; | IPI00103525 | PSPC1 paraspeckle protein 1 |
| RAP2C | Hs.119889; | IPI00009607 | RAP2C Ras-related protein Rap-2c precursor |
| LANCL2 | Hs.655117; | IPI00032995 | LANCL2 LanC-like protein 2 |
| WDR7 | Hs.465213; | IPI00289815 | WDR7 Isoform 2 of WD repeat protein 7 |
| NOC2L | Hs.405987; | IPI00411886 | NOC2L Nucleolar complex protein 2 homolog |
| FLJ12529 | Hs.444552; | IPI00719106 | FLJ12529 Isoform 2 of Cleavage and polyadenylation specificity factor 7 |
| PPWD1 | Hs.121432; | IPI00149650 | PPWD1 Peptidylprolyl isomerase domain and WD repeat-containing |
| | | | protein 1 |
| MAGOH | Hs.421576; | IPI00219306 | MAGOH Protein mago nashi homolog |
| RBM13 | Hs.583805; | IPI00332428 | RBM13 MAK16-like protein RBM13 |
| ELF1 | Hs.135646; | IPI00167002 | ELF1 ETS-related transcription factor Elf-1 |
| ALDH18A1 | Hs.500645; | IPI00008982 | ALDH18A1 Isoform Long of Delta 1-pyrroline-5-carboxylate synthetase |
| WDR91 | Hs.459858; | IPI00782984 | WDR91 HSPC049 protein |
| SNRPG | Hs.654528; | IPI00016572 | SNRPG Small nuclear ribonucleoprotein G |
| | Hs.631639; | | |
| | Hs.465167; | | |
| | Hs.516076; | | |
| HTATSF1 | Hs.204475; | IPI00013788 | HTATSF1 HIV Tat-specific factor 1 |
| GYG1 | Hs.477892; | IPI00794444 | GYG1 Isoform GN-1S of Glycogenin-1 |
| PCBP2 | Hs.546271; | IPI00216689 | PCBP2 Poly(rC)-binding protein 2 |
| CEPT1 | Hs.636850; | IPI00005775 | CEPT1 Choline/ethanolaminephosphotransferase 1 |
| | Hs.363572; | | |
| EP400 | Hs.654919; | IPI00783050 | EP400 E1A-binding protein p400 |
| SF3B5 | Hs.110695; | IPI00010404 | SF3B5 Splicing factor 3B subunit 5 |
| SFRS4 | Hs.469970; | IPI00000015 | SFRS4 Splicing factor, arginine/serine-rich 4 |
| BRDG1 | Hs.435579; | IPI00015876 | BRDG1 Signal-transducing adaptor protein 1 |
| MRPS21 | Hs.405880; | IPI00014812 | MRPS21 Mitochondrial 28S ribosomal protein S21 |
| MAP4K1 | Hs.95424; | IPI00020258 | MAP4K1 Mitogen-activated protein kinase kinase kinase kinase 1 |
| CRKRS | Hs.416108; | IPI00021175 | CRKRS Cell division cycle 2-related protein kinase 7 |
| EBP | IPI00008599 | IPI00008599 | EBP 3-beta-hydroxysteroid-Delta |
| AYTL2 | Hs.368853; | IPI00171626 | AYTL2 1-acylglycerophosphocholine O-acyltransferase 1 |
| SP100 | Hs.369056; | IPI00218326 | SP100 Isoform Sp100-C of Nuclear autoantigen Sp-100 |
| MRPL23 | Hs.3254; | IPI00293476 | MRPL23 Mitochondrial 39S ribosomal protein L23 |
| RBM15 | Hs.657503; | IPI00220716 | RBM15 Isoform 2 of Putative RNA-binding protein 15 |
| | Hs.435947; | | |
| PHF1 | Hs.166204; | IPI00064665 | PHF1 Isoform 1 of PHD finger protein 1 |
| BCKDHB | Hs.654441; | IPI00011276 | BCKDHB 2-oxoisovalerate dehydrogenase subunit beta, mitochondrial |
| | | | precursor |
| INTS1 | Hs.532188; | IPI00737363 | INTS1 similar to CG3173-PA isoform 7 |
| LOC729611 | Hs.558610; | IPI00052885 | LOC729611 similar to 60S ribosomal protein L29 |
| CCDC56 | Hs.16059; | IPI00022277 | CCDC56 Coiled-coil domain-containing protein 56 |
| MRPL15 | Hs.18349; | IPI00023086 | MRPL15 39S ribosomal protein L15, mitochondrial precursor |
| MT-ND4 | IPI00008495 | IPI00008495 | MT-ND4 NADH-ubiquinone oxidoreductase chain 4 |
| NSL1 | Hs.497692; | IPI00306330 | NSL1 Kinetochore-associated protein NSL1 homolog |
| CD5 | Hs.58685; | IPI00025383 | CD5 T-cell surface glycoprotein CD5 precursor |
| NDUFA7 | Hs.333427; | IPI00452731 | NDUFA7 NADH dehydrogenase [ubiquinone] 1 alpha subcomplex |
| | | | subunit 7 |
| USP24 | Hs.477009; | IPI00398505 | USP24 Ubiquitin carboxyl-terminal hydrolase 24 |
| ISCU | Hs.615131; | IPI00164885 | ISCU Isoform 2 of Iron-sulfur cluster assembly enzyme ISCU, mitochondrial |
| | | | precursor |
| C19orf52 | Hs.662044; | IPI00157215 | C19orf52 Uncharacterized protein C19orf52 |
| DDX24 | Hs.510328; | IPI00006987 | DDX24 ATP-dependent RNA helicase DDX24 |
| NSUN5 | Hs.647060; | IPI00783606 | NSUN5 50 kDa protein |
| ARID4A | Hs.161000; | IPI00218648 | ARID4A Isoform III of AT-rich interactive domain-containing protein 4A |
| MT-ND5 | IPI00008511 | IPI00008511 | MT-ND5 NADH-ubiquinone oxidoreductase chain 5 |
| IMP3 | Hs.513043; | IPI00019488 | IMP3 U3 small nucleolar ribonucleoprotein protein IMP3 |
| ZC3H14 | Hs.325846; | IPI00451437 | ZC3H14 nuclear protein UKp68 isoform 2 |
| SUPT4H1 | Hs.439481; | IPI00002895 | SUPT4H1 Transcription elongation factor SPT4 |
| HNRPC | Hs.508848; | IPI00216592 | HNRPC Isoform C1 of Heterogeneous nuclear ribonucleoproteins C1/C2 |
| | Hs.688323; | | |
| | Hs.449114; | | |
| RABEP2 | Hs.555978; | IPI00412499 | RABEP2 Isoform 1 of Rab GTPase-binding effector protein 2 |
| POLR2H | Hs.432574; | IPI00003309 | POLR2H DNA-directed RNA polymerases I, II, and III subunit RPABC3 |
| NFYB | Hs.84928; | IPI00013217 | NFYB Nuclear transcription factor Y subunit beta |
| CAPG | Hs.516155; | IPI00027341 | CAPG Macrophage-capping protein |
| MPG | Hs.459596; | IPI00295497 | MPG Isoform 1 of DNA-3-methyladenine glycosylase |
| RPS16 | Hs.397609; | IPI00221092 | RPS16 40S ribosomal protein S16 |
| C21orf33 | Hs.413482; | IPI00024913 | C21orf33 Isoform Long of ES1 protein homolog, mitochondrial precursor |
| EFTUD2 | Hs.151787; | IPI00003519 | EFTUD2 116 kDa U5 small nuclear ribonucleoprotein component |
| RALY | Hs.136947; | IPI00847752 | RALY Isoform 2 of RNA-binding protein Raly |
| SFPQ | Hs.355934; | IPI00010740 | SFPQ Isoform Long of Splicing factor, proline- and glutamine-rich |
| HNRPL | Hs.654559; | IPI00027834 | HNRPL heterogeneous nuclear ribonucleoprotein L isoform a |
| RPL37A | Hs.433701; | IPI00414860 | RPL37A 60S ribosomal protein L37a |
| ATP5J | Hs.246310; | IPI00456008 | ATP5J ATP synthase, H+ transporting, mitochondrial F0 complex, subunit |
| | | | F6 isoform b precursor |
| SLC25A19 | Hs.514470; | IPI00433339 | SLC25A19 Solute carrier family 25 member 19 |
| FDPS | Hs.335918; | IPI00101405 | FDPS Farnesyl diphosphate synthase |
| BCLAF1 | Hs.486542; | IPI00006079 | BCLAF1 Isoform 1 of Bcl-2-associated transcription factor 1 |
| HVCN1 | Hs.334637; | IPI00748233 | HVCN1 31 kDa protein |
| hCG_1781062 | Hs.632087; | IPI00642816 | SRP9, hCG_1781062 Signal recognition particle 9 kDa protein |
| RBM39 | Hs.282901; | IPI00215801 | RBM39 Isoform 2 of RNA-binding protein 39 |
| CTCF | Hs.368367; | IPI00027988 | CTCF Transcriptional repressor CTCF |
| PGRMC2 | Hs.507910; | IPI00005202 | PGRMC2 Membrane-associated progesterone receptor component 2 |
| PRKCB1 | Hs.460355; | IPI00219628 | PRKCB1 Isoform Beta-II of Protein kinase C beta type |
| PRPF19 | Hs.502705; | IPI00004968 | PRPF19 Pre-mRNA-processing factor 19 |
| TCEA1 | Hs.491745; | IPI00333215 | TCEA1 Isoform 1 of Transcription elongation factor A protein 1 |
| RCC1 | Hs.469723; | IPI00787306 | RCC1 regulator of chromosome condensation 1 isoform b |
| ACADM | Hs.445040; | IPI00005040 | ACADM Medium-chain specific acyl-CoA dehydrogenase, |
| | | | mitochondrial precursor |
| ECHS1 | Hs.76394; | IPI00024993 | ECHS1 Enoyl-CoA hydratase, mitochondrial precursor |
| WDR36 | Hs.533237; | IPI00169325 | WDR36 WD repeat protein 36 |
| SNRPB | Hs.83753; | IPI00844420 | SNRPB SNRPB protein |
| PDHA1 | Hs.530331; | IPI00306301 | PDHA1 Mitochondrial PDHA1 |
| NUP155 | Hs.547696; | IPI00026625 | NUP155 Isoform 1 of Nuclear pore complex protein Nup155 |
| RANBP2 | Hs.199561; | IPI00221325 | RANBP2 E3 SUMO-protein ligase RanBP2 |
| | Hs.590897; | | |
| CPSF1 | Hs.493202; | IPI00026219 | CPSF1 Cleavage and polyadenylation specificity factor subunit 1 |
| DDX17 | Hs.665429; | IPI00023785 | DDX17 DEAD box polypeptide 17 isoform 1 |
| | Hs.528305; | | |
| PDHB | Hs.161357; | IPI00003925 | PDHB Isoform 1 of Pyruvate dehydrogenase E1 component subunit beta, |
| | | | mitochondrial precursor |
| RPL22 | Hs.515329; | IPI00219153 | RPL22 60S ribosomal protein L22 |
| | Hs.554762; | | |
| CIP29 | IPI00798360 | IPI00798360 | CIP29 18 kDa protein |
| SYPL1 | Hs.80919; | IPI00009507 | SYPL1 Isoform 1 of Synaptophysin-like protein 1 |
| PRDX3 | Hs.523302; | IPI00374151 | PRDX3 peroxiredoxin 3 isoform b |
| RAE1 | Hs.371698; | IPI00019733 | RAE1 mRNA export factor |
| POLR2A | Hs.270017; | IPI00783837 | POLR2A DNA-directed RNA polymerase II subunit RPB1 |

Table 4 lists the panel of protein biomarkers that are down-regulated in CLL compared to normal B-cells.

TABLE 4
Proteins that are down-regulated in CLL compared to normal B-cells.

| Gene Symbol | Unigene | Accession | Protein |
|---|---|---|---|
| FGG | Hs.546255; | IPI00219713 | FGG Isoform Gamma-A of Fibrinogen gamma chain precursor |
| FGA | Hs.351593; | IPI00029717 | FGA Isoform 2 of Fibrinogen alpha chain precursor |
| GP1BB | Hs.283743; | IPI00464990 | GP1BB Glycoprotein Ib beta |
| ITGA2B | Hs.411312; | IPI00295976 | ITGA2B Isoform 1 of Integrin alpha-IIb precursor |
| STOM | Hs.253903; | IPI00219682 | STOM Erythrocyte band 7 integral membrane protein |
| MMRN1 | Hs.268107; | IPI00012269 | MMRN1 Multimerin-1 precursor |
| ITGB3 | Hs.218040; | IPI00303283 | ITGB3 Isoform Beta-3A of Integrin beta-3 precursor |
| ACTN1 | Hs.509765; | IPI00759776 | ACTN1 Actinin alpha 1 isoform b |
| FGB | Hs.300774; | IPI00298497 | FGB Fibrinogen beta chain precursor |
| GP9 | Hs.1144; | IPI00027502 | GP9 Platelet glycoprotein IX precursor |
| PF4 | Hs.81564; | IPI00022446 | PF4 Platelet factor 4 precursor |
| LIMS1 | Hs.655316; | IPI00555886 | LIMS1 44 kDa protein |
| | Hs.597715; | | |
| ILK | Hs.655002; | IPI00013219 | ILK Integrin-linked protein kinase |
| F13A1 | Hs.335513; | IPI00297550 | F13A1 Coagulation factor XIII A chain precursor |
| SDPR | Hs.26530; | IPI00005809 | SDPR Serum deprivation-response protein |
| ANPEP | Hs.1239; | IPI00221224 | ANPEP Aminopeptidase N |
| THBS1 | Hs.164226; | IPI00296099 | THBS1 Thrombospondin-1 precursor |
| TBXAS1 | Hs.520757; | IPI00788599 | TBXAS1 thromboxane A synthase 1 (platelet, cytochrome P450, family |
| | | | 5, subfamily A) isoform TXS-I |
| SELP | Hs.73800; | IPI00295339 | SELP P-selectin precursor |
| VWF | Hs.440848; | IPI00788786 | VWF 309 kDa protein |
| LYZ | Hs.524579; | IPI00019038 | LYZ Lysozyme C precursor |
| STX11 | Hs.118958; | IPI00026128 | STX11 Syntaxin-11 |
| IGHG4 | IPI00829814 | IPI00829814 | IGHG4 Ig gamma-4 chain C region |
| VCL | Hs.643896; | IPI00291175 | VCL Isoform 1 of Vinculin |
| FBP1 | Hs.494496; | IPI00073772 | FBP1 Fructose-1,6-bisphosphatase 1 |
| CES1 | Hs.558865; | IPI00607801 | CES1 Isoform 2 of Liver carboxylesterase 1 precursor |
| GLRX | Hs.28988; | IPI00219025 | GLRX Glutaredoxin-1 |
| KALRN | Hs.8004; | IPI00410727 | KALRN Isoform 2 of Serine/threonine-protein kinase Duet |
| TUBB1 | Hs.592143; | IPI00006510 | TUBB1 Tubulin beta-1 chain |
| ANXA1 | Hs.494173; | IPI00218918 | ANXA1 Annexin A1 |
| FHL1 | Hs.435369; | IPI00014398 | FHL1 Four and a half LIM domains 1 variant |
| CTSG | Hs.421724; | IPI00028064 | CTSG Cathepsin G precursor |
| LTF | Hs.529517; | IPI00848342 | LTF Lactotransferrin precursor |
| KCTD12 | Hs.693617; | IPI00060715 | KCTD12 BTB/POZ domain-containing protein KCTD12 |
| ADAM10 | Hs.578508; | IPI00794448 | ADAM10 63 kDa protein |
| TLN1 | Hs.471014; | IPI00784273 | TLN1 Talin-1 |
| URP2 | Hs.180535; | IPI00216699 | URP2 Isoform 2 of Unc-112-related protein 2 |
| PYGL | Hs.282417; | IPI00470525 | PYGL Glycogen phosphorylase, liver form |
| MPO | Hs.458272; | IPI00007244 | MPO Isoform H17 of Myeloperoxidase precursor |
| TPM4 | Hs.631618; | IPI00010779 | TPM4 Isoform 1 of Tropomyosin alpha-4 chain |
| EMILIN1 | Hs.63348; | IPI00013079 | EMILIN1 EMILIN-1 precursor |
| FLNA | Hs.195464; | IPI00302592 | FLNA filamin A, alpha |
| ALDH2 | Hs.632733; | IPI00006663 | ALDH2 Aldehyde dehydrogenase, mitochondrial precursor |
| ELA2 | Hs.99863; | IPI00027769 | ELA2 Leukocyte elastase precursor |
| APOB48R | Hs.200333; | IPI00399183 | APOB48R apolipoprotein B48 receptor |
| ITGB2 | Hs.375957; | IPI00291792 | ITGB2 Integrin beta-2 precursor |
| BPI | Hs.529019; | IPI00827847 | BPI Bactericidal permeability-increasing protein precursor |
| LCN2 | Hs.204238; | IPI00299547 | LCN2 Neutrophil gelatinase-associated lipocalin precursor |
| ITGAM | Hs.172631; | IPI00645887 | ITGAM Integrin, alpha M |
| GSN | Hs.522373; | IPI00026314 | GSN Isoform 1 of Gelsolin precursor |
| NUCB2 | Hs.654599; | IPI00746961 | NUCB2 Nucb2 splice variant |
| CTSA | Hs.652282; | IPI00021794 | CTSA Lysosomal protective protein precursor |
| SERPINB10 | Hs.158339; | IPI00010304 | SERPINB10 Serpin B10 |
| IQGAP2 | Hs.291030; | IPI00299048 | IQGAP2 Isoform 1 of Ras GTPase-activating-like protein IQGAP2 |
| CYBB | Hs.292356; | IPI00218646 | CYBB Cytochrome b-245 heavy chain |
| MMP9 | Hs.297413; | IPI00027509 | MMP9 Matrix metalloproteinase-9 precursor |
| LTBP1 | Hs.654497; | IPI00784258 | LTBP1 latent transforming growth factor beta binding protein 1 isoform |
| | | | LTBP-1L |
| F5 | Hs.30054; | IPI00022937 | F5 Coagulation factor V |
| S100A4 | Hs.654444; | IPI00032313 | S100A4 Protein S100-A4 |
| FLJ22662 | Hs.131933; | IPI00016255 | FLJ22662 hypothetical protein LOC79887 |
| LGALS1 | Hs.445351; | IPI00219219 | LGALS1 Galectin-1 |
| RTN4 | Hs.645283; | IPI00021766 | RTN4 Isoform 1 of Reticulon-4 |
| GCA | Hs.377894; | IPI00004524 | GCA Grancalcin |
| PECAM1 | Hs.514412; | IPI00470719 | PECAM1 Isoform Delta12 of Platelet endothelial cell adhesion |
| | | | molecule precursor |
| ITGB1 | Hs.643813; | IPI00645194 | ITGB1 integrin beta 1 isoform 1A precursor |
| HK3 | Hs.411695; | IPI00005118 | HK3 Hexokinase-3 |
| GIMAP4 | Hs.647101; | IPI00019563 | GIMAP4 GTPase IMAP family member 4 |
| CSRP1 | Hs.108080; | IPI00442073 | CSRP1 Cysteine and glycine-rich protein 1 |
| MNDA | Hs.153837; | IPI00013163 | MNDA Myeloid cell nuclear differentiation antigen |
| CTSD | Hs.654447; | IPI00011229 | CTSD Cathepsin D precursor |
| | Hs.121575; | | |
| BIN2 | Hs.14770; | IPI00550792 | BIN2 Isoform 1 of Briding integrator 2 |
| ECGF1 | Hs.592212; | IPI00853163 | ECGF1 46 kDa protein |
| SAMHD1 | Hs.580681; | IPI00294739 | SAMHD1 SAM domain and HD domain-containing protein 1 |
| RAP1B | Hs.369920; | IPI00015148 | RAP1B Ras-related protein Rap-1b precursor |
| MYH9 | Hs.474751; | IPI00019502 | MYH9 Myosin-9 |
| MYL6 | Hs.632717; | IPI00789605 | MYL6 Isoform Smooth muscle of Myosin light polypeptide 6 |
| PLEK | Hs.468840; | IPI00306311 | PLEK Pleckstrin |
| PGD | Hs.464071; | IPI00219525 | PGD 6-phosphogluconate dehydrogenase, decarboxylating |
| DIAPH1 | Hs.529451; | IPI00030876 | DIAPH1 Diaphanous 1 |
| VASP | Hs.515469; | IPI00301058 | VASP Vasodilator-stimulated phosphoprotein |
| ITGB2 | Hs.375957; | IPI00746851 | ITGB2 Integrin beta chain, beta 2 variant (Fragment) |
| TKT | Hs.89643; | IPI00643920 | TKT Transketolase |
| NAGA | Hs.75372; | IPI00414909 | NAGA Alpha-N-acetylgalactosaminidase precursor |
| PYGB | Hs.368157; | IPI00004358 | PYGB Glycogen phosphorylase, brain form |
| EFHD2 | Hs.465374; | IPI00060181 | EFHD2 EF-hand domain-containing protein 2 |
| CAPN2 | Hs.350899; | IPI00289758 | CAPN2 Calpain-2 catalytic subunit precursor |
| IPI00377005 | IPI00377005 | IPI00377005 | RcTPM3 (Fragment) |
| MYH14 | Hs.467142; | IPI00337335 | MYH14 myosin, heavy chain 14 isoform 1 |
| GNS | Hs.334534; | IPI00012102 | GNS N-acetylglucosamine-6-sulfatase precursor |
| P4HB | Hs.464336; | IPI00010796 | P4HB Protein disulfide-isomerase precursor |
| ARHGAP1 | Hs.138860; | IPI00020567 | ARHGAP1 Rho GTPase-activating protein 1 |
| YARS | Hs.213264; | IPI00007074 | YARS Tyrosyl-tRNA synthetase, cytoplasmic |
| LRRFIP1 | Hs.471779; | IPI00006207 | LRRFIP1 Isoform 2 of Leucine-rich repeat flightless-interacting protein 1 |
| CASP1 | Hs.2490; | IPI00219307 | CASP1 Isoform Beta of Caspase-1 precursor |
| PRKAR1A | Hs.280342; | IPI00021831 | PRKAR1A cAMP-dependent protein kinase type I-alpha regulatory |
| | Hs.659124; | | subunit |
| PDXK | Hs.284491; | IPI00418202 | PDXK Isoform 3 of Pyridoxal kinase |
| ATP6V1B2 | Hs.295917; | IPI00007812 | ATP6V1B2 Vacuolar ATP synthase subunit B, brain isoform |
| STMN1 | Hs.209983; | IPI00479997 | STMN1 Stathmin |
| TMOD3 | Hs.4998; | IPI00005087 | TMOD3 Tropomodulin-3 |
| CAT | Hs.502302; | IPI00465436 | CAT Catalase |
| TAGLN2 | Hs.517168; | IPI00550363 | TAGLN2 Transgelin-2 |
| PTPN12 | Hs.61812; | IPI00289082 | PTPN12 Tyrosine-protein phosphatase non-receptor type 12 |
| FKBP1A | Hs.471933; | IPI00647507 | FKBP1A Peptidyl-prolyl cis-trans isomerase |
| ENO1 | Hs.517145; | IPI00465248 | ENO1 Isoform alpha-enolase of Alpha-enolase |
| FKBP15 | Hs.522351; | IPI00853400 | FKBP15 FK506 binding protein 15, 133 kDa |
| SNAP23 | Hs.511149; | IPI00010438 | SNAP23 Isoform SNAP-23a of Synaptosomal-associated protein 23 |
| MRCL3 | Hs.190086; | IPI00604523 | MRCL3 Myosin regulatory light chain MRCL3 variant |
| RAB18 | Hs.406799; | IPI00479988 | RAB18 RAB18, member RAS oncogene family |
| ANXA2 | Hs.511605; | IPI00418169 | ANXA2 annexin A2 isoform 1 |
| ACTN4 | Hs.270291; | IPI00013808 | ACTN4 Alpha-actinin-4 |
| RAB35 | Hs.524788; | IPI00300096 | RAB35 Ras-related protein Rab-35 |
| WDR44 | Hs.98510; | IPI00747740 | WDR44 102 kDa protein |
| S100A10 | Hs.143873; | IPI00183695 | S100A10 Protein S100-A10 |
| BLMH | Hs.371914; | IPI00219575 | BLMH Bleomycin hydrolase |
| FLII | Hs.513984; | IPI00555570 | FLII Flightless I homolog variant |
| HYOU1 | Hs.277704; | IPI00000877 | HYOU1 Hypoxia up-regulated protein 1 precursor |
| RAB11FIP1 | Hs.191179; | IPI00419433 | RAB11FIP1 Isoform 1 of Rab11 family-interacting protein 1 |
| MAPRE1 | Hs.472437; | IPI00017596 | MAPRE1 Microtubule-associated protein RP/EB family member 1 |
| ACADVL | Hs.437178; | IPI00028031 | ACADVL Isoform 1 of Very-long-chain specific acyl-CoA |
| | | | dehydrogenase, mitochondrial precursor |
| SACM1L | Hs.156509; | IPI00022275 | SACM1L SAC1 suppressor of actin mutations 1-like |
| ARHGDIA | Hs.159161; | IPI00003815 | ARHGDIA Rho GDP-dissociation inhibitor 1 |
| HPRT1 | Hs.412707; | IPI00218493 | HPRT1 Hypoxanthine-guanine phosphoribosyltransferase |
| GPX1 | Hs.76686; | IPI00293975 | GPX1 glutathione peroxidase 1 isoform 1 |
| ARPC5 | Hs.518609; | IPI00550234 | ARPC5 Isoform 1 of Actin-related protein 2/3 complex subunit 5 |
| NANS | Hs.665191; | IPI00147874 | NANS Sialic acid synthase |
| | Hs.522310; | | |
| LAMP1 | Hs.494419; | IPI00004503 | LAMP1 lysosomal-associated membrane protein 1 |
| CAPZB | Hs.432760; | IPI00642256 | CAPZB Capping protein (Actin filament) muscle Z-line, beta |
| RAB11B | Hs.626404; | IPI00020436 | RAB11B Ras-related protein Rab-11B |
| PRDX4 | Hs.83383; | IPI00011937 | PRDX4 Peroxiredoxin-4 |
| STIM1 | Hs.501735; | IPI00299063 | STIM1 Stromal interaction molecule 1 precursor |
| SH3KBP1 | Hs.444770; | IPI00294962 | SH3KBP1 Isoform 1 of SH3 domain-containing kinase-binding protein 1 |
| UGP2 | Hs.516217; | IPI00329331 | UGP2 Isoform 1 of UTP--glucose-1-phosphate uridylyltransferase |
| CANX | Hs.567968; | IPI00020984 | CANX Calnexin precursor |
| EIF2S2 | Hs.429180; | IPI00816442 | EIF2S2 Eukaryotic translation initiation factor 2 subunit 2 |
| HMGB2 | Hs.434953; | IPI00219097 | HMGB2 High mobility group protein B2 |
| SLC3A2 | Hs.502769; | IPI00554722 | SLC3A2, LOC442497 solute carrier family 3 (activators of dibasic and |
| | | | neutral amino acid transport), member 2 isoform e |
| IGLV7-43 | IPI00022890 | IPI00022890 | IGLV7-43 Ig lambda chain V region 4A precursor |
| PARVB | Hs.475074; | IPI00043083 | PARVB Beta-parvin |
| TUBA8 | Hs.137400; | IPI00792478 | TUBA8 43 kDa protein |
| RSU1 | Hs.524161; | IPI00377066 | RSU1 ras suppressor protein 1 isoform 2 |
| CA2 | Hs.155097; | IPI00218414 | CA2 Carbonic anhydrase 2 |
| HSPC159 | Hs.372208; | IPI00023549 | HSPC159 Galectin-related protein |
| CD36 | Hs.120949; | IPI00418495 | CD36 Platelet glycoprotein 4 |
| | Hs.633085; | | |
| CD9 | Hs.114286; | IPI00795937 | CD9 15 kDa protein |
| FLNA | Hs.195464; | IPI00553169 | FLNA 28 kDa protein |
| PADI4 | Hs.522969; | IPI00008307 | PADI4 Protein-arginine deiminase type-4 |
| ITGA6 | Hs.133397; | IPI00216224 | ITGA6 Isoform Alpha-6X2B of Integrin alpha-6 precursor |
| CAMP | Hs.51120; | IPI00292532 | CAMP Antibacterial protein FALL-39 precursor |
| CALD1 | Hs.490203; | IPI00218696 | CALD1 Isoform 4 of Caldesmon |
| PDLIM7 | Hs.533040; | IPI00023560 | PDLIM7 Isoform 2 of PDZ and LIM domain protein 7 |
| CLU | Hs.436657; | IPI00795633 | CLU CLU |
| GIMAP7 | Hs.647074; | IPI00169340 | GIMAP7 GTPase IMAP family member 7 |
| BST1 | Hs.169998; | IPI00026240 | BST1 ADP-ribosyl cyclase 2 precursor |
| EPX | Hs.279259; | IPI00006690 | EPX Eosinophil peroxidase precursor |
| CD14 | Hs.163867; | IPI00029260 | CD14 Monocyte differentiation antigen CD14 precursor |
| ZYX | Hs.490415; | IPI00020513 | ZYX Zyxin |
| ITGAL | Hs.174103; | IPI00219896 | ITGAL Isoform 2 of Integrin alpha-L precursor |
| RAB3A | Hs.27744; | IPI00023504 | RAB3A Ras-related protein Rab-3A |
| RAB3B | Hs.123072; | IPI00300562 | RAB3B Ras-related protein Rab-3B |
| MYL9 | Hs.504687; | IPI00220278 | MYL9 Myosin regulatory light chain 2, smooth muscle isoform |
| CTSB | Hs.520898; | IPI00295741 | CTSB Cathepsin B precursor |
| RAB3D | Hs.655274; | IPI00032808 | RAB3D Ras-related protein Rab-3D |
| NCF2 | Hs.587558; | IPI00815773 | NCF2 Neutrophil cytosol factor 2 variant (Fragment) |
| EHD3 | Hs.368808; | IPI00021458 | EHD3 EH domain-containing protein 3 |
| BLVRA | Hs.488143; | IPI00294158 | BLVRA Biliverdin reductase A precursor |
| MYL1 | Hs.187338; | IPI00216070 | MYL1 Myosin light chain 1, skeletal muscle isoform |
| CYBA | Hs.513803; | IPI00218433 | CYBA Cytochrome b-245 light chain |
| LGALS3 | Hs.531081; | IPI00465431 | LGALS3 Galectin-3 |
| MGST1 | Hs.389700; | IPI00021805 | MGST1 Microsomal glutathione S-transferase 1 |
| DUSP3 | Hs.181046; | IPI00018671 | DUSP3 Dual specificity protein phosphatase 3 |
| LAMP2 | Hs.496684; | IPI00009030 | LAMP2 Isoform LAMP-2A of Lysosome-associated membrane |
| | | | glycoprotein 2 precursor |
| CTTN | Hs.632133; | IPI00029601 | CTTN Src substrate cortactin |
| PIP5K2A | Hs.57079; | IPI00009688 | PIP5K2A Phosphatidylinositol-4-phosphate 5-kinase type-2 alpha |
| S100A11 | Hs.417004; | IPI00013895 | S100A11 Protein S100-A11 |
| Sep11 | Hs.128199; | IPI00019376 | SEPT11 Septin-11 |
| RP2 | Hs.44766; | IPI00026627 | RP2 Protein XRP2 |
| LCP2 | Hs.304475; | IPI00297169 | LCP2 Lymphocyte cytosolic protein 2 |
| TST | Hs.474783; | IPI00216293 | TST Thiosulfate sulfurtransferase |
| CASP3 | Hs.141125; | IPI00292140 | CASP3 Caspase-3 precursor |
| PPM1A | Hs.592298; | IPI00020950 | PPM1A Isoform Alpha-1 of Protein phosphatase 1A |
| EHBP1L1 | Hs.502867; | IPI00296421 | EHBP1L1 EH domain-binding protein 1-like protein 1 |
| EHD4 | Hs.143703; | IPI00005578 | EHD4 EH domain-containing protein 4 |
| MAPRE2 | Hs.532824; | IPI00003420 | MAPRE2 Isoform 1 of Microtubule-associated protein RP/EB family |
| | | | member 2 |
| ATP6V1E1 | Hs.517338; | IPI00003856 | ATP6V1E1 Vacuolar ATP synthase subunit E 1 |
| CECR1 | Hs.170310; | IPI00303071 | CECR1 Cat eye syndrome critical region protein 1 precursor |
| BRUNOL6 | Hs.348342; | IPI00829779 | BRUNOL6 61 kDa protein |
| ACOX1 | Hs.464137; | IPI00296907 | ACOX1 Isoform 1 of Acyl-coenzyme A oxidase 1, peroxisomal |
| ARMET | Hs.436446; | IPI00328748 | ARMET Protein ARMET precursor |
| LOC151579 | Hs.529231; | IPI00787155 | LOC151579, BZW1 similar to basic leucine zipper and W2 domains 1 |
| PYCARD | Hs.499094; | IPI00001699 | PYCARD Isoform 1 of Apoptosis-associated speck-like protein |
| | | | containing a CARD |
| ERO1L | Hs.592304; | IPI00386755 | ERO1L ERO1-like protein alpha precursor |
| STRAP | Hs.504895; | IPI00294536 | STRAP Serine-threonine kinase receptor-associated protein |
| CD55 | Hs.527653; | IPI00647119 | CD55 CD55 molecule, decay accelerating factor for complement |
| TUBA4A | Hs.75318; | IPI00007750 | TUBA4A Tubulin alpha-4A chain |
| RDX | Hs.592679; | IPI00017367 | RDX Radixin |
| | Hs.263671; | | |
| KIF5B | Hs.644646; | IPI00012837 | KIF5B Kinesin heavy chain |
| AP2B1 | Hs.514819; | IPI00784156 | AP2B1 Isoform 1 of AP-2 complex subunit beta-1 |
| CALR | Hs.515162; | IPI00794237 | CALR Protein |
| GMFG | Hs.5210; | IPI00028414 | GMFG Glia maturation factor gamma |
| ROCK1 | Hs.306307; | IPI00022542 | ROCK1 Rho-associated protein kinase 1 |
| CCL5 | Hs.514821; | IPI00009309 | CCL5 Small inducible cytokine A5 precursor |
| TPM1 | Hs.133892; | IPI00216134 | TPM1 tropomyosin 1 alpha chain isoform 7 |
| IPI00784519 | IPI00784519 | IPI00784519 | Hypothetical protein |
| FHOD1 | Hs.95231; | IPI00001730 | FHOD1 FH1/FH2 domain-containing protein 1 |
| ESAM | Hs.173840; | IPI00303161 | ESAM Endothelial cell-selective adhesion molecule precursor |
| SKAP2 | Hs.644804; | IPI00022508 | SKAP2 Src kinase-associated phosphoprotein 2 |
| | Hs.200770; | | |
| RAB6B | IPI00016891 | IPI00016891 | RAB6B Ras-related protein Rab-6B |
| HEXB | Hs.69293; | IPI00012585 | HEXB Beta-hexosaminidase beta chain precursor |
| SLC2A3 | Hs.655169; | IPI00003909 | SLC2A3 Solute carrier family 2, facilitated glucose transporter member 3 |
| | Hs.419240; | | |
| MAOB | Hs.654473; | IPI00328156 | MAOB Amine oxidase [flavin-containing] B |
| AIF1 | Hs.76364; | IPI00795705 | AIF1 Allograft inflammatory factor 1 |
| IGHV4-31 | IPI00784822 | IPI00784822 | IGHV4-31 IGHV4-31 protein |
| S100P | Hs.2962; | IPI00017526 | S100P Protein S100-P |
| GP1BA | Hs.1472; | IPI00748955 | GP1BA platelet glycoprotein Ib alpha polypeptide precursor |
| FER1L3 | Hs.655278; | IPI00216269 | FER1L3 Isoform 3 of Myoferlin |
| PF4V1 | Hs.72933; | IPI00022295 | PF4V1 Platelet factor 4 variant precursor |
| ALOX12 | Hs.654431; | IPI00218915 | ALOX12 Arachidonate 12-lipoxygenase, 12S-type |
| C9orf19 | Hs.493819; | IPI00007067 | C9orf19 Golgi-associated plant pathogenesis-related protein 1 |
| RAB32 | Hs.287714; | IPI00014377 | RAB32 Ras-related protein Rab-32 |
| VTN | Hs.2257; | IPI00298971 | VTN Vitronectin precursor |
| CPVL | Hs.233389; | IPI00301395 | CPVL Probable serine carboxypeptidase CPVL precursor |
| | Hs.449281; | | |
| ORM1 | Hs.567311; | IPI00022429 | ORM1 Alpha-1-acid glycoprotein 1 precursor |
| PSTPIP2 | Hs.567384; | IPI00743499 | PSTPIP2 33 kDa protein |
| SIRPA | Hs.581021; | IPI00332887 | SIRPA signal-regulatory protein alpha precursor |
| | Hs.679042; | | |
| HSP90AB1 | Hs.509736; | IPI00515119 | HSP90AB1 Heat shock protein 90 kDa alpha (Cytosolic), class B |
| | | | member 1 |
| ITGAX | Hs.248472; | IPI00302270 | ITGAX Integrin alpha-X precursor |
| SCPEP1 | Hs.514950; | IPI00012426 | SCPEP1 Isoform 1 of Retinoid-inducible serine carboxypeptidase |
| | | | precursor |
| PPM1F | Hs.112728; | IPI00291412 | PPM1F Protein phosphatase 1F |
| BLVRB | Hs.515785; | IPI00219910 | BLVRB 23 kDa protein |
| GNB2 | Hs.185172; | IPI00790896 | GNB2 26 kDa protein |
| BID | Hs.591054; | IPI00420084 | BID Isoform 2 of BH3-interacting domain death agonist |
| PXN | Hs.661210; | IPI00335634 | PXN Isoform Beta of Paxillin |
| | Hs.446336; | | |
| TMEM30A | Hs.108530; | IPI00019381 | TMEM30A Isoform 1 of Cell cycle control protein 50A |
| C1orf38 | Hs.10649; | IPI00514477 | C1orf38 Isoform 1 of Induced by contact to basement membrane 1 |
| | | | protein |
| ARF4 | Hs.652183; | IPI00792330 | ARF4 14 kDa protein |
| ROCK2 | Hs.591600; | IPI00307155 | ROCK2 Rho-associated protein kinase 2 |
| FYB | Hs.370503; | IPI00446986 | FYB FYN-binding protein |
| DPYD | Hs.335034; | IPI00029772 | DPYD Dihydropyrimidine dehydrogenase [NADP+] precursor |
| OGFR | Hs.67896; | IPI00021537 | OGFR Isoform 1 of Opioid growth factor receptor |
| VAMP3 | Hs.66708; | IPI00549343 | VAMP3 Vesicle-associated membrane protein 3 |
| ITGB5 | Hs.536663; | IPI00790921 | ITGB5 21 kDa protein |
| SHMT1 | Hs.695559; | IPI00793862 | SHMT1 49 kDa protein |
| | Hs.513987; | | |
| | Hs.636044; | | |
| PRCP | Hs.523936; | IPI00001593 | PRCP Lysosomal Pro-X carboxypeptidase precursor |
| STMN2 | Hs.521651; | IPI00795953 | STMN2 20 kDa protein |
| HMGB3 | Hs.693708; | IPI00217477 | HMGB3 High mobility group protein B3 |
| WAS | Hs.2157; | IPI00001545 | WAS Wiskott-Aldrich syndrome protein |
| VAMP8 | Hs.534373; | IPI00030911 | VAMP8 Vesicle-associated membrane protein 8 |
| FLJ25715 | IPI00025285 | IPI00025285 | ATP6V1G1, FLJ25715 Vacuolar ATP synthase subunit G 1 |
| COMMD1 | Hs.468702; | IPI00171117 | COMMD1 COMM domain-containing protein 1 |
| GZMK | Hs.277937; | IPI00028602 | GZMK Granzyme K precursor (Fragment) |
| USP15 | Hs.434951; | IPI00219505 | USP15 Isoform 3 of Ubiquitin carboxyl-terminal hydrolase 15 |
| TRIM21 | Hs.532357; | IPI00018971 | TRIM21 52 kDa Ro protein |
| TCEB2 | Hs.172772; | IPI00026670 | TCEB2 Transcription elongation factor B polypeptide 2 |
| TMOD2 | Hs.659839; | IPI00794581 | TMOD2 34 kDa protein |
| IPO7 | Hs.652248; | IPI00784008 | IPO7 Importin-7 |
| PTGS1 | Hs.201978; | IPI00514766 | PIGS1 prostaglandin-endoperoxide synthase 1 isoform 2 precursor |
| ARRB1 | Hs.503284; | IPI00293857 | ARRB1 Isoform 1A of Beta-arrestin-1 |
| | Hs.625320; | | |
| S100A12 | Hs.19413; | IPI00218131 | S100A12 Protein S100-A12 |
| CLC | Hs.889; | IPI00216071 | CLC Eosinophil lysophospholipase |
| NAIP1B | IPI00398857 | IPI00398857 | NAIP1B similar to Baculoviral IAP repeat-containing protein 1 |
| TGFB111 | Hs.513530; | IPI00761017 | TGFB111 Isoform 1 of Transforming growth factor beta-1-induced |
| | | | transcript 1 protein |
| FCER1G | Hs.433300; | IPI00025804 | FCER1G High affinity immunoglobulin epsilon receptor subunit gamma |
| | | | precursor |
| EPB49 | Hs.106124; | IPI00797253 | EPB49 46 kDa protein |
| NEXN | Hs.632387; | IPI00180404 | NEXN nexilin |
| VAPA | Hs.165195; | IPI00640416 | VAPA 19 kDa protein |
| TGFB1 | Hs.645227; | IPI00000075 | TGFB1 Transforming growth factor beta-1 precursor |
| PADI2 | Hs.33455; | IPI00294187 | PADI2 Protein-arginine deiminase type-2 |
| CD97 | Hs.466039; | IPI00397230 | CD97 Isoform 3 of CD97 antigen precursor |
| LOC654029 | IPI00787407 | IPI00787407 | LOC654029 similar to 40S ribosomal protein S10 |
| ARFGAP1 | Hs.25584; | IPI00217354 | ARFGAP1 Isoform 2 of ADP-ribosylation factor GTPase-activating |
| | | | protein 1 |
| MAPKAPK3 | Hs.234521; | IPI00005777 | MAPKAPK3 MAP kinase-activated protein kinase 3 |
| C6orf25 | Hs.247879; | IPI00216583 | C6orf25 Isoform A of Protein G6b precursor |
| DSTN | Hs.304192; | IPI00643237 | DSTN 15 kDa protein |
| | Hs.667348; | | |
| IPI00555957 | IPI00555957 | IPI00555957 | Heat shock protein 90Ad |
| RAB27B | Hs.25318; | IPI00010491 | RAB27B Ras-related protein Rab-27B |
| ANXA3 | Hs.480042; | IPI00745868 | ANXA3 36 kDa protein |
| KIAA1598 | Hs.501140; | IPI00448751 | KIAA1598 Protein KIAA1598 |
| HK2 | Hs.591588; | IPI00102864 | HK2 Hexokinase-2 |
| | Hs.406266; | | |
| RENBP | Hs.158331; | IPI00796170 | RENBP 49 kDa protein |
| DYSF | Hs.252180; | IPI00020210 | DYSF Dysferlin_v1 |
| RASA3 | Hs.655219; | IPI00784114 | RASA3 96 kDa protein |
| PRAM1 | Hs.465812; | IPI00335147 | PRAM1 Isoform 2 of PML-RARA-regulated adapter molecule 1 |
| TPM4 | Hs.631618; | IPI00216975 | TPM4 Isoform 2 of Tropomyosin alpha-4 chain |
| RARRES2 | Hs.647064; | IPI00019176 | RARRES2 Retinoic acid receptor responder protein 2 precursor |
| SYTL4 | Hs.592224; | IPI00060201 | SYTL4 Isoform 1 of Synaptotagmin-like protein 4 |
| MARCKS | Hs.519909; | IPI00219301 | MARCKS Myristoylated alanine-rich C-kinase substrate |
| | Hs.694902; | | |
| DBN1 | Hs.130316; | IPI00295624 | DBN1 drebrin 1 isoform b |
| ATP6V1C1 | Hs.86905; | IPI00514430 | ATP6V1C1 ATPase, H+ transporting, lysosomal 42 kDa, VI subunit C1 |
| | | | isoform B |
| SORT1 | Hs.609479; | IPI00843957 | SORT1 83 kDa protein |
| | Hs.485195; | | |
| ATP6V0A1 | Hs.463074; | IPI00465178 | ATP6V0A1 Isoform 1 of Vacuolar proton translocating ATPase 116 kDa |
| | | | subunit a isoform 1 |
| MPP1 | Hs.496984; | IPI00215610 | MPP1 55 kDa erythrocyte membrane protein |
| PDIA5 | Hs.477352; | IPI00031479 | PDIA5 Protein disulfide-isomerase A5 precursor |
| MPST | Hs.248267; | IPI00165360 | MPST 3-mercaptopyruvate sulfurtransferase |
| CD180 | Hs.87205; | IPI00023722 | CD180 CD180 antigen precursor |
| TREML1 | Hs.117331; | IPI00410333 | TREML1 Isoform 1 of Trem-like transcript 1 protein precursor |
| P2RX4 | Hs.321709; | IPI00293327 | P2RX4 P2X purinoceptor 4 |
| SAR1A | Hs.499960; | IPI00015954 | SAR1A GTP-binding protein SAR1a |
| CASP4 | Hs.138378; | IPI00027725 | CASP4 Caspase-4 precursor |
| RCN1 | Hs.97887; | IPI00015842 | RCN1 Reticulocalbin-1 precursor |
| SLC44A1 | Hs.573495; | IPI00005068 | SLC44A1 Isoform 2 of Choline transporter-like protein 1 |
| CARD9 | Hs.694071; | IPI00745573 | CARD9 Isoform 2 of Caspase recruitment domain-containing protein 9 |
| VPS37B | Hs.507162; | IPI00002926 | VPS37B Vacuolar protein sorting-associated protein 37B |
| DOK3 | Hs.153343; | IPI00156649 | DOK3 Isoform 1 of Docking protein 3 |
| RAB1A | Hs.310645; | IPI00005719 | RAB1A Isoform 1 of Ras-related protein Rab-1A |
| ARRB2 | Hs.435811; | IPI00786904 | ARRB2 Isoform 2 of Beta-arrestin-2 |
| HOOK3 | Hs.162852; | IPI00031768 | HOOK3 Hook homolog 3 |
| ATP6V0D1 | Hs.106876; | IPI00034159 | ATP6V0D1 Vacuolar ATP synthase subunit d 1 |
| VPS36 | Hs.109520; | IPI00646971 | VPS36 Isoform 2 of Vacuolar protein sorting-associated protein 36 |
| SPTLC2 | Hs.435661; | IPI00005751 | SPTLC2 Serine palmitoyltransferase 2 |
| NDRG1 | Hs.372914; | IPI00183085 | NDRG1 CDNA FLJ38330 fis, clone FCBBF3025280, highly similar to |
| | | | NDRG1 PROTEIN |
| CHP | Hs.675412; | IPI00218924 | CHP Calcium-binding protein p22 |
| | Hs.406234; | | |
| IPI00735653 | IPI00735653 | IPI00735653 | KIAA1949 |
| RNASE2 | Hs.728; | IPI00019449 | RNASE2 Nonsecretory ribonuclease precursor |
| PSMB6 | Hs.77060; | IPI00796198 | PSMB6 12 kDa protein |
| ZZEF1 | Hs.277624; | IPI00847913 | ZZEF1 Isoform 3 of Zinc finger ZZ-type and EF-hand domain-containing |
| | | | protein 1 |
| ANKFY1 | Hs.513875; | IPI00159899 | ANKFY1 ankyrin repeat and FYVE domain containing 1 isoform 1 |
| SNX27 | Hs.192326; | IPI00640980 | SNX27 sorting nexin family member 27 |
| PPP1R12C | IPI00014340 | IPI00014340 | PPP1R12C Protein phosphatase 1 regulatory subunit 12C |
| STX12 | Hs.523855; | IPI00329332 | STX12 Syntaxin-12 |
| CUL2 | Hs.82919; | IPI00014311 | CUL2 Cullin-2 |
| NRD1 | Hs.584782; | IPI00243221 | NRD1 Nardilysin |
| PDXDC1 | Hs.370781; | IPI00645809 | PDXDC1 similar to CG1486-PA, isoform A |
| DOCK5 | Hs.195403; | IPI00792788 | DOCK5 Isoform 1 of Dedicator of cytokinesis protein 5 |
| CNTROB | Hs.348012; | IPI00295638 | CNTROB Isoform 1 of Centrobin |
| HTATIP2 | Hs.90753; | IPI00383665 | HTATIP2 Isoform 2 of Oxidoreductase HTATIP2 |
| C14orf173 | Hs.24956; | IPI00008339 | C14orf173 hypothetical protein LOC64423 isoform 1 |
| | Hs.317821; | | |
| PDE6D | Hs.516808; | IPI00015161 | PDE6D Retinal rod rhodopsin-sensitive cGMP 3′,5′-cyclic |
| | | | phosphodiesterase subunit delta |
| ACO1 | Hs.651276; | IPI00008485 | ACO1 Iron-responsive element-binding protein 1 |
| DPP7 | Hs.37916; | IPI00788159 | DPP7 similar to Dipeptidyl-peptidase 2 precursor |
| GYS1 | Hs.386225; | IPI00157144 | GYS1 GYS1 protein |
| NEDD8 | Hs.531064; | IPI00020008 | NEDD8 NEDD8 precursor |
| | Hs.657248; | | |
| RPS6KA2 | Hs.655277; | IPI00748195 | RPS6KA2 91 kDa protein |
| CD99 | IPI00253036 | IPI00253036 | CD99 Isoform I of CD99 antigen precursor |
| GOLGA2 | Hs.155827; | IPI00413895 | GOLGA2 Golgin subfamily A member 2 |
| FCGRT | Hs.111903; | IPI00026646 | FCGRT IgG receptor FcRn large subunit p51 precursor (Fragment) |
| DUSP23 | Hs.425801; | IPI00306353 | DUSP23 Dual specificity protein phosphatase 23 |
| CYB5R1 | Hs.334832; | IPI00643530 | CYB5R1 Protein |
| TPT1 | Hs.374596; | IPI00550900 | TPT1 Translationally-controlled tumor protein |
| ARFIP1 | Hs.416089; | IPI00021258 | ARFIP1 Isoform B of Arfaptin-1 |
| RAB9A | Hs.495704; | IPI00016372 | RAB9A Ras-related protein Rab-9 |
| ICAM2 | Hs.431460; | IPI00793902 | ICAM2 Intercellular adhesion molecule 2 |
| CCDC88B | Hs.98564; | IPI00398837 | CCDC88B coiled-coil domain containing 88 |
| EHBP1 | Hs.271667; | IPI00178187 | EHBP1 Isoform 1 of EH domain-binding protein 1 |
| PREB | Hs.279784; | IPI00033349 | PREB Prolactin regulatory element-binding protein |
| AP3D1 | Hs.512815; | IPI00289608 | AP3D1 Isoform 2 of AP-3 complex subunit delta-1 |
| COBLL1 | Hs.470457; | IPI00007133 | COBLL1 Isoform 3 of Cordon-bleu protein-like 1 |
| TMEM40 | Hs.475502; | IPI00168036 | TMEM40 Isoform 1 of Transmembrane protein 40 |
| CD33 | Hs.83731; | IPI00642882 | CD33 31 kDa protein |
| JAM3 | Hs.150718; | IPI00152850 | JAM3 junctional adhesion molecule 3 precursor |
| AGTRAP | Hs.464438; | IPI00513986 | AGTRAP Isoform 2 of Type-1 angiotensin II receptor-associated protein |
| PTPN18 | Hs.591549; | IPI00152019 | PTPN18 PTPN18 protein |
| LOC389101 | Hs.525984; | IPI00787625 | LOC389101 similar to 60S ribosomal protein L23a |
| TSPAN32 | Hs.271954; | IPI00220777 | TSPAN32 Isoform 2 of Tetraspanin-32 |
| GNLY | Hs.105806; | IPI00396242 | GNLY Isoform Short of Granulysin precursor |
| CAMK1 | Hs.434875; | IPI00028296 | CAMK1 Calcium/calmodulin-dependent protein kinase type 1 |
| CRISP3 | Hs.404466; | IPI00004798 | CRISP3 Cysteine-rich secretory protein 3 precursor |
| HIST1H4G | Hs.553507; | IPI00020618 | HIST1H4G H4 histone family, member L |
| EPB41L3 | Hs.213394; | IPI00215717 | EPB41L3 Isoform C of Band 4.1-like protein 3 |
| BRF1 | Hs.424484; | IPI00607889 | BRF1 Isoform 5 of Transcription factor IIIB 90 kDa subunit |
| C10orf54 | Hs.47382; | IPI00303333 | C10orf54 Platelet receptor Gi24 precursor |
| CD300LF | Hs.567706; | IPI00783431 | CD300LF Isoform 6 of CMRF35-like-molecule 1 precursor |
| TMEM126B | Hs.525063; | IPI00477843 | TMEM126B Isoform 5 of Transmembrane protein 126B |
| GNAQ | Hs.269782; | IPI00288947 | GNAQ Guanine nucleotide binding protein (G protein), q polypeptide |
| SERPINB10 | Hs.158339; | IPI00791734 | SERPINB10 Protein |
| ALDH3B1 | Hs.523841; | IPI00166751 | ALDH3B1 Isoform 2 of Aldehyde dehydrogenase 3B1 |
| VNN2 | Hs.293130; | IPI00030872 | VNN2 Vascular non-inflammatory molecule 2 precursor |
| C10orf47 | Hs.435775; | IPI00329115 | C10orf47 Isoform 1 of Uncharacterized protein C10orf47 |
| IGF2BP2 | Hs.35354; | IPI00743914 | IGF2BP2 Insulin-like growth factor 2 mRNA binding protein 2 |
| PRKG1 | Hs.654556; | IPI00552517 | PRKG1 Protein kinase, cGMP-dependent, type I |
| FAM101B | Hs.591203; | IPI00166945 | FAM101B Protein FAM101B |
| | Hs.345588; | | |
| | Hs.615223; | | |
| | Hs.596411; | | |
| PABPC1 | Hs.387804; | IPI00796139 | PABPC1 8 kDa protein |
| GMPR | Hs.484741; | IPI00304803 | GMPR GMP reductase 1 |
| AYTL1 | Hs.460857; | IPI00016418 | AYTL1 Isoform 1 of Acyltransferase-like 1 |
| MYH2 | IPI00007856 | IPI00007856 | MYH2 Myosin-2 |
| IPI00414883 | IPI00414883 | IPI00414883 | 30 kDa protein |
| C20orf27 | Hs.274422; | IPI00101095 | C20orf27 Uncharacterized protein C20orf27 |
| ITGA2B | Hs.411312; | IPI00556609 | ITGA2B Integrin alpha-IIb variant (Fragment) |
| SNCA | Hs.271771; | IPI00024107 | SNCA Isoform 1 of Alpha-synuclein |
| CHI3L1 | Hs.382202; | IPI00002147 | CHI3L1 Chitinase-3-like protein 1 precursor |
| NBEAL2 | Hs.437043; | IPI00297242 | NBEAL2 similar to CG1332-PA |
| NADK | Hs.654792; | IPI00301034 | NADK NAD kinase |
| NID1 | Hs.356624; | IPI00026944 | NID1 Isoform 1 of Nidogen-1 precursor |
| TMSB4X | Hs.522584; | IPI00220828 | TMSB4X Thymosin beta-4 |
| CR1 | Hs.334019; | IPI00640083 | CR1 Complement component (3b/4b) receptor 1 |
| GTPBP2 | Hs.485449; | IPI00785134 | GTPBP2 Isoform 2 of GTP-binding protein 2 |
| SLC16A3 | Hs.500761; | IPI00006666 | SLC16A3 Monocarboxylate transporter 4 |
| GNAZ | Hs.584760; | IPI00328128 | GNAZ Guanine nucleotide-binding protein G |
| GIMAP5 | Hs.647079; | IPI00304937 | GIMAP5 Isoform 1 of GTPase IMAP family member 5 |
| MRPL40 | Hs.431307; | IPI00099871 | MRPL40 39S ribosomal protein L40, mitochondrial precursor |
| TOE1 | Hs.525091; | IPI00549516 | TOE1 Target of EGR1 protein 1 |
| ITGA2 | Hs.482077; | IPI00013744 | ITGA2 Integrin alpha-2 precursor |
| MAP4 | Hs.517949; | IPI00396171 | MAP4 Isoform 1 of Microtubule-associated protein 4 |
| MGC11102 | Hs.425178; | IPI00298618 | MGC11102 CDNA FLJ36810 fis, clone ASTRO2001249 |
| SNTB1 | Hs.655236; | IPI00026059 | SNTB1 Isoform 1 of Beta-1-syntrophin |
| LOC643287 | Hs.671023; | IPI00737372 | LOC643287 similar to prothymosin, alpha (gene sequence 28) isoform 1 |
| PLCB3 | Hs.591953; | IPI00181283 | PLCB3 Similar to phospholipase C, beta 3 (Fragment) |
| CLIP2 | Hs.647018; | IPI00246616 | CLIP2 Isoform 2 of CAP-Gly domain-containing linker protein 2 |
| PRKACB | Hs.487325; | IPI00376119 | PRKACB Isoform 2 of cAMP-dependent protein kinase, beta-catalytic |
| | | | subunit |
| SRGN | Hs.1908; | IPI00019372 | SRGN Serglycin precursor |
| TMBIM1 | Hs.591605; | IPI00290452 | TMBIM1 Transmembrane BAX inhibitor motif-containing protein 1 |
| PTPN18 | Hs.591549; | IPI00219132 | PTPN18 protein tyrosine phosphatase, non receptor type 18 |
| LGMN | Hs.18069; | IPI00293303 | LGMN Legumain precursor |
| HNRPK | Hs.522257; | IPI00640296 | HNRPK Heterogeneous nuclear ribonucleoprotein K |
| DENND3 | Hs.656299; | IPI00448616 | DENND3 DENN/MADD domain containing 3 |
| HEBP1 | Hs.642618; | IPI00148063 | HEBP1 Heme-binding protein 1 |
| PLAUR | Hs.466871; | IPI00010676 | PLAUR Isoform 1 of Urokinase plasminogen activator surface receptor |
| | | | precursor |
| PSCD4 | Hs.170944; | IPI00395879 | PSCD4 Cytohesin-4 |
| VTA1 | Hs.431367; | IPI00643263 | VTA1 Chromosome 6 open reading frame 55 |
| ADAM15 | Hs.312098; | IPI00013302 | ADAM15 ADAM 15 precursor |
| MGST2 | Hs.81874; | IPI00017767 | MGST2 Microsomal glutathione S-transferase 2 |
| FRYL | Hs.660485; | IPI00739940 | FRYL Isoform 1 of Protein furry homolog-like |
| | Hs.631525; | | |
| | Hs.646327; | | |
| SRC | Hs.195659; | IPI00328867 | SRC Isoform 2 of Proto-oncogene tyrosine-protein kinase Src |
| ACTA2 | Hs.500483; | IPI00816229 | ACTA2 ACTA2 protein (Fragment) |
| UTRN | Hs.133135; | IPI00009329 | UTRN Utrophin |
| ZNF185 | Hs.16622; | IPI00647837 | ZNF185 zinc finger protein 185 |
| EPB41L2 | Hs.486470; | IPI00022133 | EPB41L2 4.1G protein (Fragment) |
| CAST | Hs.440961; | IPI00760715 | CAST calpastatin isoform e |
| PLCB2 | Hs.355888; | IPI00301480 | PLCB2 134 kDa protein |
| TF | Hs.518267; | IPI00798430 | TF Transferrin variant (Fragment) |
| CST3 | Hs.304682; | IPI00032293 | CST3 Cystatin-C precursor |
| AKT1 | Hs.525622; | IPI00012866 | AKT1 RAC-alpha serine/threonine-protein kinase |
| UBQLN2 | Hs.179309; | IPI00409659 | UBQLN2 Ubiquilin-2 |
| KLF12 | Hs.592500; | IPI00239722 | KLF12 Isoform 2 of Krueppel-like factor 12 |
| | Hs.373857; | | |
| YES1 | Hs.194148; | IPI00013981 | YES1 Proto-oncogene tyrosine-protein kinase Yes |
| OS9 | Hs.527861; | IPI00784446 | OS9 amplified in osteosarcoma isoform 2 precursor |
| PROS1 | Hs.64016; | IPI00294004 | PROS1 Vitamin K-dependent protein S precursor |
| KIAA0828 | Hs.600789; | IPI00101645 | KIAA0828 Putative adenosylhomocysteinase 3 |
| APPL2 | Hs.506603; | IPI00172513 | APPL2 DCC-interacting protein 13-beta |
| CLASP1 | Hs.469840; | IPI00396279 | CLASP1 Isoform 1 of CLIP-associating protein 1 |
| MTA1 | Hs.525629; | IPI00012773 | MTA1 Isoform Long of Metastasis-associated protein MTA1 |
| SGTB | Hs.482301; | IPI00061623 | SGTB Small glutamine-rich tetratricopeptide repeat-containing protein B |
| CLIC5 | Hs.485489; | IPI00294443 | CLIC5 Isoform 1 of Chloride intracellular channel protein 5 |
| RAB5A | Hs.475663; | IPI00023510 | RAB5A Ras-related protein Rab-5A |
| SMAD2 | Hs.12253; | IPI00019548 | SMAD2 Isoform Long of Mothers against decapentaplegic homolog 2 |
| | Hs.598146; | | |
| JMJD1B | Hs.483486; | IPI00298935 | JMJD1B Isoform 1 of JmjC domain-containing histone demethylation |
| | | | protein 2B |
| ARF5 | Hs.653202; | IPI00215919 | ARF5 ADP-ribosylation factor 5 |
| MGC40499 | Hs.632293; | IPI00102962 | MGC40499 PRotein Associated with Tlr4 |
| SLK | Hs.591922; | IPI00247439 | SLK Isoform 2 of STE20-like serine/threonine-protein kinase |
| USP4 | Hs.631919; | IPI00796905 | USP4 Ubiquitin specific protease, proto-oncogene isoform b variant |
| | | | (Fragment) |
| CAST | Hs.440961; | IPI00302047 | CAST calpastatin isoform c |
| AHCYL1 | Hs.485365; | IPI00182938 | AHCYL1 Isoform 1 of Putative adenosylhomocysteinase 2 |
| TESC | Hs.525709; | IPI00149680 | TESC Tescalcin |
| TBC1D2 | Hs.371016; | IPI00647041 | TBC1D2 TBC1 domain family, member 2 |
| VPS25 | Hs.500165; | IPI00031655 | VPS25 Vacuolar protein sorting-associated protein 25 |
| CUTL1 | Hs.654389; | IPI00741668 | CUTL1 Isoform 7 of Homeobox protein cut-like 1 |
| RAB4A | Hs.296169; | IPI00549945 | RAB4A, SPHAR RAB4A, member RAS oncogene family variant |
| SIGIRR | Hs.501624; | IPI00029155 | SIGIRR Isoform 1 of Single Ig IL-1-related receptor |
| AVEN | Hs.555966; | IPI00006904 | AVEN Cell death regulator Aven |
| IDE | Hs.500546; | IPI00220373 | IDE Insulin-degrading enzyme |
| TMSB10 | Hs.446574; | IPI00220827 | TMSB10 Thymosin beta-10 |
| ATP8A1 | Hs.435052; | IPI00032402 | ATP8A1 Isoform Long of Probable phospholipid-transporting ATPase IA |
| STAT5A | Hs.437058; | IPI00030783 | STAT5A Signal transducer and activator of transcription 5A |
| CIC | Hs.388236; | IPI00045360 | CIC Protein capicua homolog |
| PPFIA1 | Hs.530749; | IPI00219754 | PPFIA1 Isoform 2 of Liprin-alpha-1 |
| ZRF1 | Hs.558476; | IPI00830108 | ZRF1 Isoform 1 of DnaJ homolog subfamily C member 2 |
| GLT25D1 | Hs.418795; | IPI00168262 | GLT25D1 Glycosyltransferase 25 domain-containing protein 1 |
| KDELC2 | Hs.83286; | IPI00783221 | KDELC2 Isoform 2 of KDEL motif-containing protein 2 precursor |
| BICD2 | Hs.436939; | IPI00337667 | BICD2 Isoform 2 of Protein bicaudal D homolog 2 |
| POLG | Hs.694818; | IPI00004317 | POLG DNA polymerase subunit gamma 1 |
| C14orf133 | Hs.16157; | IPI00004958 | C14orf133 Isofornn 1 of Uncharacterized protein C14orf133 |
| CCDC93 | Hs.107845; | IPI00154668 | CCDC93 Coiled-coil domain-containing protein 93 |
| MAX | Hs.285354; | IPI00219929 | MAX Isoform 2 of Protein max |
| ADA | Hs.654536; | IPI00296441 | ADA Adenosine deaminase |
| GSDMDC1 | Hs.118983; | IPI00658006 | GSDMDC1 CDNA FLJ46051 fis, clone SYNOV4000598 |
| CEP170 | Hs.533635; | IPI00186194 | CEP170 Isoform 1 of Centrosomal protein of 170 kDa |
| | Hs.408293; | | |
| PLOD3 | Hs.153357; | IPI00030255 | PLOD3 Procollagen-lysine, 2-oxoglutarate 5-dioxygenase 3 precursor |
| ACTN2 | Hs.498178; | IPI00019884 | ACTN2 Alpha-actinin-2 |
| IGF2R | Hs.487062; | IPI00289819 | IGF2R Cation-independent mannose-6-phosphate receptor precursor |
| ATG3 | Hs.477126; | IPI00022254 | ATG3 Isoform 1 of Autophagy-related protein 3 |
| IFI35 | Hs.632258; | IPI00008613 | IFI35 Isoform 1 of Interferon-induced 35 kDa protein |
| FN1 | Hs.203717; | IPI00642991 | FN1 fibronectin 1 isoform 6 preproprotein |
| NCF1 | Hs.655201; | IPI00472396 | NCF1 neutrophil cytosolic factor 1 |
| | Hs.647047; | | |
| COMMD10 | Hs.483136; | IPI00412811 | COMMD10 COMM domain-containing protein 10 |
| TACC1 | Hs.279245; | IPI00550248 | TACC1 Isoform 7 of Transforming acidic coiled-coil-containing protein 1 |
| CD3EAP | Hs.664501; | IPI00012788 | CD3EAP Isoform 2 of DNA-directed RNA polymerase I subunit RPA34 |
| VPS13A | Hs.459790; | IPI00604660 | VPS13A Isoform 4 of Vacuolar protein sorting-associated protein 13A |
| | Hs.662256; | | |
| RNASEL | Hs.518545; | IPI00015864 | RNASEL 2-5A-dependent ribonuclease |
| TOR1A | Hs.534312; | IPI00477657 | TOR1A 38 kDa protein |
| MACF1 | Hs.580782; | IPI00550385 | MACF1 Isoform 1 of Microtubule-actin cross-linking factor 1, isoforms |
| | | | 1/2/3/5 |
| RELA | Hs.502875; | IPI00719633 | RELA RELA protein |
| CHMP2A | Hs.12107; | IPI00004416 | CHMP2A Charged multivesicular body protein 2a |
| RYBP | Hs.694786; | IPI00296594 | RYBP RING1 and YY1-binding protein |
| LRCH1 | Hs.656722; | IPI00376144 | LRCH1 Isoform 2 of Leucine-rich repeat and calponin homology |
| | | | domain-containing protein 1 |
| C10orf119 | Hs.124246; | IPI00414458 | C10orf119 Isoform 1 of Uncharacterized protein C10orf119 |
| RNPEP | Hs.497391; | IPI00647400 | RNPEP 68 kDa protein |
| KIAA0157 | Hs.280695; | IPI00299517 | KIAA0157 Uncharacterized protein KIAA0157 |
| GMPPB | Hs.567488; | IPI00030920 | GMPPB, AMIGO3 GDP-mannose pyrophosphorylase B isoform 2 |
| SEC23B | Hs.369373; | IPI00017376 | SEC23B Protein transport protein Sec23B |
| | Hs.460238; | | |
| AARSD1 | Hs.317403; | IPI00748490 | AARSD1 Alanyl-tRNA synthetase, class IIc family protein |
| ARHGAP6 | Hs.435291; | IPI00221123 | ARHGAP6 Isoform 4 of Rho GTPase-activating protein 6 |
| NCSTN | Hs.517249; | IPI00375688 | NCSTN Isoform 2 of Nicastrin precursor |
| SPAG9 | Hs.593620; | IPI00218097 | SPAG9 Isoform 2 of C-jun-amino-terminal kinase-interacting protein 4 |
| | Hs.463439; | | |
| EXOC1 | Hs.269665; | IPI00215762 | EXOC1 Isoform 2 of Exocyst complex component 1 |
| NRAS | Hs.486502; | IPI00844005 | NRAS 89 kDa protein |
| RSU1 | Hs.524161; | IPI00643346 | RSU1 RSU1 protein (Fragment) |
| MAPKAPK2 | Hs.643566; | IPI00026054 | MAPKAPK2 Isoform 1 of MAP kinase-activated protein kinase 2 |
| RCN2 | Hs.79088; | IPI00029628 | RCN2 Reticulocalbin-2 precursor |
| LUZP1 | Hs.257900; | IPI00296830 | LUZP1 Isoform 1 of Leucine zipper protein 1 |
| FYN | Hs.390567; | IPI00219012 | FYN Isoform 1 of Proto-oncogene tyrosine-protein kinase Fyn |
| LOC645312 | IPI00412440 | IPI00412440 | LOC645312 similar to Glycolipid transfer protein |
| PFDN2 | Hs.492516; | IPI00006052 | PFDN2 Prefoldin subunit 2 |
| EIF2C2 | Hs.449415; | IPI00220349 | EIF2C2 eukaryotic translation initiation factor 2C, 2 |
| PRPS2 | Hs.654581; | IPI00219617 | PRPS2 Ribose-phosphate pyrophosphokinase II |
| RAB24 | Hs.16258; | IPI00792833 | RAB24 20 kDa protein |
| CLN6 | Hs.584921; | IPI00798061 | CLN6 29 kDa protein |
| GGA2 | Hs.460336; | IPI00642330 | GGA2 31 kDa protein |
| SCAMP4 | Hs.144980; | IPI00472242 | SCAMP4 Isoform 2 of Secretory carrier-associated membrane protein 4 |
| GSTM4 | Hs.348387; | IPI00008770 | GSTM4, GSTM2 Isoform 1 of Glutathione S-transferase Mu 4 |
| CRTC2 | Hs.406392; | IPI00639850 | CRTC2 Transducer of regulated cAMP response element-binding |
| | | | protein (CREB) 2 |
| EXOC4 | Hs.321273; | IPI00655649 | EXOC4 EXOC4 protein |
| EXOC3 | Hs.646923; | IPI00157734 | EXOC3 Isoform 1 of Exocyst complex component 3 |
| GTF2E1 | Hs.445272; | IPI00019977 | GTF2E1 Transcription initiation factor IIE subunit alpha |
| MTMR3 | Hs.474536; | IPI00185018 | MTMR3 Isoform B of Myotubularin-related protein 3 |
| CEP250 | Hs.443976; | IPI00160622 | CEP250 Isoform 1 of Centrosome-associated protein CEP250 |
| WDR55 | Hs.286261; | IPI00302990 | WDR55 WD repeat protein 55 |
| ATP2B4 | Hs.343522; | IPI00217170 | ATP2B4 Isoform ZB of Plasma membrane calcium-transporting ATPase 4 |
| TBC1D13 | Hs.3376; | IPI00647082 | TBC1D13 TBC1 domain family, member 13 |
| LUC7L | Hs.16803; | IPI00410026 | LUC7L Isoform 2 of Putative RNA-binding protein Luc7-like 1 |
| S100A9 | Hs.112405; | IPI00027462 | S100A9 Protein S100-A9 |
| S100A8 | Hs.416073; | IPI00007047 | S100A8 Protein S100-A8 |
| CSTA | Hs.518198; | IPI00032325 | CSTA Cystatin-A |
| UNC13D | Hs.41045; | IPI00456635 | UNC13D Isoform 1 of Unc-13 homolog D |
| PPBP | Hs.2164; | IPI00022445 | PPBP Platelet basic protein precursor |
| TMEM173 | Hs.379754; | IPI00257059 | TMEM173 Transmembrane protein 173 |
| MYLK | Hs.556600; | IPI00221255 | MYLK Isoform 2 of Myosin light chain kinase, smooth muscle |
| EIF4A1 | Hs.129673; | IPI00025491 | EIF4A1 Eukaryotic initiation factor 4A-I |
| STS-1 | Hs.444075; | IPI00154910 | STS-1 Suppressor of T-cell receptor signaling 1 |
| PTPRJ | Hs.318547; | IPI00290328 | PTPRJ Receptor-type tyrosine-protein phosphatase eta precursor |
| | Hs.595299; | | |
| SNAP29 | Hs.108002; | IPI00032831 | SNAP29 Synaptosomal-associated protein 29 |
| PLEKHQ1 | Hs.207157; | IPI00791133 | PLEKHQ1 PLEKHQ1 protein |
| ALDH4A1 | Hs.77448; | IPI00217871 | ALDH4A1 Delta-1-pyrroline-5-carboxylate dehydrogenase, |
| | | | mitochondrial precursor |
| CHMP6 | Hs.514560; | IPI00305423 | CHMP6 Charged multivesicular body protein 6 |
| SLC9A3R1 | Hs.655595; | IPI00003527 | SLC9A3R1 Ezrin-radixin-moesin-binding phosphoprotein 50 |
| | Hs.396783; | | |
| DNAJB11 | Hs.317192; | IPI00008454 | DNAJB11 DnaJ homolog subfamily B member 11 precursor |
| PDLIM1 | Hs.368525; | IPI00010414 | PDLIM1 PDZ and LIM domain protein 1 |
| IQGAP1 | Hs.430551; | IPI00009342 | IQGAP1 Ras GTPase-activating-like protein IQGAP1 |
| MOBK1B | Hs.196437; | IPI00301518 | MOBK1B Isoform 1 of Mps one binder kinase activator-like 1B |
| RAB8A | Hs.642874; | IPI00028481 | RAB8A Ras-related protein Rab-8A |
| EVI2B | Hs.5509; | IPI00301248 | EVI2B EVI2B protein precursor |
| RAB14 | Hs.371563; | IPI00291928 | RAB14 Ras-related protein Rab-14 |
| | Hs.655183; | | |
| SCYE1 | Hs.591680; | IPI00006252 | SCYE1 Multisynthetase complex auxiliary component p43 |
| IPI00075248 | IPI00075248 | IPI00075248 | CALM1, CALM3, CALM2 Calmodulin |
| MVP | Hs.632177; | IPI00000105 | MVP Major vault protein |
| RAB8B | Hs.389733; | IPI00024282 | RAB8B Ras-related protein Rab-8B |
| ARHGEF1 | Hs.631550; | IPI00395605 | ARHGEF1 Rho guanine nucleotide exchange factor 1 isoform 1 |
| HSPA5 | Hs.605502; | IPI00003362 | HSPA5 HSPA5 protein |
| CD47 | Hs.446414; | IPI00216514 | CD47 Isoform OA3-293 of Leukocyte surface antigen CD47 precursor |
| TXNL1 | Hs.114412; | IPI00305692 | TXNL1 Thioredoxin-like protein 1 |
| ENDOD1 | Hs.167115; | IPI00001952 | ENDOD1 Endonuclease domain-containing 1 protein precursor |
| LILRB1 | Hs.667388; | IPI00658078 | LILRB1 leukocyte immunoglobulin-like receptor, subfamily B, member 1 |
| | Hs.655593; | | isoform 4 |
| LRRFIP2 | Hs.475319; | IPI00789379 | LRRFIP2 48 kDa protein |
| FASN | Hs.83190; | IPI00847250 | FASN Fatty acid synthase |
| PACSIN2 | Hs.162877; | IPI00027009 | PACSIN2 Isoform 1 of Protein kinase C and casein kinase substrate in |
| | | | neurons protein 2 |
| NAPRT1 | Hs.493164; | IPI00465085 | NAPRT1 Nicotinate phosphoribosyltransferase domain-containing |
| | | | protein 1 |
| IKBKG | Hs.43505; | IPI00641117 | IKBKG Inhibitor of kappaB kinase gamma |
| RNASET2 | Hs.529989; | IPI00414896 | RNASET2 Isoform 1 of Ribonuclease T2 precursor |
| SH3GL1 | Hs.97616; | IPI00019169 | SH3GL1 SH3-containing GRB2-like protein 1 |
| SNX3 | Hs.12102; | IPI00552276 | SNX3 Isoform 4 of Sorting nexin-3 |
| TPP2 | Hs.432424; | IPI00020416 | TPP2 Tripeptidyl-peptidase 2 |
| MAPK14 | Hs.588289; | IPI00002857 | MAPK14 Isoform CSBP2 of Mitogen-activated protein kinase 14 |
| TSPO | Hs.202; | IPI00847172 | TSPO translocator protein (18 kDa) isoform PBR |
| GSPT1 | Hs.528780; | IPI00218829 | GSPT1 G1 to S phase transition protein 1 homolog |
| NIPSNAP3A | Hs.591897; | IPI00745420 | NIPSNAP3A 23 kDa protein |
| FLJ11151 | Hs.560445; | IPI00305010 | FLJ11151 Hypothetical protein FLJ11151 |
| | Hs.460002; | | |
| PSTPIP1 | Hs.129758; | IPI00022606 | PSTPIP1 Isoform 1 of Proline-serine-threonine phosphatase-interacting |
| | | | protein 1 |
| BASP1 | Hs.201641; | IPI00299024 | BASP1 Brain acid soluble protein 1 |
| IPI00436520 | IPI00436520 | IPI00436520 | Cytochrome c oxidase VIIc |
| APIS2 | Hs.656471; | IPI00009244 | AP1S2 AP-1 complex subunit sigma-2 |
| DPYSL2 | Hs.173381; | IPI00257508 | DPYSL2 Dihydropyrimidinase-related protein 2 |
| UROD | Hs.78601; | IPI00301489 | UROD Uroporphyrinogen decarboxylase |
| IRF2BP2 | Hs.350268; | IPI00376199 | IRF2BP2 interferon regulatory factor 2 binding protein 2 isoform A |
| ACSL4 | Hs.268785; | IPI00219897 | ACSL4 Isoform Short of Long-chain-fatty-acid--CoA ligase 4 |
| CENTD2 | Hs.503165; | IPI00220421 | CENTD2 Isoform 2 of Centaurin-delta 2 |
| ATP6V1H | Hs.491737; | IPI00414079 | ATP6V1H Isoform 2 of Vacuolar ATP synthase subunit H |
| RDH11 | IPI00782958 | IPI00782958 | RDH11 35 kDa protein |
| CAPNS1 | Hs.515371; | IPI00794720 | CAPNS1 34 kDa protein |
| HIF0 | Hs.694881; | IPI00550239 | H1F0 Histone H1.0 |
| TMED4 | Hs.510745; | IPI00296259 | TMED4 Transmembrane emp24 domain-containing protein 4 precursor |
| | Hs.598832; | | |
| | Hs.632641; | | |
| RAB1B | Hs.300816; | IPI00008964 | RAB1B Ras-related protein Rab-1B |
| PGRMC1 | Hs.90061; | IPI00220739 | PGRMC1 Membrane-associated progesterone receptor component 1 |
| TOM1 | Hs.474705; | IPI00023191 | TOM1 Target of myb1 |
| CORO1B | Hs.6191; | IPI00007058 | CORO1B, PTPRCAP Coronin-1B |
| EPS15L1 | Hs.654639; | IPI00646339 | EPS15L1 EPS15L1 protein |
| BLOC1S2 | Hs.576605; | IPI00411983 | BLOC1S2 Isoform 1 of Biogenesis of lysosome-related organelles |
| | | | complex-1 subunit 2 |
| STXBP2 | Hs.515104; | IPI00019971 | STXBP2 Syntaxin-binding protein 2 |
| IDH1 | Hs.593422; | IPI00027223 | IDH1 Isocitrate dehydrogenase [NADP] cytoplasmic |
| | Hs.694738; | | |
| DNM1L | Hs.556296; | IPI00235412 | DNM1L Isoform 3 of Dynamin-1-like protein |
| TSC22D4 | Hs.469798; | IPI00852894 | TSC22D4 17 kDa protein |
| NP | Hs.75514; | IPI00017672 | NP CDNA FLJ25678 fis, clone TST04067, highly similar to PURINE |
| | | | NUCLEOSIDE PHOSPHORYLASE |
| CPT1A | Hs.503043; | IPI00479108 | CPT1A Isoform 2 of Carnitine O-palmitoyltransferase I, liver isoform |
| OSTF1 | Hs.494192; | IPI00414836 | OSTF1 Osteoclast-stimulating factor 1 |
| RAB10 | Hs.643072; | IPI00016513 | RAB10 Ras-related protein Rab-10 |
| | Hs.467960; | | |
| LCP1 | Hs.381099; | IPI00010471 | LCP1 Plastin-2 |
| GDI1 | Hs.74576; | IPI00010154 | GDI1 Rab GDP dissociation inhibitor alpha |
| ATP6V1A | Hs.477155; | IPI00007682 | ATP6V1A Vacuolar ATP synthase catalytic subunit A |
| G6PD | Hs.461047; | IPI00853547 | G6PD glucose-6-phosphate dehydrogenase isoform a |
| | Hs.684904; | | |
| CAP1 | Hs.370581; | IPI00008274 | CAP1 Adenylyl cyclase-associated protein 1 |
| TXN | Hs.435136; | IPI00216298 | TXN Thioredoxin |
| TIAF1 | Hs.462590; | IPI00402167 | TIAF1 232 kDa protein |
| | Hs.655992; | | |
| | Hs.664319; | | |
| VDP | Hs.292689; | IPI00743314 | VDP General vesicular transport factor p115 |
| ARPC2 | Hs.529303; | IPI00005161 | ARPC2 Actin-related protein 2/3 complex subunit 2 |
| FAM49B | Hs.126941; | IPI00303318 | FAM49B Protein FAM49B |
| GTPBP9 | Hs.157351; | IPI00290416 | GTPBP9 Isoform 1 of Putative GTP-binding protein 9 |
| STAT3 | Hs.463059; | IPI00306436 | STAT3 Isoform Del-701 of Signal transducer and activator of |
| | | | transcription 3 |
| MSN | Hs.87752; | IPI00219365 | MSN Moesin |
| GSS | Hs.82327; | IPI00010706 | GSS Glutathione synthetase |
| SCP2 | Hs.476365; | IPI00479934 | SCP2 sterol carrier protein 2 isoform 2 precursor |
| ARHGAP4 | Hs.3109; | IPI00398854 | ARHGAP4 Rho GTPase-activating protein 4 |
| OLFM4 | Hs.559736; | IPI00022255 | OLFM4 olfactomedin 4 precursor |
| CDA | Hs.466910; | IPI00027983 | CDA Cytidine deaminase |
| GZMA | Hs.90708; | IPI00024657 | GZMA Granzyme A precursor (Fragment) |
| CYFIP1 | Hs.26704; | IPI00644231 | CYFIP1 Isoform 1 of Cytoplasmic FMR1-interacting protein 1 |
| MYO1F | Hs.465818; | IPI00414576 | MYO1F 125 kDa protein |
| HSPB1 | Hs.520973; | IPI00025512 | HSPB1 Heat shock protein beta-1 |
| GAA | Hs.1437; | IPI00293088 | GAA 106 kDa protein |
| TAOK3 | Hs.644420; | IPI00796238 | TAOK3 53 kDa protein |
| PSMD13 | Hs.134688; | IPI00552191 | PSMD13 Hypothetical protein DKFZp686H16220 |
| FLNC | Hs.58414; | IPI00783128 | FLNC Gamma filamin variant |
| CHCHD2 | Hs.547257; | IPI00007673 | CHCHD2 Coiled-coil-helix-coiled-coil-helix domain-containing protein 2 |
| | Hs.389996; | | |
| WIPF1 | Hs.654521; | IPI00418328 | WIPF1 Isoform 1 of WAS/WASL-interacting protein family member 1 |
| ADSS | Hs.498313; | IPI00026833 | ADSS Adenylosuccinate synthetase isozyme 2 |
| WNK1 | Hs.356604; | IPI00397591 | WNK1 Isoform 3 of Serine/threonine-protein kinase WNK1 |
| LMAN1 | Hs.465295; | IPI00026530 | LMAN1 ERGIC-53 protein precursor |
| GMIP | Hs.49427; | IPI00292376 | GMIP GEM-interacting protein |
| HPCA | Hs.632391; | IPI00219103 | HPCA Neuron-specific calcium-binding protein hippocalcin |
| FKBP2 | Hs.227729; | IPI00002535 | FKBP2 FK506-binding protein 2 precursor |
| SH3BGRL2 | Hs.302772; | IPI00412272 | SH3BGRL2 SH3 domain-binding glutamic acid-rich-like protein 2 |
| CHMP5 | Hs.635313; | IPI00100796 | CHMP5 Charged multivesicular body protein 5 |
| MMP8 | Hs.161839; | IPI00027846 | MMP8 Neutrophil collagenase precursor |
| PRKAR2B | Hs.433068; | IPI00554752 | PRKAR2B cAMP-dependent protein kinase type II-beta regulatory |
| | | | subunit |
| FAM63A | Hs.3346; | IPI00413164 | FAM63A hypothetical protein LOC55793 isoform 1 |
| MLL | Hs.258855; | IPI00009286 | MLL Isoform 1 of Zinc finger protein HRX |
| | Hs.664477; | | |
| PLG | Hs.143436; | IPI00019580 | PLG Plasminogen precursor |
| DNMT1 | Hs.202672; | IPI00220918 | DNMT1 Isoform 2 of DNA (cytosine-5)-methyltransferase 1 |
| COASY | Hs.296422; | IPI00184821 | COASY Bifunctional coenzyme A synthase |
| ERLIN1 | Hs.150087; | IPI00007940 | ERLIN1 Erlin-1 precursor |
| RAB27A | Hs.654978; | IPI00016381 | RAB27A Isoform Long of Ras-related protein Rab-27A |
| ANXA6 | Hs.412117; | IPI00002459 | ANXA6 annexin VI isoform 2 |
| ICAM1 | Hs.643447; | IPI00008494 | ICAM1 Intercellular adhesion molecule 1 precursor |
| RP6-213H19.1 | Hs.444247; | IPI00182383 | RP6-213H19.1 serine/threonine protein kinase MST4 isoform 3 |
| TSG101 | Hs.523512; | IPI00018434 | TSG101 Isoform 1 of Tumor susceptibility gene 101 protein |
| EIF2A | Hs.655782; | IPI00012462 | EIF2A Eukaryotic translation initiation factor 2A |
| EIF2B2 | Hs.409137; | IPI00028083 | EIF2B2 Translation initiation factor eIF-2B subunit beta |
| SNF8 | Hs.127249; | IPI00795683 | SNF8 12 kDa protein |
| SAPS3 | Hs.503022; | IPI00019540 | SAPS3 Isoform 4 of SAPS domain family member 3 |
| ACAD9 | Hs.567482; | IPI00152981 | ACAD9 Acyl-CoA dehydrogenase family member 9, mitochondrial |
| | | | precursor |
| MKKS | Hs.472119; | IPI00020827 | MKKS PNAS-117 |
| EXOC7 | Hs.533985; | IPI00394717 | EXOC7 Isoform 4 of Exocyst complex component 7 |
| PKN1 | Hs.466044; | IPI00412672 | PKN1 protein kinase N1 isoform 1 |
| LACTB2 | Hs.118554; | IPI00006952 | LACTB2 Lactamase beta-2 |
| TRIM56 | Hs.521092; | IPI00514832 | TRIM56 Tripartite motif-containing protein 56 |
| MAPBPIP | Hs.632483; | IPI00477441 | MAPBPIP Mitogen-activated protein-binding protein-interacting |
| | | | protein |
| CCNY | Hs.14745; | IPI00465457 | CCNY Isoform 1 of Cyclin-Y |
| CALU | Hs.7753; | IPI00789155 | CALU Calumenin precursor |
| METAP1 | Hs.480364; | IPI00022239 | METAP1 Methionine aminopeptidase 1 |
| SKIV2L | Hs.89864; | IPI00414819 | SKIV2L Helicase SKI2W |
| CLASP2 | Hs.108614; | IPI00789331 | CLASP2 49 kDa protein |
| TXNDC12 | Hs.476033; | IPI00026328 | TXNDC12 Thioredoxin domain-containing protein 12 precursor |
| IKBKB | Hs.656458; | IPI00024709 | IKBKB Inhibitor of nuclear factor kappa-B kinase subunit beta |
| TBRG4 | Hs.231411; | IPI00477123 | TBRG4 Isoform 2 of Protein TBRG4 |
| AP2A2 | Hs.19121; | IPI00016621 | AP2A2 AP-2 complex subunit alpha-2 |
| PEX19 | Hs.517232; | IPI00642757 | PEX19 Peroxisomal biogenesis factor 19 |
| HP | Hs.655196; | IPI00641737 | HP Haptoglobin precursor |
| | Hs.513711; | | |
| LDHA | Hs.2795; | IPI00217966 | LDHA Isoform 1 of L-lactate dehydrogenase A chain |
| PRDX6 | Hs.573688; | IPI00220301 | PRDX6 Peroxiredoxin-6 |
| NCF4 | Hs.474781; | IPI00014338 | NCF4 Isoform 1 of Neutrophil cytosol factor 4 |
| ARHGDIB | Hs.504877; | IPI00003817 | ARHGDIB Rho GDP-dissociation inhibitor 2 |
| DNAJC13 | Hs.12707; | IPI00847695 | DNAJC13 DnaJ (Hsp40) homolog, subfamily C, member 13 |
| CNN2 | Hs.651923; | IPI00015262 | CNN2 Calponin-2 |
| CLIC1 | Hs.414565; | IPI00010896 | CLIC1 Chloride intracellular channel protein 1 |
| YWHAH | Hs.226755; | IPI00216319 | YWHAH 14-3-3 protein eta |
| HMHA1 | H5.465521; | IPI00022471 | HMHA1 minor histocompatibility antigen HA-1 |
| PSME2 | Hs.512410; | IPI00746205 | PSME2 proteasome activator subunit 2 |
| | Hs.434081; | | |
| ALDOA | Hs.513490; | IPI00465439 | ALDOA Fructose-bisphosphate aldolase A |
| RNH1 | Hs.530687; | IPI00550069 | RNH1 Ribonuclease inhibitor |
| PPP1CA | Hs.183994; | IPI00550451 | PPP1CA Serine/threonine-protein phosphatase PP1-alpha catalytic |
| | | | subunit |
| DCTN1 | Hs.516111; | IPI00029485 | DCTN1 Isoform p150 of Dynactin subunit 1 |
| SEC31A | Hs.370024; | IPI00305152 | SEC31A Isoform 3 of Protein transport protein Sec31A |
| EHD1 | Hs.523774; | IPI00017184 | EHD1 EH domain-containing protein 1 |
| HSP90AA1 | Hs.525600; | IPI00784295 | HSP90AA1 Isoform 1 of Heat shock protein HSP 90-alpha |
| SND1 | Hs.122523; | IPI00140420 | SND1 Staphylococcal nuclease domain-containing protein 1 |

Regulation of known subnetworks of cellular pathways to identify biomarker subnetworks relating to measures of CLL prognosis, diagnosis and/or pathology were also identified by determining up- and down-regulation of genes within the subnetworks. Cellular pathways of molecular interaction and reaction networks are provided in various curated databases, such as Biocarta™ and Kegg™. Table 5 lists known Biocarta™ (biocarta.com/genes/index.asp) and Kegg™ (genome.jp/kegg/pathway.html) subnetworks of cellular pathways that are up- or down-regulated in CLL B cells compared to normal B cells and thus determined to be biomarker subnetworks.

TABLE 5
Pathways that are up- or down-regulated in CLL B cells compared to
normal B cells:

| | Gene # | P-Value | Benjamini |
|---|---|---|---|
| Biocarta ™ Pathways | | | |
| Spliceosomal Assembly | 6 | 1.30E−02 | 9.80E−01 |
| Adhesion and Diapedesis of | 6 | 2.20E−02 | 9.70E−01 |
| Granulocytes | | | |
| TSP-1 Induced Apoptosis in | 4 | 2.60E−02 | 9.40E−01 |
| Microvascular Endothelial Cell | | | |
| uCalpain and friends in Cell spread | 5 | 3.40E−02 | 9.40E−01 |
| SARS Coronavirus Protease | 4 | 3.90E−02 | 9.20E−01 |
| Rab GTPases Mark Targets In The | 5 | 4.50E−02 | 9.10E−01 |
| Endocytotic Machinery | | | |
| Erk and PI-3 Kinase Are Necessary for | 6 | 6.30E−02 | 9.50E−01 |
| Collagen Binding in Corneal | | | |
| Epithelia | | | |
| Monocyte and its Surface Molecules | 5 | 6.90E−02 | 9.40E−01 |
| Cell to Cell Adhesion Signaling | 4 | 7.10E−02 | 9.30E−01 |
| Eph Kinases and ephrins support | 4 | 9.10E−02 | 9.50E−01 |
| platelet aggregation | | | |
| Kegg ™ Pathways | | | |
| Regulation of actin cytoskeleton | 35 | 5.30E−06 | 1.10E−03 |
| Hematopoietic cell lineage | 18 | 7.70E−05 | 7.70E−03 |
| Focal adhesion | 30 | 1.40E−04 | 9.20E−03 |
| Leukocyte transendothelial migration | 21 | 1.80E−04 | 9.20E−03 |
| Epithelial cell signaling in | 14 | 8.50E−04 | 3.30E−02 |
| Helicobacter pylori infection | | | |
| Tight junction | 20 | 2.30E−03 | 7.50E−02 |
| Methane metabolism | 5 | 3.80E−03 | 1.00E−01 |
| Fatty acid metabolism | 9 | 1.30E−02 | 2.80E−01 |
| Adherens junction | 12 | 1.50E−02 | 2.80E−01 |
| Glutathione metabolism | 8 | 1.90E−02 | 3.20E−01 |
| Complement and coagulation cascades | 11 | 2.30E−02 | 3.50E−01 |
| Pentose phosphate pathway | 6 | 2.90E−02 | 3.90E−01 |
| Long-term potentiation | 10 | 4.00E−02 | 4.70E−01 |
| Aminosugars metabolism | 6 | 4.50E−02 | 4.90E−01 |
| ECM-receptor interaction | 12 | 4.70E−02 | 4.80E−01 |
| Antigen processing and presentation | 11 | 5.70E−02 | 5.20E−01 |
| Lysine degradation | 8 | 5.70E−02 | 5.00E−01 |
| Glycolysis/Gluconeogenesis | 9 | 6.10E−02 | 5.10E−01 |
| Cholera - Infection | 7 | 6.90E−02 | 5.30E−01 |
| Pathogenic Escherichia coli | 8 | 8.10E−02 | 5.50E−01 |
| infection - EPEC | | | |
| Pathogenic Escherichia coli | 8 | 8.10E−02 | 5.50E−01 |
| infection - EHEC | | | |
| Caprolactam degradation | 4 | 8.70E−02 | 5.60E−01 |
| Acute myeloid leukemia | 8 | 9.40E−02 | 5.80E−01 |

### EXAMPLE II

### Prognostic Classification of CLL Patients Using Subnetwork Data

The clinical course of patients with chronic lymphocytic leukemia (CLL) is heterogeneous. For unknown reasons, some patients become fatal within few years while some others may stay symptom free for more than a decade. Several prognostic factors have been identified that can stratify patients into groups that differ in their relative tendency for disease progression and/or survival. Microarray studies have highlighted differences in mRNA levels found between such CLL subgroups.

To evaluate gene expression profiling to define a repertoires of transcriptional activity contributing to or resulting from the dynamic evolution of CLL cells. 131 CLL patients (of >90% CD19+CD5+ peripheral blood mononuclear cells in each sample) were profiled on mRNA expression microarrays using Affymetrix HG-U133 plus 2 GeneChips™ Patterns of gene activity correlated with the time intervals to treatment of CLL patients from the date of sample collection (treatment-free survival). An expression-based prognosis that assigns patients to “aggressive” (high-risk) or “indolent” (low-risk) groups based upon biological-defendable models by incorporating knowledge of molecular pathways was next developed.

To identify progression-associated pathway markers, a network-based marker identification was adopted. The network-based approach identified prognostic markers not as individual genes but as subnetworks extracted from molecular interaction databases (FIG. 2). Gene expression profiles from CLL patients were mapped to a large human molecular interaction network, consisting of 45,526 interactions (including protein-protein and protein-DNA interactions) among 9,800 genes/proteins, compiled from high-throughput screenings and curation of previous measurements reported in the literature. A search over this network was performed to identify prognostic subnetworks that could be used to predict treatment-free survival.

Specifically, each subnetwork was scored by a vector of activities across all patients, where the activity for a given patient is a function of the expression levels of its member genes. A subnetwork's prognostic power was scored by the Cox metric, which measures the correlation between the activity vector and the patients' treatment-free survival. The resulting 30 prognostic biomarker subnetworks identify new putative cancer markers and provide an array of “small-scale” models charting the molecular mechanisms correlated with CLL disease progression, e.g. subnetworks detailing interactions between proteins participating in cell cycle and death, Myc regulation, proteasome or Wnt signaling (FIG. 3).

To examine the utility of the 30 subnetwork markers in CLL risk assessment, a 5-fold cross validation was performed where 80% of the 131 patients were designated as a training set and the rest as a test set. The patients in a training set were first separated into two groups based on the similarity between their activity patterns of the 30 prognostic subnetworks; one set was assigned as “aggressive” and the other as “indolent” according to the median survival time of each patient set. Patients in a test set were segregated into either the “aggressive” or “indolent” group based on their activity similarity to that of the training samples. The survival difference between the two predicted groups of patients in a test set was then used as a metric to evaluate the prognostic power of the given markers.

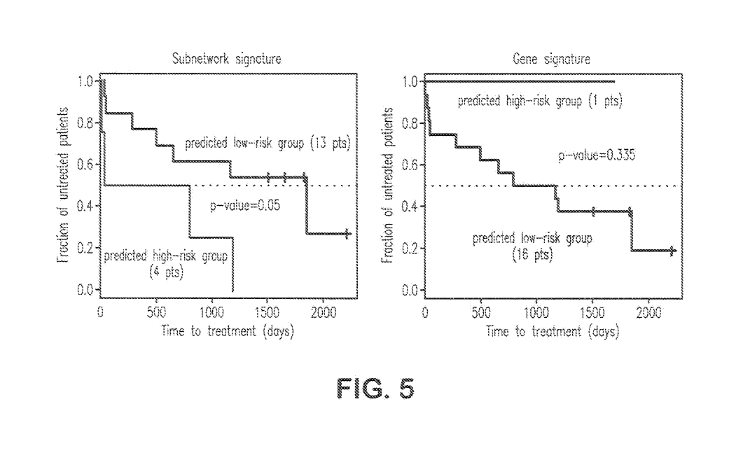

Combining the results from the 5 test trials, the two risk groups defined by the subnetwork markers displayed significantly different behaviors with respect to treatment-free survival (FIG. 4); however, neither of conventional gene-expression array analyses or the two commonly-used prognostic factors, IgVH gene mutational status or leukemia-cell expression of ZAP-70 protein, could segregate the test samples to the same degree of statistical significance. Moreover, the subnetwork signature learned from the patient cohort was also predictive of the prognosis of a subsequent independent testing set of 17 patients from Europe (FIG. 5). The identified subnetwork signature provides a powerful tool for identification of CLL patients at high risk of immediate care. In all, the network-based approach integrating protein interactions with CLL expression profiles leads to increased classification accuracy and, simultaneously, provides a view of the biological processes underlying cancer progression.

Although the invention has been described with reference to the above example, which is incorporated herein by reference, it will be understood that modifications and variations are encompassed within the spirit and scope of the invention. Accordingly, the invention is limited only by the following claims.

1. A method for predicting the prognostic risk posed by chronic lymphocytic leukemia (CLL) to a patient diagnosed with the disease comprising:
a) obtaining a sample from the patient; and
b) comparing expression of a first plurality of genes from said sample to expression of a second plurality of genes comprising a biomarker subnetwork, wherein the genes of the subnetwork encode proteins known to exhibit protein-protein interactions, and wherein further said proteins are associated with relatively high or low risk for progression of the disease, whereby similarity between expression of said pluralities of genes indicates the relative level of such risk for the patient.

2. The method of claim 1, wherein the subnetwork of genes encode proteins that comprise one or more protein biomarkers listed in Tables 1 through 4.

3. The method of claim 1, wherein the subnetwork of genes encode proteins that comprise one or more protein biomarkers listed in any of Tables 1 and 2.

4. The method of claim 1, wherein the subnetwork comprises one or more subnetworks listed in Table 5.

5. The method of claim 1, wherein the subnetwork of genes comprises one or more of the subnetworks of FIGS. 8 through 37.

6. The method of claim 1, wherein the sample is a blood sample.

7. A method of diagnosing a subject as having or being at risk of having chronic lymphocytic leukemia (CLL), comprising:
a) obtaining a sample from the subject; and
b) comparing the expression or activation of one or more biomarkers listed in Tables 1 through 5 or FIGS. 8 through 37, in a first sample from the subject suspected of having CLL with a control sample of normal B cells, wherein differential expression of one or more of said biomarkers in the subject's sample as compared to the control sample is diagnostic of CLL in the subject.

8. The method of claim 7, wherein the biomarker comprises one or more biomarkers listed in Tables 1 or 3 and expression of the one or more biomarkers is increased as compared to expression of the biomarker in the control sample.

9. The method of claim 7, wherein the biomarker comprises one or more biomarkers listed in Tables 2 or 4 and expression of the one or more biomarkers is decreased as compared to expression of the biomarker in the control sample.

10. The method of claim 7, wherein the biomarker comprises one or more subnetworks listed in Table 5.

11. The method of claim 1, wherein the subnetwork comprises one or more of the subnetworks of FIGS. 8 through 37.

12. A method of differentially diagnosing aggressive chronic lymphocytic leukemia (CLL) versus indolent CLL in a subject, comprising:
a) obtaining a sample from a subject; and
b) comparing the level of expression of one or more biomarkers listed in Table 1 in a sample from the subject suspected of having aggressive CLL with a control indolent CLL sample, wherein greater expression of one or more of said biomarkers listed in Table 1 in the subject sample versus the control indolent CLL sample is diagnostic of aggressive CLL in the subject.

13. A method of differentially diagnosing aggressive chronic lymphocytic leukemia (CLL) versus indolent CLL in a subject, comprising:
a) obtaining a sample from a subject; and
b) comparing the level of expression of one or more biomarkers listed in Table 2 in a sample from the subject suspected of having aggressive CLL with a control indolent CLL sample, wherein lesser expression of one or more of said biomarkers listed in Table 2 in the subject sample versus the control indolent CLL sample is diagnostic of indolent CLL in the subject.

14. A method for diagnosing CLL in a subject, comprising:
a) providing a gene expression profile of a sample suspected of being CLL from the subject, wherein the sample simultaneously expresses a plurality of genes at the protein level that are markers for CLL; and
b) comparing the subject's gene expression profile to a reference gene expression profile obtained from a corresponding control sample, wherein the reference gene expression profile comprises an expression value of one or more target biomarkers selected from the genes listed in Table 1 and Table 2.

15. A method for distinguishing aggressive chronic lymphocytic leukemia (CLL) from indolent CLL in a subject, comprising:
a) providing a gene expression profile of a sample suspected of being aggressive CLL from the subject, wherein the sample simultaneously expresses a plurality of genes at the protein level that are markers for aggressive CLL; and
b) comparing the subject's gene expression profile to a reference gene expression profile obtained from a corresponding indolent CLL control sample, wherein the reference gene expression profile comprises an expression value of one or more target genes selected from the biomarkers listed in Table 3 and Table 4.

16. A computer-readable media comprising an algorithm for execution of (b) of the method of claims 1-15.

17. A method of monitoring a therapeutic regimen for treating a subject having or at risk of having CLL, comprising determining a change in activity or expression of one or more biomarkers listed in any of Tables 1 through 4, subnetwork listed in Table 5 or FIGS. 8 through 37, thereby monitoring the therapeutic regimen in the subject.

18. A diagnostic chip comprising nucleotides with at least 95% homology to the sequences of two or more genes shown in a subnetwork of FIGS. 8 through 37.
